(19) United States
(12) Patent Application Publication
(10) Pub. No.: US 2024/0071660 A1
(43) Pub. Date: Feb. 29, 2024

(54) SOFT MAGNETIC ALLOY POWDER, MAGNETIC CORE, MAGNETIC COMPONENT, AND ELECTRONIC DEVICE

(71) Applicant: TDK CORPORATION, Tokyo (JP)

(72) Inventors: Akito HASEGAWA, Tokyo (JP); Yoshiki KAJIURA, Tokyo (JP); Masakazu HOSONO, Tokyo (JP); Kazuhiro YOSHIDOME, Tokyo (JP)

(73) Assignee: TDK CORPORATION, Tokyo (JP)

(21) Appl. No.: 18/458,639

(22) Filed: Aug. 30, 2023

(30) Foreign Application Priority Data
Aug. 31, 2022 (JP) 2022-138394

(51) Int. Cl. H01F 1/147; H01F 3/08

(52) U.S. Cl. CPC H01F 1/14758; H01F 3/08

(57) ABSTRACT

A soft magnetic alloy powder comprises a component having a compositional formula ((Fe_{(1-(α+β))}Co_{α}Ni_{β})_{(1-γ)}X1_{γ})_{(1-(a+b+c+d+e))}BₐP_{b}Si_{c}C_{d}Crₑ in atomic ratio. X1 comprises at least one selected from specific elements. Values of a, b, c, d, e, α, β, and γ of the compositional formula satisfy specific ranges. The soft magnetic alloy powder comprises soft magnetic alloy particles including soft magnetic alloy particles having a particle size of (0.95×D90) or more and (1.05×D90) or less. An average Wadell's circularity of the soft magnetic alloy particles having the particle size of (0.95×D90) or more and (1.05×D90) or less is 0.75 or more. A variance of Wadell's circularity of the soft magnetic alloy particles having the particle size of (0.95×D90) or more and (1.05×D90) or less is 0.035 or less.

### TECHNICAL FIELD

The present invention relates to a soft magnetic alloy powder, a magnetic core, a magnetic component, and an electronic device.

### BACKGROUND

Patent Document 1 discloses a toroidal core including an amorphous soft magnetic powder. The amorphous soft magnetic powder includes metal glass and has an average Wadell's working sphericity of 0.90 or more.

Patent Document 1: JP Patent Application Laid Open No. 2011-023673

### SUMMARY

It is an object of an exemplary embodiment of the present invention to provide a soft magnetic alloy powder or the like with which a magnetic core having improved core loss and improved DC superimposition characteristics can be produced.

To achieve the above object, a soft magnetic alloy powder of an exemplary embodiment of the present invention is a soft magnetic alloy powder comprising a component having a compositional formula ((Fe_{(1-(α+β))}Co_{α}Ni_{β})_{(1-γ)}X1_{γ})_{(1-(a+b+c+d+e))}BₐP_{b}Si_{c}C_{d}Crₑ in atomic ratio,

wherein

X1 comprises at least one selected from the group consisting of Ti, Zr, Hf, Nb, Ta, Mo, W, Al, Ga, Ag, Zn, S, Ca, Mg, V, Sn, As, Sb, Bi, N, O, Au, Cu, Mn, rare earth elements, and platinum-group elements;

a, b, c, d, e, α, β, and γ of the compositional formula satisfy

0.020≤a≤0.200,

0≤b≤0.070,

0.020≤a+b≤0.200,

0≤c≤0.100,

0<d≤0.050,

0≤e≤0.040,

0.005≤α≤0.700,

0≤β≤0.200,

0≤γ≤0.030, and

0.790≤1−(a+b+c+d+e)≤0.900;

the soft magnetic alloy powder comprises soft magnetic alloy particles including soft magnetic alloy particles having a particle size of (0.95×D90) or more and (1.05×D90) or less;
an average Wadell's circularity of the soft magnetic alloy particles having the particle size of (0.95×D90) or more and (1.05×D90) or less is 0.75 or more; and
a variance of Wadell's circularity of the soft magnetic alloy particles having the particle size of (0.95×D90) or more and (1.05×D90) or less is 0.035 or less.

A magnetic core of the exemplary embodiment of the present invention comprises the above soft magnetic alloy powder.

The magnetic core may further comprise a resin.

A magnetic component of the exemplary embodiment of the present invention comprises the above magnetic core.

An electronic device of the exemplary embodiment of the present invention comprises the above magnetic core.

### BRIEF DESCRIPTION OF THE DRAWING(S)

FIG. 1 is an example chart generated in an X-ray crystal structure analysis.

FIG. 2 is a plurality of example patterns obtained by profile fitting of the chart of FIG. 1.

FIG. 3A is a schematic sectional view of an elliptical water flow atomizing apparatus according to an exemplary embodiment of the present invention.

FIG. 3B is an enlarged sectional view of a main part of the elliptical water flow atomizing apparatus shown in FIG. 3A.

FIG. 3C is an enlarged sectional perspective view of the main part of the elliptical water flow atomizing apparatus shown in FIG. 3A.

FIG. 4A is a schematic view of a flow of a cooling liquid in the elliptical water flow atomizing apparatus shown in FIG. 3A viewed from a side.

FIG. 4B is a schematic view of the flow of the cooling liquid shown in FIG. 4A viewed from a vertical direction.

FIG. 5A is a schematic view of a structure of a tubular body according to the elliptical water flow atomizing apparatus shown in FIG. 3A.

FIG. 5B is a schematic view of a structure of a modified example of the tubular body shown in FIG. 3A.

FIG. 6A is a schematic view of a flow of a cooling liquid in a conventional atomizing apparatus viewed from a side.

FIG. 6B is a schematic view of the flow of the cooling liquid shown in FIG. 6A viewed from above.

### DETAILED DESCRIPTION

Hereinafter, a soft magnetic alloy according to an embodiment of the present invention will be described.

A soft magnetic alloy powder according to the present embodiment is a soft magnetic alloy powder comprising a component having a compositional formula ((Fe_{(1-(α+β))}Co_{α}N_{β})_{(1-γ)}X1_{γ})_{(1-(a+b+c+d+e))}BₐP_{b}Si_{c}C_{d}Crₑ in atomic ratio, wherein

X1 comprises at least one selected from the group consisting of Ti, Zr, Hf, Nb, Ta, Mo, W, Al, Ga, Ag, Zn, S, Ca, Mg, V, Sn, As, Sb, Bi, N, O, Au, Cu, Mn, rare earth elements, and platinum-group elements;
a, b, c, d, e, α, β, and γ of the compositional formula satisfy

0.020≤a≤0.200,

0≤b≤0.070,

0.020≤a+b≤0.200,

0≤c≤0.100,

0<d≤0.050,

0≤e≤0.040,

0.005≤α≤0.700,

0≤β≤0.200,

0≤γ≤0.030, and

0.790≤1−(a+b+c+d+e)≤0.900;

the soft magnetic alloy powder comprises soft magnetic alloy particles including soft magnetic alloy particles having a particle size of (0.95×D90) or more and (1.05×D90) or less;
an average Wadell's circularity of the soft magnetic alloy particles having the particle size of (0.95×D90) or more and (1.05×D90) or less is 0.75 or more; and a variance of Wadell's circularity of the soft magnetic alloy particles having the particle size of (0.95×D90) or more and (1.05×D90) or less is 0.035 or less.

When an atomizing method is used to produce the soft magnetic alloy powder having the above composition, use of an atomizing apparatus having specific characteristics described later for the atomizing method enables relatively large particles to readily have a large average circularity and a small variance of circularity. Note that the variance is an average squared deviation from the mean.

Specifically, the relatively large particles are particles having a particle size of (0.95×D90) or more and (1.05×D90) or less. Hereinafter, the relatively large particles may be simply referred to as large particles. D90 is the corresponding particle size at a number-based cumulative relative frequency of 90%. Similarly, D50 is the corresponding particle size at a number-based cumulative relative frequency of 50%.

The average Wadell's circularity of the large particles is 0.75 or more, and the variance of Wadell's circularity thereof is 0.035 or less.

Hereinafter, the composition of the soft magnetic alloy powder will be described in more detail.

The B content (a) satisfies 0.020≤a≤0.200. The B content may satisfy 0.075≤a≤0.150. When the soft magnetic alloy contains B, the amorphousness of the soft magnetic alloy is improved. However, when the B content is high, Bs of the soft magnetic alloy is readily reduced. Further, when the B content is too high or too low, the melting point of the soft magnetic alloy is readily increased, and the viscosity of the melted soft magnetic alloy is readily increased. Thus, when the B content is too high, use of the atomizing apparatus described later would not improve the circularity of the large particles or the variance of circularity of the large particles.

When a soft magnetic alloy powder containing too little B or a soft magnetic alloy powder containing too much B is used for producing a magnetic core, use of the atomizing apparatus described later for producing the soft magnetic alloy powder would not readily improve the core loss or the DC superimposition characteristics sufficiently.

The P content (b) satisfies 0≤b≤0.070. That is, the soft magnetic alloy may not contain P. The P content may satisfy 0.010≤b≤0.070. When the soft magnetic alloy contains P, the amorphousness of the soft magnetic alloy is improved; the melting point of the soft magnetic alloy is readily reduced; and the viscosity of the melted soft magnetic alloy is readily reduced. Thus, use of the atomizing apparatus described later readily improves the circularity of the large particles and the variance of circularity of the large particles. However, when the P content is high, Bs of the soft magnetic alloy is readily reduced.

When a soft magnetic alloy powder containing too much P is used for producing a magnetic core, use of the atomizing apparatus described later for producing the soft magnetic alloy powder would not readily improve the core loss or the DC superimposition characteristics sufficiently.

The sum (a+b) of the B content and the P content satisfies 0.020≤a+b≤0.200. The sum may satisfy 0.125≤a+b≤0.180. When the sum of the B content and the P content is too large, Bs of the soft magnetic alloy is readily reduced.

When a soft magnetic alloy powder containing too much B and P in total is used for producing a magnetic core, use of the atomizing apparatus described later for producing the soft magnetic alloy powder would not readily improve the core loss or the DC superimposition characteristics sufficiently.

The Si content (c) satisfies 0≤c≤0.100. That is, the soft magnetic alloy may not contain Si. The Si content may satisfy 0≤c ≤0.060. The Si content preferably satisfies 0≤c≤0.020. When the soft magnetic alloy contains Si, the amorphousness and corrosion resistance of the soft magnetic alloy are improved; the melting point of the soft magnetic alloy is readily reduced; and the viscosity of the melted soft magnetic alloy is readily reduced. Thus, use of the atomizing apparatus described later readily improves the circularity of the large particles and the variance of circularity of the large particles. However, when the Si content is high, Bs of the soft magnetic alloy is readily reduced.

When a soft magnetic alloy powder containing too much Si is used for producing a magnetic core, use of the atomizing apparatus described later for producing the soft magnetic alloy powder would not readily improve the core loss or the DC superimposition characteristics sufficiently.

The C content (d) satisfies 0≤d≤0.050. The C content may satisfy 0.001≤d≤0.050 or may satisfy 0.001≤d≤0.020. When the soft magnetic alloy contains C, the amorphousness of the soft magnetic alloy is improved; the melting point of the soft magnetic alloy is readily reduced; and the viscosity of the melted soft magnetic alloy is readily reduced. Thus, use of the atomizing apparatus described later readily improves the circularity of the large particles and the variance of circularity of the large particles. However, when the C content is high, the amorphousness is readily reduced, and the soft magnetic properties are readily impaired because secondary phases are readily generated in the soft magnetic alloy. Specifically, the coercivity is readily increased.

When a soft magnetic alloy powder containing too little C or a soft magnetic alloy powder containing too much C is used for producing a magnetic core, use of the atomizing apparatus described later for producing the soft magnetic alloy powder would not readily improve the core loss or the DC superimposition characteristics sufficiently.

The Cr content (e) satisfies 0≤e≤0.040. That is, the soft magnetic alloy may not contain Cr. The Cr content may satisfy 0≤e≤0.020. When the soft magnetic alloy contains Cr, the corrosion resistance of the soft magnetic alloy is improved. However, when the Cr content is high, Bs of the soft magnetic alloy is readily reduced.

When a soft magnetic alloy powder containing too much Cr is used for producing a magnetic core, use of the atomizing apparatus described later for producing the soft magnetic alloy powder would not readily improve the DC superimposition characteristics sufficiently.

The Co content ratio (a), which is the ratio of the Co content to the Fe content, Co content, and Ni content in total, satisfies 0.005≤α≤0.700. The Co content ratio may satisfy 0.005≤α≤0.500 or may satisfy 0.010≤α≤0.500.

mThe Ni content ratio (β), which is the ratio of the Ni content to the Fe content, Co content, and Ni content in total, satisfies 0 ≤β≤0.200. The Ni content ratio may satisfy 0≤β≤0.050 or may satisfy 0≤β≤0.005. That is, the soft magnetic alloy may not contain Ni.

In particular, when having an amorphous structure described later, the soft magnetic alloy having a suitable Co content ratio and a suitable Ni content ratio readily has an improved Bs compared to a soft magnetic alloy that does not contain Co or Ni. When the soft magnetic alloy having the suitable Co content ratio and the suitable Ni content ratio is used for producing a magnetic core, the magnetic core has more improved DC superimposition characteristics than a magnetic core produced using the soft magnetic alloy that does not contain Co or Ni.

When a soft magnetic alloy powder having too low a Co content ratio is used for producing a magnetic core, use of the atomizing apparatus described later for producing the soft magnetic alloy powder would not readily improve the core loss or the DC superimposition characteristics sufficiently.

When a soft magnetic alloy powder having too high a Co content ratio is used for producing a magnetic core, Bs of the soft magnetic alloy is readily reduced, and use of the atomizing apparatus described later for producing the soft magnetic alloy powder would not readily improve the DC superimposition characteristics sufficiently.

When a soft magnetic alloy powder having too high a Ni content ratio is used for producing a magnetic core, Bs of the soft magnetic alloy is readily reduced, and use of the atomizing apparatus described later for producing the soft magnetic alloy powder would not readily improve the DC superimposition characteristics sufficiently.

X1 includes at least one selected from the group consisting of Ti, Zr, Hf, Nb, Ta, Mo, W, Al, Ga, Ag, Zn, S, Ca, Mg, V, Sn, As, Sb, Bi, N, 0, Au, Cu, Mn, rare earth elements, and platinum-group elements. The rare earth elements include Sc, Y, and lanthanoids. The platinum-group elements include Ru, Rh, Pd, Os, Ir, and Pt. X1 may be included as impurities or may be intentionally added.

The X1 content ratio (γ), which is the ratio of the X1 content to the Fe content, Co content, Ni content, and X1 content in total, satisfies 0≤γ≤0.030.

The sum (1−(a+b+c+d+e)) of the Fe content, Co content, Ni content, and X1 content satisfies 0.790≤1−(a+b+c+d+e)≤0.900. The sum may satisfy 0.820≤1−(a+b+c+d+e)≤0.850. When the sum of the Fe content, Co content, Ni content, and X1 content is too small, Bs of the soft magnetic alloy is readily reduced.

When a soft magnetic alloy powder containing too little Fe, Co, Ni, and X1 in total is used for producing a magnetic core, use of the atomizing apparatus described later for producing the soft magnetic alloy powder would not readily improve the DC superimposition characteristics sufficiently.

When a soft magnetic alloy powder containing too much Fe, Co, Ni, and X1 in total is used for producing a magnetic core, use of the atomizing apparatus described later for producing the soft magnetic alloy powder would not readily improve the core loss or the DC superimposition characteristics sufficiently.

As inevitable impurities, the soft magnetic alloy may contain elements other than the above elements, i.e., the soft magnetic alloy may contain elements other than Fe, Co, Ni, X1, B, P, Si, C, and Cr. For example, the inevitable impurities may be included at 0.1 mass % or less with respect to 100 mass % of the soft magnetic alloy.

Provided that the molding pressure is the same between a magnetic core produced by press molding the soft magnetic alloy powder produced using the atomizing apparatus described later and having the above composition and another magnetic core produced by press molding the soft magnetic alloy powder produced using a conventional atomizing apparatus and having the above composition, the former magnetic core readily has coercivity (Hc) equivalent to the latter's, a packing density equivalent to the latter's, and relatively high relative permeability (μ). The core loss of the former magnetic core is readily reduced, and the DC superimposition characteristics thereof are readily increased.

Provided that the relative permeability (μ) is the same due to different molding pressures between a magnetic core produced by press molding the soft magnetic alloy powder produced using the atomizing apparatus described later and having the above composition and another magnetic core produced by press molding the soft magnetic alloy powder produced using a conventional atomizing apparatus and having the above composition, the former magnetic core readily has relatively low coercivity (Hc) and a relatively low packing density. The core loss of the former magnetic core is readily reduced, and the DC superimposition characteristics thereof are readily increased.

Among soft magnetic alloy particles included in a magnetic core of the present embodiment, the large particles may have an average Wadell's circularity of 0.75 or more and a variance of Wadell's circularity of 0.035 or less. A magnetic core produced using the soft magnetic alloy powder in which the average Wadell's circularity of the large particles is 0.75 or more and the variance of Wadell's circularity of the large particles is 0.035 or less readily has the above circularity. When the average Wadell's circularity of the large particles included in the magnetic core is 0.75 or more, in particular, the core loss of the magnetic core is readily reduced.

When the variance of Wadell's circularity of the large particles included in the magnetic core is 0.035 or less, in particular, the DC superimposition characteristics of the magnetic core tend to improve.

In measurement of the circularity of soft magnetic alloy particles included in a magnetic core produced by press molding the soft magnetic alloy powder per particle size, the larger the particle size of the soft magnetic alloy particles, the smaller tends to be the average circularity, and the larger tends to be the variance of circularity. That is, soft magnetic alloy particles having a particularly large size and a particularly distorted shape are readily included in the magnetic core. When such soft magnetic alloy particles having a particularly large size and a particularly distorted shape are included in the magnetic core, local saturation is readily generated around there. Consequently, in particular, the DC superimposition characteristics are readily reduced.

It has been conventionally difficult to increase the average circularity of the large particles (defined based on the number of particles) and reduce the variance of circularity of the large particles. In particular, it has been difficult to reduce the variance of circularity of the large particles. However, the present inventors have found that, when a soft magnetic alloy powder is produced using the atomizing apparatus described later and the soft magnetic alloy having the above composition, it is possible to increase the average circularity of the large particles and reduce the variance of circularity of the large particles.

The magnetic core may include a resin in addition to the above soft magnetic alloy particles. The resin may be of any type, and the amount of the resin is not limited. Examples of the resin include thermosetting resins, such as a phenol resin and an epoxy resin. The amount of the resin may be 1 part by mass or more and 5 parts by mass or less with respect to 100 parts by mass of the soft magnetic alloy particles.

Hereinafter, a method of measuring D50 and D90 of the soft magnetic alloy powder and a method of calculating the average circularity of the large particles and the variance of circularity of the large particles will be described.

Any method of measuring D50 and D90 of the soft magnetic alloy powder may be used. Various particle size analyses (e.g., a laser diffraction method) can be used for measurement. In particular, a particle image analyzer Morphologi G3 (Malvern Panalytical) may be used. Morphologi G3 is an analyzer that enables the powder to be dispersed using air, individual particle shapes to be projected, and projections to be evaluated.

Specifically, from the projected areas of individual particles, equivalent circle diameters (particle sizes) of the individual particles can be obtained. In the present embodiment, equivalent circle diameters mean Heywood diameters. From the equivalent circle diameters of the individual particles, particle size distribution can be obtained. The corresponding particle size at a number-based cumulative relative frequency of 50% in the particle size distribution can be D50. The corresponding particle size at a number-based cumulative relative frequency of 90% in the particle size distribution can be D90. In the present embodiment, D50 and D90 are calculated using the equivalent circle diameters of at least 2,000 particles or preferably 20,000 particles or more.

Then, among all particles whose projections have been obtained, large particles, i.e., particles with a particle size of (0.95×D90) or more and (1.05×D90) or less are identified. From the projections of the individual large particles, the circularities of the individual large particles are calculated. In the present embodiment, circularity means Wadell's circularity. From the circularities of the individual large particles, the average circularity of the large particles and the variance of circularity of the large particles are calculated.

Because Morphologi G3 can generate projections of multiple particles at one time for evaluation, shapes of the multiple particles can be evaluated in a short amount of time. Thus, Morphologi G3 is suitable for evaluating the particle size distribution and the like of the soft magnetic alloy powder prior to molding. It is possible to generate the projections of the multiple particles, automatically calculate the particle sizes and circularities of the individual particles, and calculate the average circularity of the large particles and the variance of circularity of the large particles.

Next, a method of measuring D50 and D90 of the soft magnetic alloy particles included in the magnetic core and a method of calculating the average circularity of the large particles and the variance of circularity of the large particles will be described.

First, any part of the magnetic core is cut off to give a cross section of the magnetic core. The cross section is then observed. Any method of observing the cross section may be used. For example, an electron microscope (e.g., a SEM and a STEM) may be used. The field of view and magnification are not limited as long as individual sectional shapes of at least 2,000 soft magnetic alloy particles are observed.

Then, the equivalent circle diameters of the individual particles included in the field of view are calculated. Any method of calculating the equivalent circle diameters may be used. For example, an analysis program may be used. However, when the analysis program or the like is used, portions that are apparently not particles may be recognized as particles. Such portions are appropriately left out in the calculation.

From the equivalent circle diameters of the individual particles, D50 and D90 are calculated. Then, among all the observed particles, large particles are identified, i.e., particles with a particle size of (0.95×D90) or more and (1.05×D90) or less are identified. From the projections of the individual large particles, the circularities of the individual large particles are calculated. In the present embodiment, circularity means Wadell's circularity. From the circularities of the individual large particles, the average circularity of the large particles and the variance of circularity of the large particles are calculated.

The number-based particle size distribution and the circularity of the soft magnetic alloy powder confirmed with Morphologi G3 and the number-based particle size distribution and the circularity of the soft magnetic alloy particles in the cross section of the magnetic core obtained in the end do not correspond with each other.

However, the number-based particle size distribution and the circularity of the magnetic powder confirmed with Morphologi G3 and the number-based particle size distribution and the circularity of the particles in the magnetic powder in the cross section of the magnetic core obtained in the end are correlated. Thus, confirmation of the particle size distribution and the circularity of the soft magnetic alloy powder with Morphologi G3 enables, to some degree, estimation of the particle size distribution of the soft magnetic alloy particles in the cross section of the magnetic core obtained in the end. That is, the number-based particle size distribution and the circularity of the soft magnetic alloy particles in the cross section of the magnetic core obtained in the end are easily controlled by control of the number-based particle size distribution and the circularity of the soft magnetic alloy powder prior to molding.

The soft magnetic alloy powder according to the present embodiment may have any D50 and any D90. D50 may be, for example, 3 μm or more and 50 μm or less. D90 may be, for example, 10 μm or more and 100 μm or less.

Although the soft magnetic alloy powder according to the present embodiment may have any microstructure, the soft magnetic alloy powder preferably has an amorphous structure, a hetero-amorphous structure, or a nanocrystalline structure, because such structures readily improve the core loss and the DC superimposition characteristics of the magnetic core.

In the following description, an amorphous structure refers to a structure having an amorphous ratio X of 85% or more and in which crystals are not observed; a hetero-amorphous structure refers to a structure having an amorphous ratio X of 85% or more and in which crystals are present in an amorphous solid; a nanocrystalline structure refers to a structure having an amorphous ratio X of less than 85% and an average crystal size of 100 nm or less; and a crystalline structure refers to a structure having an amorphous ratio X of less than 85% and an average crystal size exceeding 100 nm.

When the soft magnetic alloy powder according to the present embodiment has a hetero-amorphous structure, the average crystal size is preferably 0.1 nm or more and 10 nm or less. When the soft magnetic alloy powder according to the present embodiment has a nanocrystalline structure, the average crystal size is preferably 3 nm or more and 50 nm or less.

Any method of evaluating the amorphous ratio X may be used. For example, such methods include a method using XRD and a method using a scanning transmission electron microscope (STEM). The method using a STEM is particularly used for evaluating the amorphous ratio X of the soft magnetic alloy included in the magnetic core.

Hereinafter, a method of evaluating the amorphous ratio using XRD will be described. Any method of evaluating the average crystal size using XRD may be used, and a normal method can be appropriately used for evaluation.

When the amorphous ratio X is evaluated by XRD, the amorphous ratio X is calculated using Formula 1 shown below.

X=100−(Ic/(Ic+Ia)×100) Formula 1

Ic: Crystal scattering integrated intensity

Ia: Amorphous scattering integrated intensity

The amorphous ratio X is calculated as follows. An X-ray crystal structure analysis of the soft magnetic alloy using XRD is performed. In the analysis, phases are identified, and peaks (Ic: crystal scattering integrated intensity, Ia: amorphous scattering integrated intensity) of crystallized Fe or a crystallized compound are read. From the intensities of these peaks, the crystallization ratio is determined, and the amorphous ratio X is calculated using the above Formula 1. Hereinafter, the calculation method will be described more specifically.

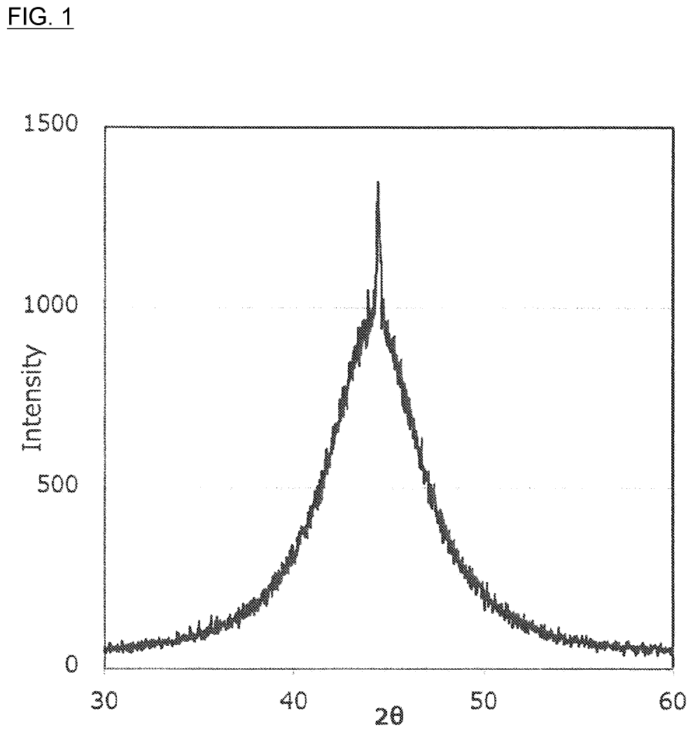

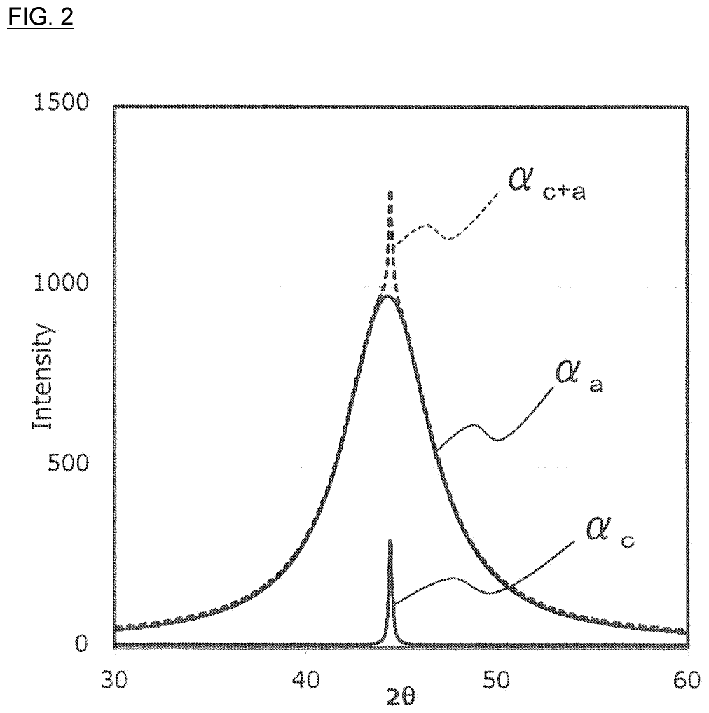

The X-ray crystal structure analysis of the soft magnetic alloy using XRD is performed to generate a chart like the one shown as FIG. 1. Then, profile fitting is performed to this chart using a Lorentzian function shown as Formula 2 below to generate a crystal component pattern α_{c} showing the crystal scattering integrated intensity, an amorphous component pattern αₐ showing the amorphous scattering integrated intensity, and a pattern α_{c+a} showing a combination of these patterns, as shown in FIG. 2. From the patterns of the crystal scattering integrated intensity and the amorphous scattering integrated intensity, the amorphous ratio X is calculated using the above Formula 1. Note that, the range of measurement is within a diffraction angle of 2θ=30° to 60° in which a halo derived from amorphousness can be confirmed. The difference between the actual integrated intensities measured using XRD and the integrated intensities calculated using the Lorentzian function is 1% or less in this range.

$$f ( x ) = \frac{h}{1 + \frac{{( x - u )}^{2}}{{w}^{2}}} + b \qquad ( 2 )$$

h: Peak height
u: Peak position
w: Half width
b: Background height

Hereinafter, a method of evaluating the amorphous ratio X using a STEM will be described.

First, any part of the magnetic core is cut off, and a resulting cross section of the magnetic core is observed with the STEM. The cross section may be observed at any magnification that is sufficiently high for evaluating the amorphous ratio X using the following method. In the STEM image generated in the observation, amorphous portions and crystalline portions are identified. The amorphous ratio X is defined by a ratio of the area of the amorphous portions to the total area of the amorphous portions and the crystalline portions.

The average crystal size can be evaluated through observation of a higher resolution image of the cross section captured with the STEM at a higher resolution.

Hereinafter, a method of manufacturing the soft magnetic alloy powder made of the soft magnetic alloy according to the present embodiment will be described.

Any method of manufacturing the soft magnetic alloy powder may be used. However, the present inventors have found that, when a soft magnetic alloy powder is produced from the soft magnetic alloy having the above composition by a gas atomization method using an elliptical water flow atomizing apparatus 10 described later, the average circularity of the large particles can be increased and the variance of circularity of the large particles are readily reduced. Hereinafter, the structure of the elliptical water flow atomizing apparatus 10 will be described.

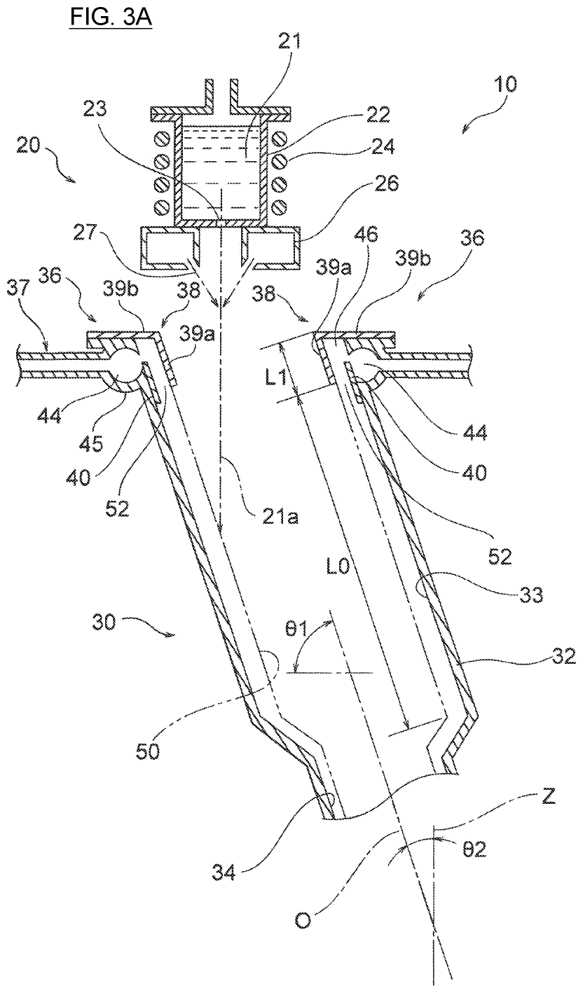

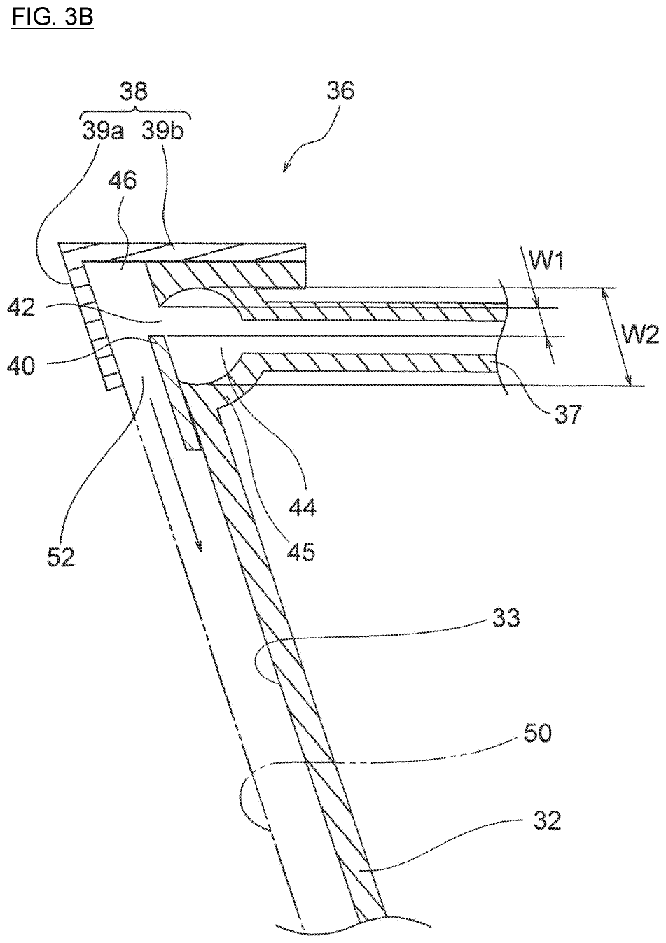

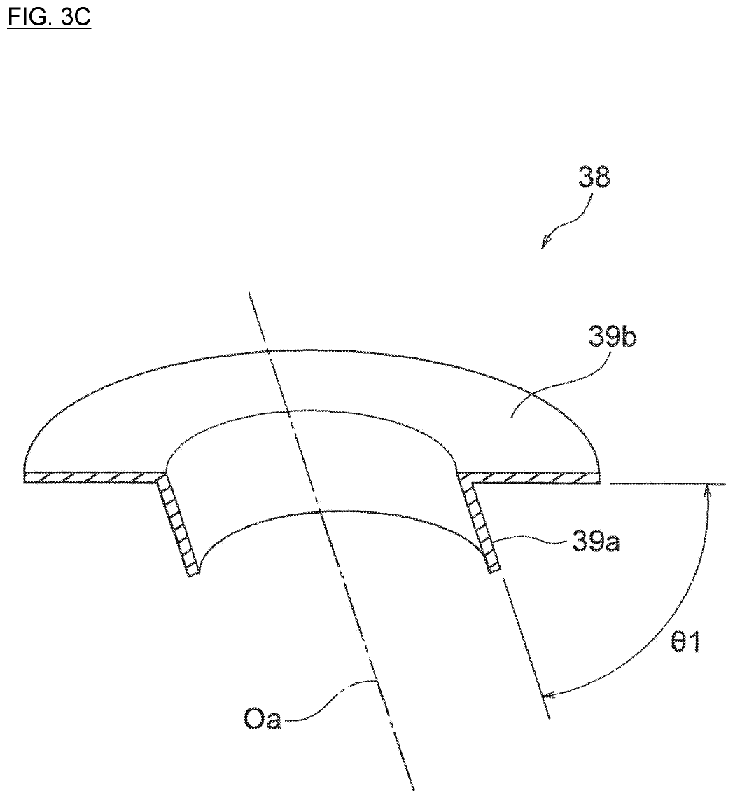

As shown in FIG. 3A, the elliptical water flow atomizing apparatus 10 according to the present embodiment is an apparatus for turning a molten metal 21 into a powder by the gas atomization method to give a soft magnetic alloy powder including multiple soft magnetic metal particles. The apparatus 10 includes a molten metal supply unit 20 and a cooling unit 30 disposed below the molten metal supply unit 20 in the vertical direction. In the drawings, the vertical direction is the direction along the Z-axis. Any method of producing the molten metal 21 may be used. For example, simple substances of elements included in the intended composition may be weighed and melted as raw material metals, or a soft magnetic alloy having the intended composition may be melted again.

The molten metal supply unit 20 includes a heat resistant container 22 for containing the molten metal 21. A heating coil 24 is disposed around the outer circumference of the heat resistant container 22, and the molten metal 21 contained in the container 22 is heated and maintained in a molten state. A molten metal discharge port 23 is provided at the bottom of the container 22, and the molten metal 21 is discharged as a molten metal drip 21a from the molten metal discharge port 23 towards an inner circumferential surface 33 of a tubular body 32 constituting the cooling unit 30.

Gas spray nozzles 26 are disposed at an outer portion of an outer bottom wall of the container 22 so as to surround the molten metal discharge port 23. Each gas spray nozzle 26 is provided with a gas spray port 27. From the gas spray ports 27, a high pressure gas is sprayed on the molten metal drip 21a discharged from the molten metal discharge port 23. The high pressure gas is sprayed diagonally downwards from the entire circumference of the molten metal discharged from the molten metal discharge port 23, and the molten metal drip 21a turns into multiple liquid drops and drips onto the inner circumferential surface 33 of the upper inside portion of the tubular body 32 along the gas flow.

With a short time of contact with air, the molten metal 21 having the above composition easily oxidizes to form an oxide film. Once the oxide film is formed, it is difficult for the liquid drops to become finer. Using an inert gas or a reducing gas as a gas sprayed from the gas spray ports 27 of the gas spray nozzles 26 can prevent formation of the oxide film and can easily turn the metal into powder.

Examples of inert gases include a nitrogen gas, an argon gas, and a helium gas. Examples of reducing gases include an ammonia decomposition gas.

In a cross section (e.g., a cross section substantially perpendicular to the Z-axis) inclined at an angle θ1 relative to an axis O of the tubular body 32 of the present embodiment, the inner circumferential surface 33 of at least the upper inside portion (to which the molten metal drip 21a is supplied) of the tubular body 32 shown in FIG. 3A has a substantially elliptical sectional shape. The angle θ1 can be represented by θ1=(90 degrees−θ2), provided that the axis O of the tubular body 32 is inclined at an angle θ2 relative to the Z-axis.

In the cross section inclined at the angle θ1 relative to the axis O of the tubular body 32, the direction of the major axis of the ellipse of the inner circumferential surface 33 preferably corresponds to the direction in which the axis O of the tubular body 32 is inclined relative to the Z-axis (vertical line). That is, the tubular body 32 is preferably structured so that the major axis of the ellipse is included in a plane containing the axis O of the tubular body 32 and the Z-axis intersecting the axis O.

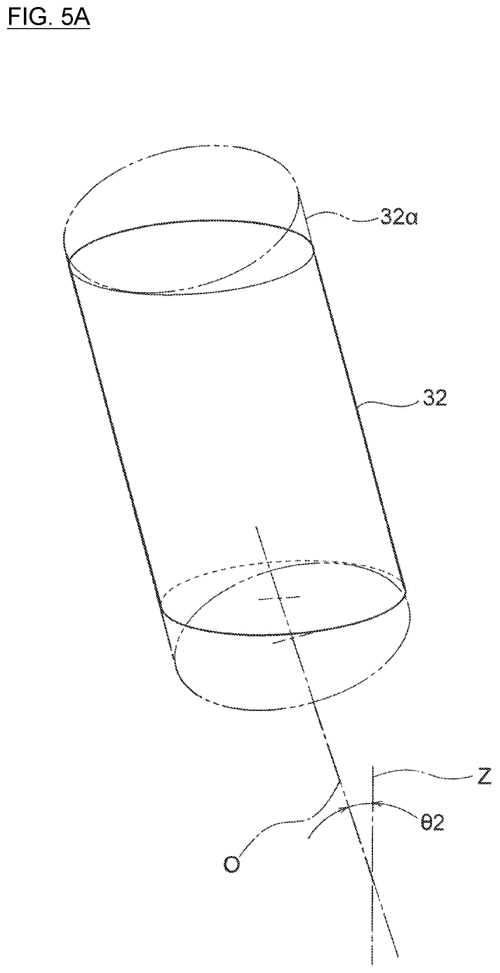

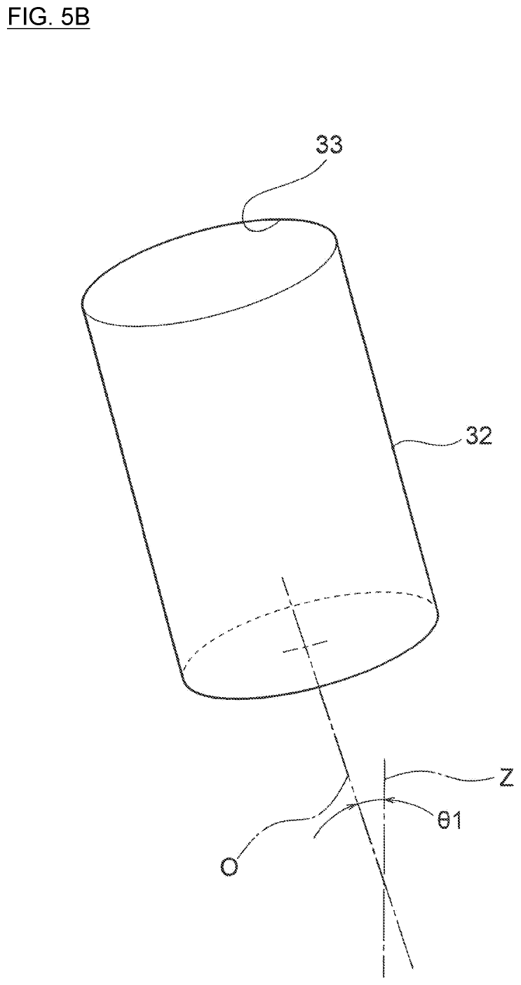

For example, as shown in FIG. 5A, the tubular body 32 structured in this manner can be manufactured from a cylindrical member 32a having an inner circumferential surface with a circular sectional shape perpendicular to the axis O. That is, the tubular body 32 shown in FIG. 3A can be formed by horizontally cutting the upper and lower portions of the cylindrical member 32a with its axis O inclined at the predetermined angle θ2 relative to the vertical direction (Z-axis direction). In the present embodiment, the inner circumferential surface 33 of the tubular body 32 is continuously provided around the axis O and has substantially elliptical sectional shapes with the same size inclined at the angle θ1 relative to the axis O.

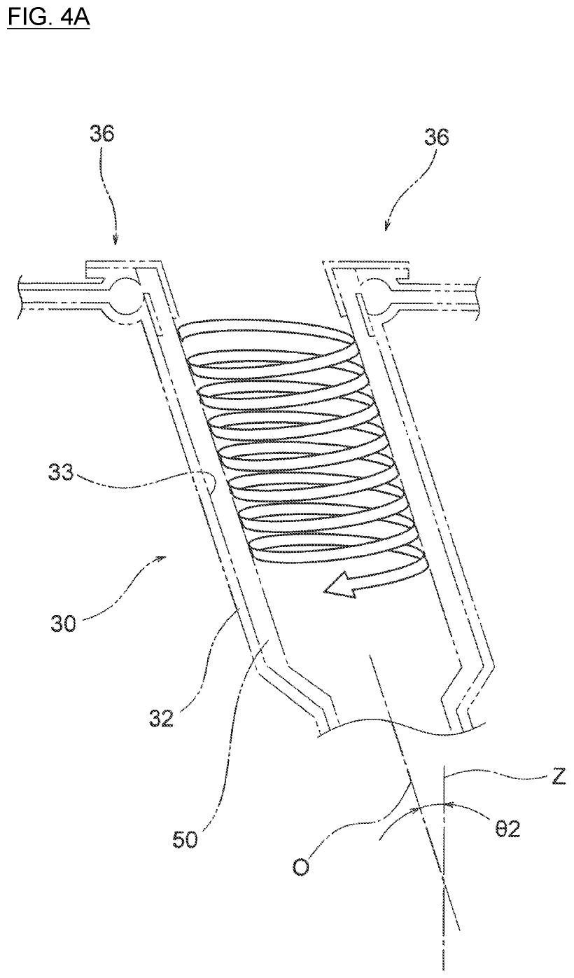

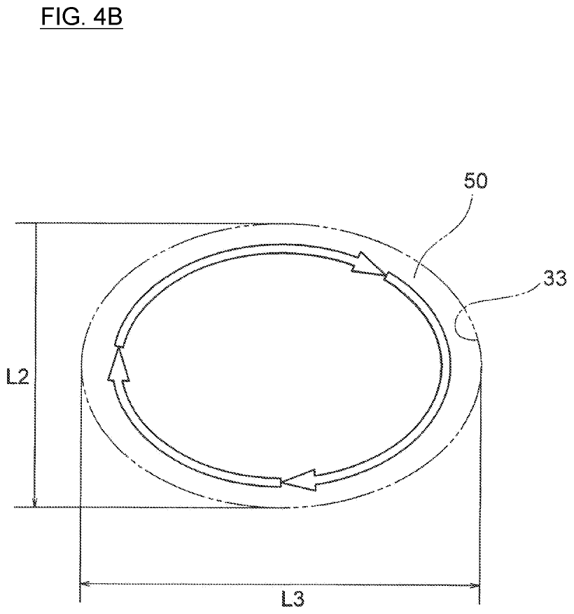

In the present embodiment, as shown in FIG. 4B, the ratio (L3/L2) of a long diameter L3 to a short diameter L2 of each elliptical shape at horizontal cross sections of the inner circumferential surface 33 of the tubular body 32 is preferably 1.01 or more and 3.00 or less, more preferably 1.04 or more and 2.00 or less, and most preferably 1.04 or more and 1.30 or less. With this structure, a cooling liquid layer 50 having a uniform thickness can be easily formed at a changing flow speed of a cooling liquid (e.g., cooling water). For example, when L3/L2 is 1.04 to 3.00, the ratio (maximum speed/minimum speed) of the flow speed of the cooling liquid can be about 1.07 to about 1.33, although change in the ratio depends on the flow amount, fluid pressure, thickness, etc. of the cooling liquid layer 50.

As shown in FIG. 3A, a discharge port 34 is provided below along the axis O of the tubular body 32. Through the discharge port 34, the soft magnetic alloy powder contained and flowed in the cooling liquid layer 50 can be discharged outside together with the cooling liquid. The inner diameter of the inner circumferential surface of the discharge port 34 may be smaller than that of the inner circumferential surface 33 of the tubular body 32. Preferably, the inner diameter continuously decreases from the inner circumferential surface 33 of the tubular body 32 to the inner circumferential surface of the discharge port 34. A horizontal cross section of the inner circumferential surface of the discharge port 34 is not necessarily elliptical and may be circular. Preferably, horizontal sectional shapes of the inner circumferential surface 33 of the tubular body 32 anywhere from the upper portion of the tubular body 32 to the discharge port 34 along the axis O are ellipses having the same size.

A cooling liquid introduction unit 36 is provided at the upper portion, along the axis O, of the tubular body 32. As shown in FIG. 3B, the cooling liquid introduction unit 36 includes a frame 38 and an outer member (outer-frame member) 45. The outer member 45 may be formed integrally with the tubular body 32. The outer member 45 may be formed separately from the tubular body 32 and attached to the tubular body 32.

At the upper portion of the tubular body 32, the outer member 45 defines an outside space 44 outside the inner circumferential surface 33. An auxiliary tubular body 40 is attached to the inner circumferential surface of the upper portion of the tubular body 32. The auxiliary tubular body 40 may be the upper opening edge of the tubular body 32 itself. However, in the illustrated example, the auxiliary tubular body 40 is formed separately from the tubular body 32 and is attached to the inner circumferential surface of the upper portion of the tubular body 32. The inner circumferential surface of the auxiliary tubular body 40 is preferably flush with the inner circumferential surface 33 of the tubular body 32 but may not be flush with the inner circumferential surface 33. The frame 38 may be formed integrally with the tubular body 32. However, the frame 38 is preferably formed separately from the tubular body 32. The frame 38 includes an inner frame piece 39a disposed inwards from the inner circumferential surface of the tubular body 32 and a frame support piece 39b meeting the inner frame piece 39a at a predetermined angle. As shown in FIG. 3C, the frame support piece 39b is a plate piece having a substantially elliptical ring shape. The inner frame piece 39a has a substantially elliptical tubular shape having a center axis Oa inclined at the angle θ1 relative to the major axis of the substantially elliptical central opening of the frame support piece 39b.

The axis Oa of the inner frame piece 39a shown in FIG. 3C corresponds to the axis O of the tubular body 32 shown in FIG. 3A. A horizontal cross section of the outer circumferential surface of the inner frame piece 39a shown in FIG. 3C has an elliptical shape that has a smaller inner diameter than the elliptical shape of a horizontal cross section of the inner circumferential surface 33 of the tubular body 32 shown in FIG. 3A (or the inner circumferential surface of the auxiliary tubular body 40) and is similar to the horizontal sectional shape of the inner circumferential surface 33. That is, the outer circumferential surface of the inner frame piece 39a has a diameter that is smaller than the diameter of the inner circumferential surface 33 of the tubular body 32 (or the inner circumferential surface of the auxiliary tubular body 40) and is parallel to the inner circumferential surface 33 of the tubular body 32 (or the inner circumferential surface of the auxiliary tubular body 40).

As shown in FIG. 3A, an outer radial portion of the frame support piece 39b may be attached to an upper end of the outer member 45 or an upper end of the tubular body 32. Alternatively, the outer radial portion of the frame support piece 39b may be formed integrally with the upper end of the outer member 45 or the upper end of the tubular body 32. Together with the inner circumferential surface of the tubular body 32, the inner circumferential surface of the auxiliary tubular body 40, and/or the inner circumferential surface of the outer member 45, an inner radial portion of the frame support piece 39b and the inner frame piece 39a define an inside space 46 inwards from the inner circumferential surface 33, at the upper portion of the tubular body 32.

As shown in FIG. 3B, at the upper portion of the tubular body 32, together with the tubular body 32 (including the auxiliary tubular body 40), the outer member 45 defines the outside space 44 outwards from the inner circumferential surface 33. The inside space 46 is located radially inwards from the outside space and communicates with the outside space 44 via a passage 42. An upper end of the auxiliary tubular body 40 or the upper end of the tubular body 32 is located between the outside space 44 and the inside space so that the passage 42 is provided at or near the top of the outside space 44 along the axis O of the tubular body 32.

In the present embodiment, the outside space 44 is provided in a substantially elliptical ring shape horizontally continuing outwards from the inner circumferential surface 33 of the tubular body 32. The inside space 46 is provided in a substantially elliptical ring shape horizontally continuing inwards from the inner circumferential surface 33 of the tubular body 32 along the inner circumferential surface 33. Likewise, the passage 42 is provided in a substantially elliptical ring shape continuing horizontally. A width W1 of the passage 42 along the axis O is smaller than a width W2 of the outside space 44 in the axial direction. W1/W2 may be ½ or less.

A cooling liquid supply line 37 for introducing the cooling liquid is attached radially outwards from the outer member 45. Preferably, a connection port from the supply line 37 to the outside space 44 is located below the level of the passage 42 along the axis O.

Preferably, in the outside space 44, the cooling liquid introduced from the supply line 37 flows from the bottom to the top of the outside space and enters the inside space 46 through the passage 42. A lower end of the inner frame piece 39a for defining the inside space 46 is preferably located below the level of the passage 42 along the axis O, and a cooling liquid discharge port 52 is provided between the lower end of the inner frame piece 39a and the inner circumferential surface 33 of the tubular body 32 (including the inner circumferential surface of the auxiliary tubular body 40). As shown in FIG. 3C, the lower end of the inner frame piece 39a defines a substantially elliptical opening in a horizontal plane.

A radially inner side of the cooling liquid discharge port 52 is defined by the outer circumferential surface of the inner frame piece 39a, and a radially outer side of the cooling liquid discharge port 52 is defined by the inner circumferential surface of the tubular body 32 (the inner circumferential surface of the auxiliary tubular body 40). Preferably, the cooling liquid discharge port 52 is provided in a substantially elliptical ring shape continuing along the circumferential direction in a horizontal cross section.

The cooling liquid discharge port 52 is connected to the inside space 46. The cooling liquid in the inside space 46 is blown out in an elliptical spiral manner through the cooling liquid discharge port 52 to the inner circumferential surface 33 of the tubular body 32. In the present embodiment, the cooling liquid discharge port 52 may have any radial width. The radial width of the cooling liquid discharge port 52 corresponds to the thickness of the cooling liquid layer 50 in which the cooling liquid flows along the inner circumferential surface of the tubular body 32. Thus, the radial width of the cooling liquid discharge port 52 is determined in relation to the thickness of the cooling liquid layer 50.

As shown in FIG. 3A, the inner frame piece 39a has an axial length L1 to the extent that L1 covers the width W1 of the passage 42 shown in FIG. 3B in the direction of the axis O. The axial length L1 of the inner frame piece 39a is determined so that the cooling liquid discharge port 52 is provided further upstream than the point at which the molten metal discharged from the molten metal supply unit 20 touches the cooling liquid layer 50. Moreover, as shown in FIG. 3A, the axial length L1 of the inner frame piece 39a is determined so that the liquid surface of the cooling liquid layer 50 having a sufficient axial length LO is exposed at the inner circumferential surface 33 of the tubular body 32.

Preferably, the length LO of the cooling liquid layer 50 exposed inside along the axis O is 5 to 500 times larger than the length L1 of the inner frame piece 39a. The inner diameter of the inner circumferential surface 33 of the tubular body 32 (the short diameter of the ellipse) is not limited and is preferably 50 to 500 mm.

In the present embodiment, the cooling liquid supply line 37 may be connected in the tangential direction of the cooling liquid introduction unit 36. The cooling liquid can enter the outside space 44 from the cooling liquid supply line 37 so as to spiral around the axis O in an elliptical spiral manner. The cooling liquid that has entered the outside space 44 in a spiral manner passes through the passage 42 and enters the inside space 46 in a spiral manner.

In the cooling liquid introduction unit 36 of the present embodiment, the cooling liquid is temporarily stored in the outside space 44 disposed outwards from the tubular body 32. The outside space 44 has a substantially elliptical shape. With this structure, the cooling liquid circling in an elliptical manner in the outside space 44 is introduced into the inside space 46.

In the present embodiment, a lower end of the passage 42 is provided at a level higher than that of a lower end of the outside space 44. Thus, the cooling liquid circling in the elliptical spiral manner in the outside space 44 is once raised upwards. Then, the cooling liquid passes through the passage 42 and enters the inside space 46. As the cooling liquid passes through the passage 42, the flow speed of the cooling liquid entering the inside space 46 located at the upper inside portion of the tubular body 32 increases. The cooling liquid then collides with the inner frame piece 39a of the inside space 46 to change the flowing direction of the cooling liquid.

The cooling liquid that has passed through the passage 42 at the upper portion of the tubular body 32 and entered the inside space 46 in an elliptical spiral manner flows downwards along the inner frame piece 39a (along the axis O). The frame support piece 39b blocks the upward flow of the cooling liquid. The cooling liquid flows in an elliptical ring shaped manner along the inner circumferential surface 33 around the axis O in the inside space 46. The force of gravity acts on the cooling liquid downwards along the inner circumferential surface 33 (along the axis O). Due to synergy between the cooling liquid and the force of gravity, the cooling liquid is discharged from the cooling liquid discharge port 52 along the inner circumferential surface 33 so as to flow in a substantially elliptical spiral orbit. The cooling liquid discharged from the cooling liquid discharge port 52 forms the cooling liquid layer 50 in which the cooling liquid flows in an elliptical spiral manner at a substantially constant thickness along the inner circumferential surface 33.

As shown in FIG. 3A, in the present embodiment, the cooling liquid is supplied from the cooling liquid introduction unit 36 to the inner circumferential surface 33 having an elliptical shape at the upper inside portion of the tubular body 32. Thus, the cooling liquid layer 50 in which the cooling liquid flows in the substantially elliptical spiral manner along the inner circumferential surface 33 of the tubular body 32 can be formed. Because the molten metal drip 21a, which includes droplets of the molten metal 21, is sprayed onto an inner liquid surface of the cooling liquid layer 50, the molten metal drip 21a can be cooled more rapidly. As shown in FIGS. 4A and 4B, the flow speed of the cooling liquid flowing in the elliptical spiral manner is faster at a short diameter side of the ellipse and slower at a long diameter side of the ellipse. The molten metal drip 21a sprayed onto the cooling liquid layer 50 flows in the cooling liquid layer 50 together with the cooling liquid at a changing flow speed.

Because the molten metal drip 21a flows in the cooling liquid layer 50 together with the cooling liquid at the changing flow speed, a vapor film, which is presumably generated immediately after contact with the cooling liquid, around the molten metal drip 21a is readily peeled from the molten metal drip 21a. Consequently, the molten metal drip 21a is readily cooled rapidly in the cooling liquid layer 50. Cooling the molten metal drip 21a rapidly in such a manner enables manufacture of a soft magnetic alloy powder having good amorphousness and good magnetic characteristics despite the fine particle size.

As shown in FIG. 3A, in the present embodiment, the cooling liquid discharge port 52 is continuously formed in a substantially elliptical shape in the circumferential direction of the tubular body 32. However, the cooling liquid discharge port 52 may be provided with, for example, a reinforcing member and be formed intermittently in the circumferential direction of the tubular body 32. Because the cooling liquid discharge port 52 is formed in the circumferential direction of the tubular body 32, the cooling liquid flowing in the elliptical spiral manner along the inner circumferential surface 33 of the tubular body 32 can form the cooling liquid layer 50.

In the present embodiment, as shown in FIG. 3A, the cooling liquid introduction unit 36 can have the cooling liquid discharge port 52 having the substantially elliptical shape between the inner frame piece 39a and the inner circumferential surface 33 of the tubular body 32. Consequently, the cooling liquid flowing in the elliptical spiral manner along the inner circumferential surface 33 of the tubular body 32 can be discharged from the cooling liquid discharge port 52.

In the present embodiment, as shown in FIG. 3A, the center of the ellipse formed by the inner circumferential surface 33 is shifted relative to the vertical line (Z-axis) by the angle θ2 towards the lower portion of the tubular body 32. As shown in FIG. 4A, the cooling liquid forming the cooling liquid layer 50 along the inner circumferential surface 33 flows in the elliptical spiral orbit inclined relative to the vertical direction (the direction of gravity).

Thus, provided that a conventional atomizing apparatus and the atomizing apparatus of the present embodiment have the same length of the cooling liquid layer 50 in the Z-axis direction, the distance of the elliptical spiral in which the cooling liquid flows in the atomizing apparatus of the present embodiment can be longer. Because the molten metal is sprayed in the direction of gravity onto one point along the long axis of the ellipse of the inner circumferential surface 33 of the tubular body 32, the molten metal drip 21a readily reaches the inner circumferential surface 33 of the tubular body 32 (enters the cooling liquid layer 50) from the upper end opening of the tubular body 32. Thus, the droplets can be cooled smoothly.

In the above-mentioned embodiment, horizontal sectional shapes of the inner circumferential surface 33 of the tubular body 32 anywhere from the upper portion of the tubular body 32 to the discharge port 34 along the axis O are ellipses having the same size. However, horizontal cross sections of the inner circumferential surface 33 of the tubular body 32 have a substantially elliptical shape at least at the upper portion of the tubular body 32 and may have a different shape changing towards the discharge port 34 along the axis O. For example, the shapes of the cross sections may gradually change from the substantially elliptical shape to a substantially circular shape (or other shapes) along the axis O, starting from the upper portion of the tubular body 32 towards the discharge port 34.

The ratio (L3/L2) of the long diameter L3 to the short diameter L2 of a horizontal elliptical cross section of the inner circumferential surface 33 of the tubular body 32 is preferably constant from the upper portion of the tubular body 32 towards the discharge port 34 along the axis O. However, the ratio (L3/L2) may change. For example, the ratio (L3/L2) may change so as to be smaller, larger, or both alternately from the upper portion of the tubular body 32 towards the discharge port 34 along the axis O.

The direction of the long diameter of the elliptical shape of the horizontal cross section of the inner circumferential surface 33 of the tubular body 32 may change gradually from the upper portion of the tubular body 32 towards the discharge port 34 along the axis O. For example, the direction of the long diameter of the elliptical shape at the upper portion of the tubular body 32 may correspond to the inclination direction of the axis O of the tubular body 32, and the direction of the long diameter of the elliptical shape at the lower portion of the tubular body 32 may be substantially perpendicular to the inclination direction of the axis O of the tubular body 32.

In the present embodiment, the predetermined angle θ2 formed by the axis O of the tubular body 32 and the vertical direction is not limited and is preferably 5 to 45 degrees. Such an angle range enables the molten metal drip 21a to be easily discharged from the molten metal discharge port 23 into the cooling liquid layer 50 at the inner circumferential surface 33 of the tubular body 32.

In the present embodiment, the cooling liquid introduction unit 36 is formed so that the frame support piece 39b is horizontal. However, the cooling liquid introduction unit 36 may be formed differently as long as the cooling liquid introduction unit 36 is structured to discharge the cooling liquid layer 50 in the elliptical spiral manner.

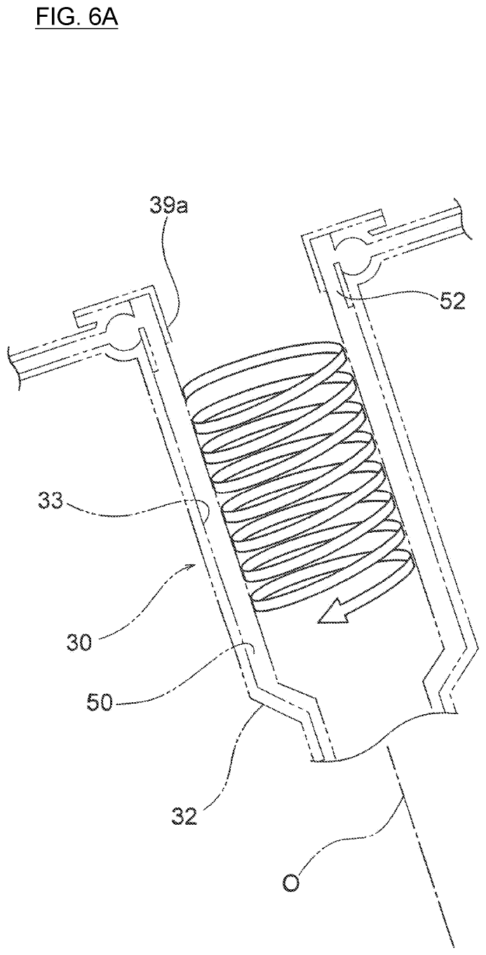

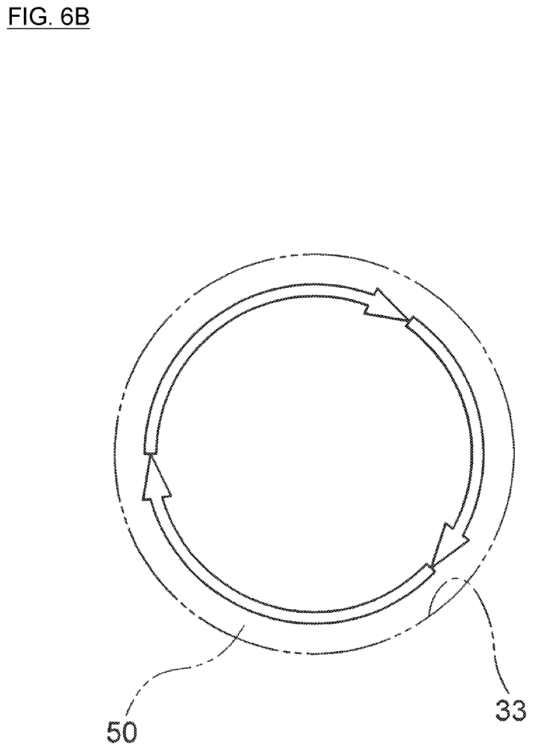

In contrast, as shown in FIGS. 6A and 6B, a cross section perpendicular to the axis O of the inner circumferential surface 33 of the tubular body 32 of a conventional atomizing apparatus is circular (L3/L2=1.00). Additionally, the lower end of the inner frame piece 39a of the cooling liquid introduction unit of the conventional atomizing apparatus defines an opening having a circular sectional shape perpendicular to the axis O, and the cooling liquid discharge port 52 thereof has a circular shape.

The particle size of the soft magnetic alloy powder can be adjusted by appropriately changing atomizing conditions. The particle size can also be adjusted by dry classification, wet classification, etc. Examples of dry classification methods include dry sieving and air flow classification. Examples of wet classification methods include wet filtration classification using a filter and classification by centrifuging.

The soft magnetic alloy powder according to the present embodiment may include an insulation coating.

Press molding the resulting soft magnetic alloy powder can give a magnetic core. Any method of molding may be used. As one example, a method of producing the magnetic core by press molding will be described.

First, the soft magnetic alloy powder and a resin are mixed. Mixing the powder with the resin makes it easier to give a pressed body having high strength by molding. The resin may be any type of resin. Examples of the resin include a phenol resin and an epoxy resin. The amount of the resin is not limited. When the resin is added, 1 mass % or more and 5 mass % or less of the resin may be added with respect to the magnetic powder.

A mixture of the soft magnetic alloy powder and the resin is granulated to give a granulated powder. Any method of granulation may be used. For example, a stirrer may be used for granulation. The granulated powder may have any particle size. The granulated powder is press molded to give the pressed body. The press molding pressure is not limited. For example, the pressure may be 0.1 t/cm² or more and 20 t/cm² or less. When the soft magnetic alloy powder that is produced with the elliptical water flow atomizing apparatus and has the above composition is used, the relative permeability (μ) can be increased with a relatively smaller press molding pressure, compared to when a conventional atomizing apparatus is used. Additionally, the core loss and the DC superimposition characteristics of the magnetic core can be improved compared to when a conventional atomizing apparatus is used.

Hardening the resin included in the pressed body can give the magnetic core. Any hardening method may be used, and a heat treatment may be performed under conditions that enable hardening of the resin.

The magnetic core may be used for any purpose. For example, the magnetic core can be suitably used as a magnetic core for an inductor, particularly a power inductor. Further, the magnetic core can be suitably used for an inductor integrally including the magnetic core and a coil.

Further, the above-mentioned magnetic core and a magnetic component including the above-mentioned magnetic core can be suitably used for an electronic device. In particular, because the above-mentioned magnetic core readily has relatively low core loss and relatively high DC superimposition characteristics, the above-mentioned magnetic core is suitably used in fields in need of smaller size, higher frequency, higher efficiency, and energy saving. For example, the above-mentioned magnetic core can be suitably used as a magnetic core implemented in ICT equipment, electric vehicles, etc. and for a magnetic component and an electronic device.

### EXAMPLES

Hereinafter, the present invention will be specifically described with examples.

### Experiment 1

### Soft Magnetic Alloy Powder

Raw material metals were weighed and melted by high-frequency heating to produce a mother alloy having a composition of (Fe_{0.700}Co_{0.300})_{0.820}B_{0.110}P_{0.020}Si_{0.030}C_{0.010}Cr_{0.010} in atomic ratio.

The mother alloy was heated and melted to give a metal in a molten state having a temperature of 1500° C. Then, a gas atomization method was used to produce a soft magnetic alloy powder having the composition of samples. Specifically, when the molten mother alloy was discharged from a discharge port to a cooling part in a tubular body, a high-pressure gas was sprayed to a discharged molten metal drip. The high-pressure gas was an N₂ gas. The molten metal drip collided with the cooling part (cooling water), cooled, and solidified to form the soft magnetic alloy powder.

For the samples marked with “Conventional apparatus” in the atomizing apparatus column of a table, a conventional atomizing apparatus shown in FIGS. 6A and 6B was used. For the samples marked with “Elliptical water flow apparatus” in the atomizing apparatus column of a table, an elliptical water flow atomizing apparatus shown in FIGS. 3A, 3B, 3C, 4A, 4B and 5A was used.

As for gas atomizing conditions, the sprayed amount of the molten metal was 0.8 to 12 kg/min; the gas spraying pressure was 0.5 to 9 MPa; and the cooling water pressure was 2 to 30 MPa. The above conditions were appropriately controlled so as to give the intended soft magnetic alloy powder.

It was confirmed that, in each sample, the composition of the mother alloy and the composition of the powder were approximately the same by ICP analysis. An X-ray diffraction measurement was performed for each powder used in Experiments 1 to 3 to check its microstructure. In Experiments 1 to 3, it was confirmed that all powders had an amorphous structure.

The number-based D50 and the number-based D 90 of each sample were measured by observing the shapes of 20,000 particles of the powder using Morphologi G3 (Malvern Panalytical) at a magnification of 10×. Specifically, 3 cc (volume) of the powder was dispersed at an air pressure of 1 bar to 3 bars to take projections with a laser microscope. The Heywood diameter of each particle of the powder in the projections was measured as a particle size.

The corresponding particle size at a number-based cumulative relative frequency of 50% was defined as D50. The corresponding particle size at a number-based cumulative relative frequency of 90% was defined as D 90. Table 1 shows the results. Particles having a particle size of (0.95×D90) or more and (1.05×D90) or less were identified as large particles.

From the projections of the large particles, their circularities were measured, and the average circularity of the large particles and the variance of circularity of the large particles were calculated. Table 1 shows the results.

### Soft Magnetic Alloy Ribbon for Bs Measurement

A soft magnetic alloy ribbon having the same composition as the above soft magnetic alloy powder or, more specifically, a soft magnetic alloy ribbon for Bs measurement having a composition of (Fe_{0.700}Co_{0.300})_{0.820}B_{0.110}P_{0.020}Si_{0.030}C_{0.010}Cr_{0.010} in atomic ratio, was manufactured by a single-roll method.

First, pure substances of the elements were prepared and weighed so that the soft magnetic alloy ribbon for Bs measurement obtained in the end would have the intended composition. The pure substances of the elements were melted by high-frequency heating to produce a mother alloy.

Then, the mother alloy was heated and melted to give a metal in a molten state having a temperature of 1300° C. Then, the single-roll method was used to spray the molten metal to a roll having a temperature of 30° C. rotating at 25 m/sec in air to produce the soft magnetic alloy ribbon for Bs measurement. The ribbon had a thickness of 20 to 25 μm, a width of about 5 mm, and a length of about 70 m. The material of the roll was Cu.

An X-ray diffraction measurement of the soft magnetic alloy ribbon for Bs measurement was performed to confirm that the ribbon was amorphous.

It was confirmed that the composition of the mother alloy and the composition of the soft magnetic alloy ribbon for Bs measurement were approximately the same by ICP analysis.

Bs of the soft magnetic alloy ribbon was measured with a vibrating sample magnetometer (VSM) at a magnetic field of 1000 kA/m. Table 1 shows the results. When Bs of the soft magnetic alloy ribbon was 1.30 T or more, Bs of the soft magnetic alloy powder was deemed good.

### Magnetic Core

A toroidal core was produced using the soft magnetic alloy powder of each sample.

First, the soft magnetic alloy powder and a resin (phenol resin) were mixed so that the amount of the resin was 3 parts by mass with respect to 100 parts by mass of the soft magnetic alloy powder. Then, the mixture was granulated with a planetary mixer, which was a general stirrer, to give a granulated powder having a particle size of about 500 μm. The granulated powder was press molded into a toroidal pressed body having an outer diameter of φ11 mm, an inner diameter of φ6.5 mm, and a height of 6.0 mm. The molding pressure (surface pressure) was appropriately controlled so that the magnetic core obtained in the end had relative permeability (μ) shown in Table 1. The pressed body was hardened at 150° C. to give the toroidal core. As many number of toroidal cores as necessary for the tests described below were produced.

A method of measuring the number-based D50 and the number-based D90 of the soft magnetic alloy particles included in the magnetic core (toroidal core) of each sample will be described. First, any part of the magnetic core (toroidal core) of each sample was cut off, and a resulting cross section of the magnetic core was observed with a SEM at a magnification of 500×. The field of view was as large so that at least 2,000 soft magnetic alloy particles could be observed. The equivalent circle diameters (Heywood diameters) of all soft magnetic alloy particles in the above field of view were calculated. The corresponding particle size at a number-based cumulative relative frequency of 50% was defined as D50. The corresponding particle size at a number-based cumulative relative frequency of 90% was defined as D90. Table 1 shows the results. Particles having a particle size of (0.95×D90) or more and (1.05×D90) or less were identified as large particles.

The circularity of each large particle was measured, and the average circularity of the large particles and the variance of circularity of the large particles were calculated. Table 1 shows the results.

A UEW wire was wound around the toroidal core to measure the relative permeability (μ) with 4284A PRECISION LCR METER (Hewlett-Packard) at 100 kHz. Table 1 shows the results.

The coercivity (Hc) was measured using an HC meter (K-HC1000 manufactured by Tohoku Steel Co., Ltd.) for the toroidal core. Table 1 shows the results.

As for the packing density, first, the density of the toroidal core was calculated using its dimensions and mass. Then, the calculated density of the toroidal core was divided by the true density, which was the density calculated using the mass ratio of the soft magnetic alloy powder, to calculate the packing density (relative density). Table 1 shows the results.

As for the core loss, first, a primary wire was wound around each toroidal core for 20 turns, and a secondary wire was wound therearound for 14 turns. Then, iron loss at 300 kHz, 50 mT, 20° C. to 25° C. was measured with a B-H analyzer (SY-8232 manufactured by IWATSU ELECTRIC CO., LTD.). Table 1 shows the results.

The ratio of the core loss of a sample in which the elliptical water flow apparatus was used to the core loss of a sample in which the conventional apparatus was used was calculated in the cases in which μ was the same between the two. Specifically, the ratio of the core loss of Sample No. 1b to the core loss of Sample No. 4a, the ratio of the core loss of Sample No. 2b to the core loss of Sample No. 5a, the ratio of the core loss of Sample No. 3b to the core loss of Sample No. 6a, the ratio of the core loss of Sample No. 4b to the core loss of Sample No. 7a, the ratio of the core loss of Sample No. 5b to the core loss of Sample No. 8a, and the ratio of the core loss of Sample No. 6b to the core loss of Sample No. 9a were calculated. Table 1 shows the results.

As for Isat, the inductance was measured while a direct current was applied from 0 A to each toroidal core. The direct current at which the inductance was reduced to 10% of the inductance at a direct current of 0 A was defined as Isat. The inductance was measured with an LCR meter (manufactured by Hewlett-Packard). In this measurement, the measurement frequency was 100 kHz, and the measurement voltage was 0.5 mV. Table 1 shows the results.

Further, the ratio of Isat of a sample in which the elliptical water flow apparatus was used to Isat of a sample in which the conventional apparatus was used was calculated in the cases in which μ was the same between the two. Specifically, the ratio of Isat of Sample No. 1b to Isat of Sample No. 4a, the ratio of Isat of Sample No. 2b to Isat of Sample No. 5a, the ratio of Isat of Sample No. 3b to Isat of Sample No. 6a, the ratio of Isat of Sample No. 4b to Isat of Sample No. 7a, the ratio of Isat of Sample No. 5b to Isat of Sample No. 8a, and the ratio of Isat of Sample No. 6b to Isat of Sample No. 9a were calculated. Table 1 shows the results.

TABLE 1

| | | | | | | | | Magnetic core |
|---|---|---|---|---|---|---|---|---|
| | | Soft magnetic alloy powder | | | | | | Manufacturing |
| | | | Particle | | Circularity of | | | condition |
| | | | size | | large particles | | Ribbon | Molding |
| Sample | Comparative Example/ | Manufacturing condition | D50 | D90 | Average | Variance | Bs | pressure |
| No. | Example | Atomizing apparatus | μm | μm | (—) | (—) | T | t/cm² |
| 1a | Comparative Example | Conventional apparatus | 7.6 | 17.4 | 0.71 | 0.044 | 1.70 | 0.5 |
| 2a | Comparative Example | Conventional apparatus | 7.6 | 17.4 | 0.71 | 0.044 | 1.70 | 1.0 |
| 3a | Comparative Example | Conventional apparatus | 7.6 | 17.4 | 0.71 | 0.044 | 1.70 | 2.0 |
| 4a | Comparative Example | Conventional apparatus | 7.6 | 17.4 | 0.71 | 0.044 | 1.70 | 4.0 |
| 5a | Comparative Example | Conventional apparatus | 7.6 | 17.4 | 0.71 | 0.044 | 1.70 | 8.0 |
| 6a | Comparative Example | Conventional apparatus | 7.6 | 17.4 | 0.71 | 0.044 | 1.70 | 12.0 |
| 7a | Comparative Example | Conventional apparatus | 7.6 | 17.4 | 0.71 | 0.044 | 1.70 | 14.0 |
| 8a | Comparative Example | Conventional apparatus | 7.6 | 17.4 | 0.71 | 0.044 | 1.70 | 16.0 |
| 9a | Comparative Example | Conventional apparatus | 7.6 | 17.4 | 0.71 | 0.044 | 1.70 | 18.0 |
| 1b | Example | Elliptical water flow apparatus | 7.8 | 17.8 | 0.94 | 0.004 | 1.70 | 0.5 |
| 2b | Example | Elliptical water flow apparatus | 7.8 | 17.8 | 0.94 | 0.004 | 1.70 | 1.0 |
| 3b | Example | Elliptical water flow apparatus | 7.8 | 17.8 | 0.94 | 0.004 | 1.70 | 2.0 |
| 4b | Example | Elliptical water flow apparatus | 7.8 | 17.8 | 0.94 | 0.004 | 1.70 | 4.0 |
| 5b | Example | Elliptical water flow apparatus | 7.8 | 17.8 | 0.94 | 0.004 | 1.70 | 8.0 |
| 6b | Example | Elliptical water flow apparatus | 7.8 | 17.8 | 0.94 | 0.004 | 1.70 | 12.0 |

| | Magnetic core | | | | | | | | |
|---|---|---|---|---|---|---|---|---|---|
| | Particle | | Circularity of | | Characteristics | | | | |
| | size | | large particles | | | Packing | | Core | |
| Sample | D50 | D90 | Average | Variance | Hc | density | μ | loss | Isat |
| No. | μm | μm | (—) | (—) | Oe | (—) | (—) | kW/m³ | A |
| 1a | 9.5 | 24.7 | 0.68 | 0.048 | 1.3 | 72% | 22.6 | 1048 | 9.2 |
| 2a | 9.5 | 24.2 | 0.67 | 0.048 | 1.6 | 72% | 23.1 | 1098 | 9.2 |
| 3a | 9.8 | 24.9 | 0.66 | 0.049 | 2.2 | 72% | 23.2 | 1132 | 9.2 |
| 4a | 9.6 | 24.5 | 0.65 | 0.050 | 3.4 | 73% | 23.6 | 1189 | 9.3 |
| 5a | 9.5 | 23.8 | 0.63 | 0.052 | 5.7 | 75% | 24.3 | 1547 | 9.3 |
| 6a | 9.8 | 25.2 | 0.60 | 0.053 | 8.1 | 76% | 25.2 | 1910 | 9.4 |
| 7a | 9.7 | 25.2 | 0.58 | 0.054 | 9.3 | 77% | 25.4 | 1998 | 9.4 |
| 8a | 9.4 | 24.4 | 0.57 | 0.054 | 10.5 | 78% | 26.0 | 1964 | 9.4 |
| 9a | 9.4 | 24.2 | 0.56 | 0.054 | 11.7 | 78% | 27.0 | 1946 | 9.5 |
| 1b | 9.8 | 24.4 | 0.94 | 0.003 | 1.4 | 73% | 23.6 | 786 | 11.5 |
| 2b | 9.8 | 24.6 | 0.94 | 0.004 | 1.7 | 73% | 24.3 | 905 | 11.5 |
| 3b | 9.7 | 24.3 | 0.94 | 0.004 | 2.3 | 73% | 25.2 | 1024 | 11.8 |
| 4b | 9.7 | 24.3 | 0.94 | 0.004 | 3.3 | 74% | 25.4 | 1083 | 11.7 |
| 5b | 9.7 | 24.6 | 0.92 | 0.005 | 5.5 | 75% | 26.0 | 1143 | 11.7 |
| 6b | 9.8 | 24.5 | 0.91 | 0.006 | 7.6 | 76% | 27.0 | 1202 | 11.7 |

According to Table 1, D50 and D90 of the soft magnetic alloy powder did not significantly change even when the atomizing apparatus was changed from the conventional apparatus to the elliptical water flow apparatus. However, when the atomizing apparatus was changed from the conventional apparatus to the elliptical water flow apparatus, the average circularity of the large particles included in the soft magnetic alloy powder increased. When the atomizing apparatus was changed from the conventional apparatus to the elliptical water flow apparatus, the variance of circularity of the large particles included in the soft magnetic alloy powder was reduced.

Sample Nos. 1a and 1b, in which the magnetic cores were produced under the same conditions except for the atomizing apparatus, were compared. Hc was about the same between Sample Nos. 1a and 1b. The packing density was about the same between Sample Nos. 1a and 1b. The relative permeability (μ) was higher in Sample No. 1b. The core loss was lower in Sample No. 1b. Isat was higher in Sample No. 1b. That is, changing the atomizing apparatus from the conventional apparatus to the elliptical water flow apparatus enabled maintenance of Hc and the packing density at about the same levels, increase of μ, reduction of the core loss, and increase of the DC superimposition characteristics.

In comparisons between Sample Nos. 2 and 2b, between Sample Nos. 3a and 3b, between Sample Nos. 4a and 4 b, between Sample Nos. 5a and 5b, and between Sample Nos. 6a and 6b, in which the magnetic cores were produced under the same conditions except for the atomizing apparatus, the results were the same as the results of the comparison between Sample Nos. 1a and 1b.

It was confirmed that, when the atomizing apparatus was changed from the conventional apparatus to the elliptical water flow apparatus, the magnetic cores having a low packing density and about the same μ as when the conventional apparatus was used were produced at a low molding pressure. In the comparisons between samples in which the atomizing apparatus was different but μ was about the same, the sample in which the elliptical water flow apparatus was used demonstrated lower core loss and higher DC superimposition characteristics.

### Experiment 2

Experiment 2 was an experiment in which the composition of the soft magnetic alloy was changed from that of Experiment 1. Conditions of the gas atomization method were appropriately controlled so that μ of all magnetic cores obtained in the end was 25. Unlike Experiment 1, Hc was not measured in Experiment 2.

The ratio (core loss ratio) of the core loss of the magnetic core produced with the elliptical water flow apparatus was calculated on the premise that the core loss of the magnetic core having the same composition and produced with the conventional apparatus was 1. A core loss ratio of 0.85 or less was deemed good. The core loss ratio was preferably 0.70 or less and more preferably 0.60 or less.

As for the DC superimposition characteristics, the ratio (Isat ratio) of Isat of the magnetic core produced with the elliptical water flow apparatus was calculated on the premise that Isat of the magnetic core having the same composition and produced with the conventional apparatus was 1. An Isat ratio of 1.10 or more was deemed good. The Isat ratio was preferably 1.15 or more and more preferably 1.20 or more.

TABLE 2

| | | Soft magnetic alloy powder | | | | | | | | |
|---|---|---|---|---|---|---|---|---|---|---|
| | | (Fe_{(1-α)}Co_{α})_{(1-(a+b+c+d+e))}BₐP_{b}Si_{c}C_{d}Crₑ (α = 0.300, β = γ = 0) | | | | | | | | |
| Sample | Comparative Example/ | Fe | Co | B | P | Si | C | Cr | B + P | Manufacturing condition |
| No. | Example | (1 − α) × A | α × A | a | b | c | d | e | a + b | Atomizing apparatus |
| 11 | Comparative Example | 0.630 | 0.270 | 0.000 | 0.000 | 0.080 | 0.010 | 0.010 | 0.000 | Conventional apparatus |
| 12 | Comparative Example | 0.630 | 0.270 | 0.000 | 0.000 | 0.080 | 0.010 | 0.010 | 0.000 | Elliptical water flow apparatus |
| 13 | Comparative Example | 0.616 | 0.264 | 0.020 | 0.000 | 0.080 | 0.010 | 0.010 | 0.020 | Conventional apparatus |
| 14 | Example | 0.616 | 0.264 | 0.020 | 0.000 | 0.080 | 0.010 | 0.010 | 0.020 | Elliptical water flow apparatus |
| 15 | Comparative Example | 0.595 | 0.255 | 0.050 | 0.000 | 0.080 | 0.010 | 0.010 | 0.050 | Conventional apparatus |
| 16 | Example | 0.595 | 0.255 | 0.050 | 0.000 | 0.080 | 0.010 | 0.010 | 0.050 | Elliptical water flow apparatus |
| 17 | Comparative Example | 0.578 | 0.248 | 0.075 | 0.000 | 0.080 | 0.010 | 0.010 | 0.075 | Conventional apparatus |
| 18 | Example | 0.578 | 0.248 | 0.075 | 0.000 | 0.080 | 0.010 | 0.010 | 0.075 | Elliptical water flow apparatus |
| 19 | Comparative Example | 0.560 | 0.240 | 0.100 | 0.000 | 0.080 | 0.010 | 0.010 | 0.100 | Conventional apparatus |
| 20 | Example | 0.560 | 0.240 | 0.100 | 0.000 | 0.080 | 0.010 | 0.010 | 0.100 | Elliptical water flow apparatus |
| 21 | Comparative Example | 0.560 | 0.240 | 0.150 | 0.000 | 0.030 | 0.010 | 0.010 | 0.150 | Conventional apparatus |
| 22 | Example | 0.560 | 0.240 | 0.150 | 0.000 | 0.030 | 0.010 | 0.010 | 0.150 | Elliptical water flow apparatus |
| 23 | Comparative Example | 0.553 | 0.237 | 0.200 | 0.000 | 0.000 | 0.010 | 0.000 | 0.200 | Conventional apparatus |
| 24 | Example | 0.553 | 0.237 | 0.200 | 0.000 | 0.000 | 0.010 | 0.000 | 0.200 | Elliptical water flow apparatus |
| 25 | Comparative Example | 0.546 | 0.234 | 0.210 | 0.000 | 0.000 | 0.010 | 0.000 | 0.210 | Conventional apparatus |
| 26 | Comparative Example | 0.546 | 0.234 | 0.210 | 0.000 | 0.000 | 0.010 | 0.000 | 0.210 | Elliptical water flow apparatus |

| | | | | | | Magnetic core (μ = 25) | | | | | | | |
|---|---|---|---|---|---|---|---|---|---|---|---|---|---|
| | Soft magnetic alloy powder | | | | | Manufacturing | | | | | | | |
| | Particle | | Circularity of | | | condition | Particle | | Circularity of | | Characteristics | | |
| | size | | large particles | | Ribbon | Molding | size | | large particles | | Packing | Core | |
| Sample | D50 | D90 | Average | Variance | Bs | pressure | D50 | D90 | Average | Variance | density | loss | Isat |
| No. | μm | μm | (—) | (—) | T | t/cm² | μm | μm | (—) | (—) | (—) | Ratio | Ratio |
| 11 | 7.8 | 17.9 | 0.60 | 0.053 | 1.97 | 14 | 9.9 | 25.8 | 0.50 | 0.056 | 76% | 1.00 | 1.00 |
| 12 | 7.8 | 17.9 | 0.69 | 0.046 | 1.97 | 12 | 9.6 | 24.8 | 0.57 | 0.054 | 76% | 1.00 | 1.08 |
| 13 | 7.8 | 18.9 | 0.66 | 0.050 | 1.90 | 14 | 10.1 | 25.9 | 0.58 | 0.054 | 76% | 1.00 | 1.00 |
| 14 | 7.8 | 18.9 | 0.75 | 0.034 | 1.90 | 8 | 9.7 | 27.0 | 0.75 | 0.028 | 75% | 0.78 | 1.17 |
| 15 | 8.0 | 18.7 | 0.69 | 0.046 | 1.80 | 12 | 9.6 | 25.6 | 0.59 | 0.054 | 76% | 1.00 | 1.00 |
| 16 | 8.0 | 18.7 | 0.77 | 0.025 | 1.80 | 8 | 10.2 | 26.7 | 0.77 | 0.023 | 75% | 0.80 | 1.20 |
| 17 | 8.4 | 19.3 | 0.71 | 0.043 | 1.71 | 12 | 10.5 | 26.2 | 0.58 | 0.054 | 76% | 1.00 | 1.00 |
| 18 | 8.4 | 19.3 | 0.78 | 0.021 | 1.71 | 8 | 10.5 | 28.0 | 0.78 | 0.020 | 75% | 0.73 | 1.18 |
| 19 | 8.6 | 17.8 | 0.73 | 0.041 | 1.63 | 12 | 11.1 | 24.4 | 0.59 | 0.054 | 75% | 1.00 | 1.00 |
| 20 | 8.6 | 17.8 | 0.79 | 0.017 | 1.63 | 8 | 11.1 | 24.4 | 0.79 | 0.019 | 75% | 0.82 | 1.14 |
| 21 | 8.3 | 18.9 | 0.71 | 0.043 | 1.65 | 12 | 10.7 | 27.4 | 0.61 | 0.052 | 76% | 1.00 | 1.00 |
| 22 | 8.3 | 18.9 | 0.78 | 0.021 | 1.65 | 8 | 10.6 | 27.0 | 0.78 | 0.017 | 75% | 0.82 | 1.15 |
| 23 | 8.2 | 17.7 | 0.65 | 0.051 | 1.68 | 14 | 10.4 | 25.5 | 0.57 | 0.054 | 76% | 1.00 | 1.00 |
| 24 | 8.2 | 17.7 | 0.75 | 0.034 | 1.68 | 8 | 10.1 | 24.2 | 0.76 | 0.026 | 75% | 0.77 | 1.11 |
| 25 | 8.4 | 18.7 | 0.63 | 0.052 | 1.65 | 14 | 10.2 | 26.7 | 0.51 | 0.056 | 76% | 1.00 | 1.00 |
| 26 | 8.4 | 18.7 | 0.72 | 0.043 | 1.65 | 12 | 10.7 | 26.1 | 0.60 | 0.053 | 75% | 0.91 | 1.00 |

*A = 1 − (a + b + c + d + e)

TABLE 3

| | | Soft magnetic alloy powder | | | | | | | | |
|---|---|---|---|---|---|---|---|---|---|---|
| | | (Fe_{(1-α)}Co_{α})_{(1-(a+b+c+d+e))}BₐP_{b}Si_{c}C_{d}Crₑ (α = 0.300, β = γ = 0) | | | | | | | | |
| Sample | Comparative Example/ | Fe | Co | B | P | Si | C | Cr | B + P | Manufacturing condition |
| No. | Example | (1 − α) × A | α × A | a | b | c | d | e | a + b | Atomizing apparatus |
| 27 | Comparative Example | 0.581 | 0.249 | 0.130 | 0.000 | 0.020 | 0.010 | 0.010 | 0.130 | Conventional apparatus |
| 28 | Example | 0.581 | 0.249 | 0.130 | 0.000 | 0.020 | 0.010 | 0.010 | 0.130 | Elliptical water flow apparatus |
| 29 | Comparative Example | 0.581 | 0.249 | 0.120 | 0.010 | 0.020 | 0.010 | 0.010 | 0.130 | Conventional apparatus |
| 30 | Example | 0.581 | 0.249 | 0.120 | 0.010 | 0.020 | 0.010 | 0.010 | 0.130 | Elliptical water flow apparatus |
| 31 | Comparative Example | 0.581 | 0.249 | 0.110 | 0.020 | 0.020 | 0.010 | 0.010 | 0.130 | Conventional apparatus |
| 32 | Example | 0.581 | 0.249 | 0.110 | 0.020 | 0.020 | 0.010 | 0.010 | 0.130 | Elliptical water flow apparatus |
| 33 | Comparative Example | 0.581 | 0.249 | 0.100 | 0.030 | 0.020 | 0.010 | 0.010 | 0.130 | Conventional apparatus |
| 34 | Example | 0.581 | 0.249 | 0.100 | 0.030 | 0.020 | 0.010 | 0.010 | 0.130 | Elliptical water flow apparatus |
| 35 | Comparative Example | 0.581 | 0.249 | 0.090 | 0.040 | 0.020 | 0.010 | 0.010 | 0.130 | Conventional apparatus |
| 36 | Example | 0.581 | 0.249 | 0.090 | 0.040 | 0.020 | 0.010 | 0.010 | 0.130 | Elliptical water flow apparatus |
| 37 | Comparative Example | 0.581 | 0.249 | 0.080 | 0.050 | 0.020 | 0.010 | 0.010 | 0.130 | Conventional apparatus |
| 38 | Example | 0.581 | 0.249 | 0.080 | 0.050 | 0.020 | 0.010 | 0.010 | 0.130 | Elliptical water flow apparatus |
| 39 | Comparative Example | 0.581 | 0.249 | 0.070 | 0.060 | 0.020 | 0.010 | 0.010 | 0.130 | Conventional apparatus |
| 40 | Example | 0.581 | 0.249 | 0.070 | 0.060 | 0.020 | 0.010 | 0.010 | 0.130 | Elliptical water flow apparatus |
| 41 | Comparative Example | 0.581 | 0.249 | 0.060 | 0.070 | 0.020 | 0.010 | 0.010 | 0.130 | Conventional apparatus |
| 42 | Example | 0.581 | 0.249 | 0.060 | 0.070 | 0.020 | 0.010 | 0.010 | 0.130 | Elliptical water flow apparatus |
| 43 | Comparative Example | 0.581 | 0.249 | 0.050 | 0.080 | 0.020 | 0.010 | 0.010 | 0.130 | Conventional apparatus |
| 44 | Comparative Example | 0.581 | 0.249 | 0.050 | 0.080 | 0.020 | 0.010 | 0.010 | 0.130 | Elliptical water flow apparatus |

| | | | | | | Magnetic core (μ = 25) | | | | | | | |
|---|---|---|---|---|---|---|---|---|---|---|---|---|---|
| | Soft magnetic alloy powder | | | | | Manufacturing | | | | | | | |
| | Particle | | Circularity of | | | condition | Particle | | Circularity of | | Characteristics | | |
| | size | | large particles | | Ribbon | Molding | size | | large particles | | Packing | Core | |
| Sample | D50 | D90 | Average | Variance | Bs | pressure | D50 | D90 | Average | Variance | density | loss | Isat |
| No. | μm | μm | (—) | (—) | T | t/cm² | μm | μm | (—) | (—) | (—) | Ratio | Ratio |
| 27 | 7.6 | 16.9 | 0.60 | 0.053 | 1.76 | 14 | 9.6 | 23.4 | 0.53 | 0.055 | 76% | 1.00 | 1.00 |
| 28 | 8.0 | 18.2 | 0.76 | 0.027 | 1.76 | 8 | 10.2 | 26.2 | 0.76 | 0.027 | 75% | 0.85 | 1.17 |
| 29 | 7.5 | 16.7 | 0.66 | 0.050 | 1.75 | 14 | 9.5 | 23.6 | 0.56 | 0.054 | 76% | 1.00 | 1.00 |
| 30 | 8.3 | 17.7 | 0.85 | 0.009 | 1.75 | 8 | 10.0 | 25.0 | 0.85 | 0.008 | 75% | 0.62 | 1.24 |
| 31 | 7.2 | 18.8 | 0.69 | 0.047 | 1.74 | 12 | 9.3 | 25.8 | 0.57 | 0.055 | 76% | 1.00 | 1.00 |
| 32 | 7.7 | 18.0 | 0.91 | 0.005 | 1.74 | 4 | 9.3 | 24.9 | 0.91 | 0.005 | 74% | 0.56 | 1.26 |
| 33 | 8.3 | 18.1 | 0.71 | 0.043 | 1.73 | 12 | 10.0 | 25.2 | 0.62 | 0.052 | 76% | 1.00 | 1.00 |
| 34 | 7.9 | 18.8 | 0.95 | 0.004 | 1.73 | 4 | 9.9 | 26.3 | 0.96 | 0.003 | 74% | 0.58 | 1.27 |
| 35 | 7.3 | 16.5 | 0.73 | 0.040 | 1.72 | 12 | 9.2 | 23.5 | 0.64 | 0.051 | 75% | 1.00 | 1.00 |
| 36 | 7.4 | 18.5 | 0.98 | 0.003 | 1.72 | 4 | 9.6 | 25.4 | 0.98 | 0.003 | 74% | 0.57 | 1.27 |
| 37 | 7.9 | 19.4 | 0.72 | 0.042 | 1.71 | 12 | 10.2 | 26.3 | 0.62 | 0.052 | 75% | 1.00 | 1.00 |
| 38 | 8.3 | 16.7 | 0.97 | 0.003 | 1.71 | 4 | 10.5 | 23.8 | 0.98 | 0.003 | 74% | 0.59 | 1.26 |
| 39 | 7.7 | 17.4 | 0.72 | 0.042 | 1.70 | 12 | 9.5 | 23.9 | 0.58 | 0.053 | 75% | 1.00 | 1.00 |
| 40 | 7.7 | 17.0 | 0.97 | 0.003 | 1.70 | 4 | 9.8 | 24.0 | 0.98 | 0.003 | 74% | 0.65 | 1.15 |
| 41 | 7.5 | 19.2 | 0.71 | 0.044 | 1.69 | 12 | 9.4 | 26.0 | 0.62 | 0.052 | 76% | 1.00 | 1.00 |
| 42 | 7.2 | 18.4 | 0.96 | 0.003 | 1.69 | 4 | 8.9 | 24.8 | 0.96 | 0.003 | 74% | 0.78 | 1.11 |
| 43 | 7.4 | 18.0 | 0.71 | 0.043 | 1.59 | 12 | 9.5 | 25.0 | 0.61 | 0.052 | 76% | 1.00 | 1.00 |
| 44 | 7.6 | 17.7 | 0.96 | 0.003 | 1.59 | 4 | 9.3 | 25.3 | 0.82 | 0.013 | 74% | 1.00 | 1.04 |

*A = 1 − (a + b + c + d + e)

TABLE 4

| | | Soft magnetic alloy powder | | | | | | | | |
|---|---|---|---|---|---|---|---|---|---|---|
| | | (Fe_{(1-α)}Co_{α})_{(1-(a+b+c+d+e))}BₐP_{b}Si_{c}C_{d}Crₑ (α = 0.300, β = γ = 0) | | | | | | | | |
| Sample | Comparative Example/ | Fe | Co | B | P | Si | C | Cr | B + P | Manufacturing condition |
| No. | Example | (1 − α) × A | α × A | a | b | c | d | e | a + b | Atomizing apparatus |
| 45 | Comparative Example | 0.574 | 0.246 | 0.140 | 0.020 | 0.000 | 0.010 | 0.010 | 0.160 | Conventional apparatus |
| 46 | Example | 0.574 | 0.246 | 0.140 | 0.020 | 0.000 | 0.010 | 0.010 | 0.160 | Elliptical water flow apparatus |
| 47 | Comparative Example | 0.574 | 0.246 | 0.130 | 0.020 | 0.010 | 0.010 | 0.010 | 0.150 | Conventional apparatus |
| 48 | Example | 0.574 | 0.246 | 0.130 | 0.020 | 0.010 | 0.010 | 0.010 | 0.150 | Elliptical water flow apparatus |
| 49 | Comparative Example | 0.574 | 0.246 | 0.110 | 0.020 | 0.030 | 0.010 | 0.010 | 0.130 | Conventional apparatus |
| 50 | Example | 0.574 | 0.246 | 0.110 | 0.020 | 0.030 | 0.010 | 0.010 | 0.130 | Elliptical water flow apparatus |
| 51 | Comparative Example | 0.574 | 0.246 | 0.090 | 0.020 | 0.050 | 0.010 | 0.010 | 0.110 | Conventional apparatus |
| 52 | Example | 0.574 | 0.246 | 0.090 | 0.020 | 0.050 | 0.010 | 0.010 | 0.110 | Elliptical water flow apparatus |
| 53 | Comparative Example | 0.574 | 0.246 | 0.070 | 0.020 | 0.070 | 0.010 | 0.010 | 0.090 | Conventional apparatus |
| 54 | Example | 0.574 | 0.246 | 0.070 | 0.020 | 0.070 | 0.010 | 0.010 | 0.090 | Elliptical water flow apparatus |
| 55 | Comparative Example | 0.574 | 0.246 | 0.040 | 0.020 | 0.100 | 0.010 | 0.010 | 0.060 | Conventional apparatus |
| 56 | Example | 0.574 | 0.246 | 0.040 | 0.020 | 0.100 | 0.010 | 0.010 | 0.060 | Elliptical water flow apparatus |
| 57 | Comparative Example | 0.574 | 0.246 | 0.030 | 0.020 | 0.110 | 0.010 | 0.010 | 0.050 | Conventional apparatus |
| 58 | Example | 0.574 | 0.246 | 0.030 | 0.020 | 0.110 | 0.010 | 0.010 | 0.050 | Elliptical water flow apparatus |

| | | | | | | Magnetic core (μ = 25) | | | | | | | |
|---|---|---|---|---|---|---|---|---|---|---|---|---|---|
| | Soft magnetic alloy powder | | | | | Manufacturing | | | | | | | |
| | Particle | | Circularity of | | | condition | Particle | | Circularity of | | Characteristics | | |
| | size | | large particles | | Ribbon | Molding | size | | large particles | | Packing | Core | |
| Sample | D50 | D90 | Average | Variance | Bs | pressure | D50 | D90 | Average | Variance | density | loss | Isat |
| No. | μm | μm | (—) | (—) | T | t/cm² | μm | μm | (—) | (—) | (—) | Ratio | Ratio |
| 45 | 7.8 | 17.8 | 0.60 | 0.053 | 1.72 | 14 | 9.9 | 25.2 | 0.51 | 0.056 | 76% | 1.00 | 1.00 |
| 46 | 7.0 | 18.9 | 0.75 | 0.031 | 1.72 | 8 | 8.7 | 27.3 | 0.75 | 0.029 | 75% | 0.85 | 1.11 |
| 47 | 7.3 | 17.2 | 0.63 | 0.052 | 1.71 | 14 | 9.1 | 23.6 | 0.54 | 0.055 | 76% | 1.00 | 1.00 |
| 48 | 7.2 | 18.5 | 0.78 | 0.020 | 1.71 | 8 | 8.6 | 26.6 | 0.78 | 0.021 | 75% | 0.82 | 1.18 |
| 49 | 7.9 | 17.2 | 0.65 | 0.050 | 1.70 | 14 | 9.4 | 24.0 | 0.54 | 0.055 | 76% | 1.00 | 1.00 |
| 50 | 7.7 | 17.6 | 0.80 | 0.015 | 1.70 | 8 | 9.5 | 24.0 | 0.80 | 0.016 | 75% | 0.79 | 1.21 |
| 51 | 8.4 | 18.6 | 0.68 | 0.047 | 1.69 | 12 | 10.4 | 26.8 | 0.57 | 0.054 | 76% | 1.00 | 1.00 |
| 52 | 7.6 | 18.5 | 0.82 | 0.013 | 1.69 | 8 | 9.6 | 25.5 | 0.82 | 0.013 | 75% | 0.81 | 1.19 |
| 53 | 8.2 | 18.8 | 0.70 | 0.045 | 1.68 | 12 | 9.8 | 26.5 | 0.62 | 0.052 | 76% | 1.00 | 1.00 |
| 54 | 8.0 | 18.1 | 0.85 | 0.009 | 1.68 | 8 | 10.3 | 25.3 | 0.85 | 0.009 | 75% | 0.82 | 1.15 |
| 55 | 7.0 | 17.0 | 0.71 | 0.044 | 1.67 | 12 | 9.1 | 24.0 | 0.64 | 0.051 | 76% | 1.00 | 1.00 |
| 56 | 7.7 | 19.0 | 0.88 | 0.006 | 1.67 | 8 | 9.6 | 26.9 | 0.88 | 0.006 | 75% | 0.85 | 1.12 |
| 57 | 7.4 | 18.8 | 0.72 | 0.041 | 1.60 | 12 | 8.9 | 27.0 | 0.63 | 0.051 | 75% | 1.00 | 1.00 |
| 58 | 7.0 | 17.9 | 0.90 | 0.005 | 1.60 | 4 | 8.6 | 25.8 | 0.81 | 0.014 | 75% | 1.00 | 1.06 |

*A = 1 − (a + b + c + d + e)

TABLE 5

| | | Soft magnetic alloy powder | | | | | | | | |
|---|---|---|---|---|---|---|---|---|---|---|
| | | (Fe_{(1-α)}Co_{α})_{(1-(a+b+c+d+e))}BₐP_{b}Si_{c}C_{d}Crₑ (α = 0.300, β = γ = 0) | | | | | | | | |
| Sample | Comparative Example/ | Fe | Co | B | P | Si | C | Cr | B + P | Manufacturing condition |
| No. | Example | (1 − α) × A | α × A | a | b | c | d | e | a + b | Atomizing apparatus |
| 59 | Comparative Example | 0.581 | 0.249 | 0.110 | 0.020 | 0.030 | 0.000 | 0.010 | 0.130 | Conventional apparatus |
| 60 | Comparative Example | 0.581 | 0.249 | Q.110 | 0.020 | 0.030 | 0.000 | 0.010 | 0.130 | Elliptical water flow apparatus |
| 61 | Comparative Example | 0.581 | 0.249 | 0.109 | 0.020 | 0.030 | 0.001 | 0.010 | 0.129 | Conventional apparatus |
| 62 | Example | 0.581 | 0.249 | 0.109 | 0.020 | 0.030 | 0.001 | 0.010 | 0.129 | Elliptical water flow apparatus |
| 63 | Comparative Example | 0.581 | 0.249 | 0.107 | 0.020 | 0.030 | 0.003 | 0.010 | 0.127 | Conventional apparatus |
| 64 | Example | 0.581 | 0.249 | 0.107 | 0.020 | 0.030 | 0.003 | 0.010 | 0.127 | Elliptical water flow apparatus |
| 65 | Comparative Example | 0.581 | 0.249 | 0.105 | 0.020 | 0.030 | 0.005 | 0.010 | 0.125 | Conventional apparatus |
| 66 | Example | 0.581 | 0.249 | 0.105 | 0.020 | 0.030 | 0.005 | 0.010 | 0.125 | Elliptical water flow apparatus |
| 67 | Comparative Example | 0.581 | 0.249 | 0.100 | 0.020 | 0.030 | 0.010 | 0.010 | 0.120 | Conventional apparatus |
| 68 | Example | 0.581 | 0.249 | 0.100 | 0.020 | 0.030 | 0.010 | 0.010 | 0.120 | Elliptical water flow apparatus |
| 69 | Comparative Example | 0.581 | 0.249 | 0.080 | 0.020 | 0.030 | 0.030 | 0.010 | 0.100 | Conventional apparatus |
| 70 | Example | 0.581 | 0.249 | 0.080 | 0.020 | 0.030 | 0.030 | 0.010 | 0.100 | Elliptical water flow apparatus |
| 71 | Comparative Example | 0.581 | 0.249 | 0.060 | 0.020 | 0.030 | 0.050 | 0.010 | 0.080 | Conventional apparatus |
| 72 | Example | 0.581 | 0.249 | 0.060 | 0.020 | 0.030 | 0.050 | 0.010 | 0.080 | Elliptical water flow apparatus |
| 73 | Comparative Example | 0.581 | 0.249 | 0.050 | 0.020 | 0.030 | 0.060 | 0.010 | 0.070 | Conventional apparatus |
| 74 | Example | 0.581 | 0.249 | 0.050 | 0.020 | 0.030 | 0.060 | 0.010 | 0.070 | Elliptical water flow apparatus |

| | | | | | | Magnetic core (μ = 25) | | | | | | | |
|---|---|---|---|---|---|---|---|---|---|---|---|---|---|
| | Soft magnetic alloy powder | | | | | Manufacturing | | | | | | | |
| | Particle | | Circularity of | | | condition | Particle | | Circularity of | | Characteristics | | |
| | size | | large particles | | Ribbon | Molding | size | | large particles | | Packing | Core | |
| Sample | D50 | D90 | Average | Variance | Bs | pressure | D50 | D90 | Average | Variance | density | loss | Isat |
| No. | μm | μm | (—) | (—) | T | t/cm² | μm | μm | (—) | (—) | (—) | Ratio | Ratio |
| 59 | 7.1 | 18.2 | 0.59 | 0.054 | 1.73 | 14 | 8.9 | 26.3 | 0.53 | 0.056 | 76% | 1.00 | 1.00 |
| 60 | 7.5 | 17.4 | 0.74 | 0.037 | 1.73 | 8 | 9.7 | 23.6 | 0.64 | 0.051 | 75% | 1.00 | 1.08 |
| 61 | 7.3 | 17.5 | 0.63 | 0.052 | 1.73 | 14 | 8.9 | 24.6 | 0.51 | 0.056 | 76% | 1.00 | 1.00 |
| 62 | 7.1 | 16.9 | 0.83 | 0.011 | 1.73 | 8 | 9.1 | 22.8 | 0.84 | 0.010 | 75% | 0.63 | 1.23 |
| 63 | 8.2 | 19.3 | 0.65 | 0.051 | 1.73 | 14 | 10.4 | 27.9 | 0.53 | 0.055 | 76% | 1.00 | 1.00 |
| 64 | 7.7 | 16.7 | 0.90 | 0.006 | 1.73 | 4 | 9.9 | 23.2 | 0.90 | 0.005 | 75% | 0.59 | 1.26 |
| 65 | 7.2 | 19.0 | 0.67 | 0.049 | 1.73 | 12 | 8.7 | 27.0 | 0.57 | 0.055 | 76% | 1.00 | 1.00 |
| 66 | 8.4 | 18.6 | 0.91 | 0.005 | 1.73 | 4 | 10.3 | 26.7 | 0.91 | 0.005 | 74% | 0.55 | 1.26 |
| 67 | 7.5 | 18.6 | 0.72 | 0.041 | 1.73 | 12 | 9.6 | 26.5 | 0.61 | 0.053 | 75% | 1.00 | 1.00 |
| 68 | 8.3 | 18.8 | 0.94 | 0.004 | 1.73 | 4 | 10.0 | 26.8 | 0.94 | 0.004 | 74% | 0.58 | 1.25 |
| 69 | 7.6 | 17.7 | 0.72 | 0.043 | 1.74 | 12 | 9.4 | 25.5 | 0.63 | 0.051 | 75% | 1.00 | 1.00 |
| 70 | 8.3 | 17.3 | 0.97 | 0.003 | 1.74 | 4 | 10.5 | 24.1 | 0.98 | 0.003 | 74% | 0.60 | 1.25 |
| 71 | 8.5 | 18.6 | 0.73 | 0.039 | 1.75 | 12 | 10.2 | 25.1 | 0.59 | 0.054 | 75% | 1.00 | 1.00 |
| 72 | 7.2 | 17.9 | 0.98 | 0.003 | 1.75 | 4 | 9.3 | 24.6 | 0.98 | 0.003 | 74% | 0.72 | 1.12 |
| 73 | 7.1 | 17.0 | 0.73 | 0.041 | 1.76 | 12 | 8.6 | 24.6 | 0.60 | 0.053 | 75% | 1.00 | 1.00 |
| 74 | 8.4 | 16.5 | 0.98 | 0.003 | 1.76 | 4 | 10.4 | 23.6 | 0.83 | 0.011 | 74% | 1.00 | 1.03 |

*A = 1 − (a + b + c + d + e)

TABLE 6

| | | Soft magnetic alloy powder | | | | | | | | |
|---|---|---|---|---|---|---|---|---|---|---|
| | | (Fe_{(1-α)}Co_{α})_{(1-(a+b+c+d+e))}BₐP_{b}Si_{c}C_{d}Crₑ (α = 0.300, β = γ = 0) | | | | | | | | |
| Sample | Comparative Example/ | Fe | Co | B | P | Si | C | Cr | B + P | Manufacturing condition |
| No. | Example | (1 − α) × A | α × A | a | b | c | d | e | a + b | Atomizing apparatus |
| 75 | Comparative Example | 0.588 | 0.252 | 0.100 | 0.020 | 0.030 | 0.010 | 0.000 | 0.120 | Conventional apparatus |
| 76 | Example | 0.588 | 0.252 | 0.100 | 0.020 | 0.030 | 0.010 | 0.000 | 0.120 | Elliptical water flow apparatus |
| 77 | Comparative Example | 0.581 | 0.249 | 0.100 | 0.020 | 0.030 | 0.010 | 0.010 | 0.120 | Conventional apparatus |
| 78 | Example | 0.581 | 0.249 | 0.100 | 0.020 | 0.030 | 0.010 | 0.010 | 0.120 | Elliptical water flow apparatus |
| 79 | Comparative Example | 0.574 | 0.246 | 0.100 | 0.020 | 0.030 | 0.010 | 0.020 | 0.120 | Conventional apparatus |
| 80 | Example | 0.574 | 0.246 | 0.100 | 0.020 | 0.030 | 0.010 | 0.020 | 0.120 | Elliptical water flow apparatus |
| 81 | Comparative Example | 0.567 | 0.243 | 0.100 | 0.020 | 0.030 | 0.010 | 0.030 | 0.120 | Conventional apparatus |
| 82 | Example | 0.567 | 0.243 | 0.100 | 0.020 | 0.030 | 0.010 | 0.030 | 0.120 | Elliptical water flow apparatus |
| 83 | Comparative Example | 0.560 | 0.240 | 0.100 | 0.020 | 0.030 | 0.010 | 0.040 | 0.120 | Conventional apparatus |
| 84 | Example | 0.560 | 0.240 | 0.100 | 0.020 | 0.030 | 0.010 | 0.040 | 0.120 | Elliptical water flow apparatus |
| 85 | Comparative Example | 0.553 | 0.237 | 0.100 | 0.020 | 0.030 | 0.010 | 0.050 | 0.120 | Conventional apparatus |
| 86 | Comparative Example | 0.553 | 0.237 | 0.100 | 0.020 | 0.030 | 0.010 | 0.050 | 0.120 | Elliptical water flow apparatus |

| | | | | | | Magnetic core (μ = 25) | | | | | | | |
|---|---|---|---|---|---|---|---|---|---|---|---|---|---|
| | Soft magnetic alloy powder | | | | | Manufacturing | | | | | | | |
| | Particle | | Circularity of | | | condition | Particle | | Circularity of | | Characteristics | | |
| | size | | large particles | | Ribbon | Molding | size | | large particles | | Packing | Core | |
| Sample | D50 | D90 | Average | Variance | Bs | pressure | D50 | D90 | Average | Variance | density | loss | Isat |
| No. | μm | μm | (—) | (—) | T | t/cm² | μm | μm | (—) | (—) | (—) | Ratio | Ratio |
| 75 | 8.4 | 16.9 | 0.72 | 0.043 | 1.82 | 12 | 10.3 | 23.1 | 0.58 | 0.054 | 75% | 1.00 | 1.00 |
| 76 | 7.4 | 16.6 | 0.94 | 0.004 | 1.82 | 4 | 9.5 | 23.1 | 0.94 | 0.004 | 74% | 0.57 | 1.30 |
| 77 | 8.4 | 18.0 | 0.71 | 0.044 | 1.73 | 12 | 10.4 | 24.3 | 0.61 | 0.052 | 76% | 1.00 | 1.00 |
| 78 | 7.8 | 17.5 | 0.93 | 0.004 | 1.73 | 4 | 10.0 | 25.3 | 0.93 | 0.004 | 74% | 0.57 | 1.26 |
| 79 | 8.5 | 17.0 | 0.72 | 0.043 | 1.65 | 12 | 10.8 | 23.1 | 0.64 | 0.051 | 75% | 1.00 | 1.00 |
| 80 | 8.0 | 17.7 | 0.94 | 0.004 | 1.65 | 4 | 10.1 | 24.5 | 0.95 | 0.004 | 74% | 0.60 | 1.25 |
| 81 | 7.1 | 18.4 | 0.71 | 0.043 | 1.57 | 12 | 8.8 | 26.0 | 0.61 | 0.053 | 76% | 1.00 | 1.00 |
| 82 | 7.4 | 18.2 | 0.93 | 0.004 | 1.57 | 4 | 9.6 | 25.0 | 0.93 | 0.004 | 74% | 0.57 | 1.17 |
| 83 | 7.1 | 17.9 | 0.72 | 0.042 | 1.48 | 12 | 8.8 | 25.8 | 0.64 | 0.050 | 75% | 1.00 | 1.00 |
| 84 | 7.7 | 19.2 | 0.94 | 0.004 | 1.48 | 4 | 9.4 | 27.6 | 0.94 | 0.004 | 74% | 0.58 | 1.10 |
| 85 | 8.1 | 19.1 | 0.72 | 0.042 | 1.40 | 12 | 10.3 | 27.0 | 0.58 | 0.054 | 75% | 1.00 | 1.00 |
| 86 | 7.7 | 16.8 | 0.94 | 0.004 | 1.40 | 4 | 9.5 | 23.3 | 0.92 | 0.005 | 74% | 0.57 | 1.01 |

*A = 1 − (a + b + c + d + e)

TABLE 7A

| | | Soft magnetic alloy powder | | | | | | | | | |
|---|---|---|---|---|---|---|---|---|---|---|---|
| | | (Fe_{(1-(α+β))}Co_{α}Ni_{β})_{(1-(a+b+c+d+e))}BₐP_{b}Si_{c}C_{d}Crₑ (γ = 0) | | | | | | | | | |
| | | Fe | | | | | | | | | |
| Sample | Comparative Example/ | (1 − (α + | Co | Ni | B | P | Si | C | Cr | B + P | Manufacturing condition |
| No. | Example | β)) × A | α × A | β × A | a | b | c | d | e | a + b | Atomizing apparatus |
| 87 | Comparative Example | 0.820 | 0.000 | 0.000 | 0.110 | 0.020 | 0.030 | 0.010 | 0.010 | 0.130 | Conventional apparatus |
| 88 | Comparative Example | 0.820 | 0.000 | 0.000 | 0.110 | 0.020 | 0.030 | 0.010 | 0.010 | 0.130 | Elliptical water flow apparatus |
| 89 | Comparative Example | 0.816 | 0.000 | 0.004 | 0.110 | 0.020 | 0.030 | 0.010 | 0.010 | 0.130 | Conventional apparatus |
| 90 | Comparative Example | 0.816 | 0.000 | 0.004 | 0.110 | 0.020 | 0.030 | 0.010 | 0.010 | 0.130 | Elliptical water flow apparatus |
| 91 | Comparative Example | 0.812 | 0.000 | 0.008 | 0.110 | 0.020 | 0.030 | 0.010 | 0.010 | 0.130 | Conventional apparatus |
| 92 | Comparative Example | 0.812 | 0.000 | 0.008 | 0.110 | 0.020 | 0.030 | 0.010 | 0.010 | 0.130 | Elliptical water flow apparatus |
| 93 | Comparative Example | 0.795 | 0.000 | 0.025 | 0.110 | 0.020 | 0.030 | 0.010 | 0.010 | 0.130 | Conventional apparatus |
| 94 | Comparative Example | 0.795 | 0.000 | 0.025 | 0.110 | 0.020 | 0.030 | 0.010 | 0.010 | 0.130 | Elliptical water flow apparatus |
| 95 | Comparative Example | 0.779 | 0.000 | 0.041 | 0.110 | 0.020 | 0.030 | 0.010 | 0.010 | 0.130 | Conventional apparatus |
| 96 | Comparative Example | 0.779 | 0.000 | 0.041 | 0.110 | 0.020 | 0.030 | 0.010 | 0.010 | 0.130 | Elliptical water flow apparatus |
| 97 | Comparative Example | 0.738 | 0.000 | 0.082 | 0.110 | 0.020 | 0.030 | 0.010 | 0.010 | 0.130 | Conventional apparatus |
| 98 | Comparative Example | 0.738 | 0.000 | 0.082 | 0.110 | 0.020 | 0.030 | 0.010 | 0.010 | 0.130 | Elliptical water flow apparatus |
| 99 | Comparative Example | 0.656 | 0.000 | 0.164 | 0.110 | 0.020 | 0.030 | 0.010 | 0.010 | 0.130 | Conventional apparatus |
| 100 | Comparative Example | 0.656 | 0.000 | 0.164 | 0.110 | 0.020 | 0.030 | 0.010 | 0.010 | 0.130 | Elliptical water flow apparatus |
| 101 | Comparative Example | 0.648 | 0.000 | 0.172 | 0.110 | 0.020 | 0.030 | 0.010 | 0.010 | 0.130 | Conventional apparatus |
| 102 | Comparative Example | 0.648 | 0.000 | 0.172 | 0.110 | 0.020 | 0.030 | 0.010 | 0.010 | 0.130 | Elliptical water flow apparatus |

| | | | | | | Magnetic core (μ = 25) | | | | | | | |
|---|---|---|---|---|---|---|---|---|---|---|---|---|---|
| | Soft magnetic alloy powder | | | | | Manufacturing | | | | | | | |
| | Particle | | Circularity of | | | condition | Particle | | Circularity of | | Characteristics | | |
| | size | | large particles | | Ribbon | Molding | size | | large particles | | Packing | Core | |
| Sample | D50 | D90 | Average | Variance | Bs | pressure | D50 | D90 | Average | Variance | density | loss | Isat |
| No. | μm | μm | (—) | (—) | T | t/cm² | μm | μm | (—) | (—) | (—) | Ratio | Ratio |
| 87 | 7.1 | 18.4 | 0.60 | 0.053 | 1.56 | 14 | 8.6 | 25.4 | 0.50 | 0.068 | 76% | 1.00 | 1.00 |
| 88 | 8.3 | 16.7 | 0.70 | 0.044 | 1.56 | 12 | 10.3 | 23.6 | 0.71 | 0.046 | 76% | 0.95 | 1.00 |
| 89 | 8.2 | 16.6 | 0.60 | 0.052 | 1.57 | 14 | 10.6 | 23.1 | 0.50 | 0.057 | 76% | 1.00 | 1.00 |
| 90 | 7.7 | 19.4 | 0.71 | 0.040 | 1.57 | 12 | 9.8 | 27.4 | 0.72 | 0.041 | 76% | 0.93 | 1.01 |
| 91 | 8.1 | 18.0 | 0.60 | 0.052 | 1.59 | 14 | 10.5 | 25.7 | 0.54 | 0.059 | 76% | 1.00 | 1.00 |
| 92 | 7.8 | 16.5 | 0.70 | 0.038 | 1.59 | 12 | 9.8 | 23.5 | 0.70 | 0.038 | 76% | 0.88 | 1.01 |
| 93 | 7.7 | 18.7 | 0.60 | 0.052 | 1.63 | 14 | 9.8 | 26.0 | 0.54 | 0.058 | 76% | 1.00 | 1.00 |
| 94 | 8.2 | 17.7 | 0.70 | 0.038 | 1.63 | 12 | 10.0 | 24.8 | 0.70 | 0.039 | 76% | 0.90 | 1.03 |
| 95 | 7.5 | 19.1 | 0.60 | 0.052 | 1.66 | 14 | 9.2 | 27.2 | 0.54 | 0.066 | 76% | 1.00 | 1.00 |
| 96 | 8.2 | 18.8 | 0.70 | 0.038 | 1.66 | 12 | 10.2 | 25.7 | 0.70 | 0.038 | 76% | 0.89 | 1.05 |
| 97 | 7.8 | 19.2 | 0.60 | 0.053 | 1.70 | 14 | 9.5 | 27.7 | 0.51 | 0.068 | 76% | 1.00 | 1.00 |
| 98 | 7.2 | 18.6 | 0.72 | 0.040 | 1.70 | 12 | 8.7 | 26.9 | 0.71 | 0.041 | 75% | 0.93 | 1.05 |
| 99 | 8.5 | 18.0 | 0.60 | 0.055 | 1.68 | 14 | 10.7 | 25.1 | 0.54 | 0.069 | 76% | 1.00 | 1.00 |
| 100 | 7.1 | 18.7 | 0.71 | 0.046 | 1.68 | 12 | 9.0 | 26.2 | 0.71 | 0.048 | 76% | 0.94 | 1.03 |
| 101 | 7.1 | 17.6 | 0.60 | 0.058 | 1.67 | 14 | 8.8 | 24.3 | 0.49 | 0.071 | 76% | 1.00 | 1.00 |
| 102 | 7.3 | 17.1 | 0.71 | 0.055 | 1.67 | 12 | 9.2 | 23.8 | 0.71 | 0.056 | 76% | 0.95 | 1.03 |

*A = 1 − (a + b + c + d + e)

TABLE 7B

| | | Soft magnetic alloy powder | | | | | | | | | |
|---|---|---|---|---|---|---|---|---|---|---|---|
| | | (Fe_{(1-(α+β))}Co_{α}Ni_{β})_{(1-(a+b+c+d+e))}BₐP_{b}Si_{c}C_{d}Crₑ (γ = 0) | | | | | | | | | |
| | | Fe | | | | | | | | | |
| Sample | Comparative Example/ | (1 − (α + | Co | Ni | B | P | Si | C | Cr | B + P | Manufacturing condition |
| No. | Example | β)) × A | α × A | β × A | a | b | c | d | e | a + b | Atomizing apparatus |
| 103 | Comparative Example | 0.816 | 0.004 | 0.000 | 0.110 | 0.020 | 0.030 | 0.010 | 0.010 | 0.130 | Conventional apparatus |
| 104 | Example | 0.816 | 0.004 | 0.000 | 0.110 | 0.020 | 0.030 | 0.010 | 0.010 | 0.130 | Elliptical water flow apparatus |
| 105 | Comparative Example | 0.812 | 0.004 | 0.004 | 0.110 | 0.020 | 0.030 | 0.010 | 0.010 | 0.130 | Conventional apparatus |
| 106 | Example | 0.812 | 0.004 | 0.004 | 0.110 | 0.020 | 0.030 | 0.010 | 0.010 | 0.130 | Elliptical water flow apparatus |
| 107 | Comparative Example | 0.808 | 0.004 | 0.008 | 0.110 | 0.020 | 0.030 | 0.010 | 0.010 | 0.130 | Conventional apparatus |
| 108 | Example | 0.808 | 0.004 | 0.008 | 0.110 | 0.020 | 0.030 | 0.010 | 0.010 | 0.130 | Elliptical water flow apparatus |
| 109 | Comparative Example | 0.791 | 0.004 | 0.025 | 0.110 | 0.020 | 0.030 | 0.010 | 0.010 | 0.130 | Conventional apparatus |
| 110 | Example | 0.791 | 0.004 | 0.025 | 0.110 | 0.020 | 0.030 | 0.010 | 0.010 | 0.130 | Elliptical water flow apparatus |
| 111 | Comparative Example | 0.775 | 0.004 | 0.041 | 0.110 | 0.020 | 0.030 | 0.010 | 0.010 | 0.130 | Conventional apparatus |
| 112 | Example | 0.775 | 0.004 | 0.041 | 0.110 | 0.020 | 0.030 | 0.010 | 0.010 | 0.130 | Elliptical water flow apparatus |
| 113 | Comparative Example | 0.734 | 0.004 | 0.082 | 0.110 | 0.020 | 0.030 | 0.010 | 0.010 | 0.130 | Conventional apparatus |
| 114 | Example | 0.734 | 0.004 | 0.082 | 0.110 | 0.020 | 0.030 | 0.010 | 0.010 | 0.130 | Elliptical water flow apparatus |
| 115 | Comparative Example | 0.652 | 0.004 | 0.164 | 0.110 | 0.020 | 0.030 | 0.010 | 0.010 | 0.130 | Conventional apparatus |
| 116 | Example | 0.652 | 0.004 | 0.164 | 0.110 | 0.020 | 0.030 | 0.010 | 0.010 | 0.130 | Elliptical water flow apparatus |
| 117 | Comparative Example | 0.644 | 0.004 | 0.172 | 0.110 | 0.020 | 0.030 | 0.010 | 0.010 | 0.130 | Conventional apparatus |
| 118 | Comparative Example | 0.644 | 0.004 | 0.172 | 0.110 | 0.020 | 0.030 | 0.010 | 0.010 | 0.130 | Elliptical water flow apparatus |

| | | | | | | Magnetic core (μ = 25) | | | | | | | |
|---|---|---|---|---|---|---|---|---|---|---|---|---|---|
| | Soft magnetic alloy powder | | | | | Manufacturing | | | | | | | |
| | Particle | | Circularity of | | | condition | Particle | | Circularity of | | Characteristics | | |
| | size | | large particles | | Ribbon | Molding | size | | large particles | | Packing | Core | |
| Sample | D50 | D90 | Average | Variance | Bs | pressure | D50 | D90 | Average | Variance | density | loss | Isat |
| No. | μm | μm | (—) | (—) | T | t/cm² | μm | μm | (—) | (—) | (—) | Ratio | Ratio |
| 103 | 7.4 | 16.8 | 0.65 | 0.049 | 1.57 | 14 | 9.6 | 23.2 | 0.53 | 0.056 | 76% | 1.00 | 1.00 |
| 104 | 7.6 | 17.3 | 0.80 | 0.028 | 1.57 | 8 | 9.3 | 23.7 | 0.80 | 0.028 | 75% | 0.68 | 1.10 |
| 105 | 7.0 | 17.8 | 0.65 | 0.049 | 1.58 | 14 | 9.1 | 24.8 | 0.56 | 0.054 | 76% | 1.00 | 1.00 |
| 106 | 7.8 | 18.0 | 0.80 | 0.028 | 1.58 | 8 | 9.8 | 24.9 | 0.81 | 0.028 | 75% | 0.64 | 1.10 |
| 107 | 8.3 | 19.2 | 0.66 | 0.049 | 1.59 | 14 | 10.0 | 26.5 | 0.59 | 0.053 | 76% | 1.00 | 1.00 |
| 108 | 8.0 | 19.0 | 0.79 | 0.028 | 1.59 | 8 | 10.0 | 25.9 | 0.79 | 0.028 | 75% | 0.73 | 1.13 |
| 109 | 8.3 | 19.4 | 0.66 | 0.049 | 1.64 | 14 | 10.2 | 26.5 | 0.55 | 0.055 | 76% | 1.00 | 1.00 |
| 110 | 7.8 | 17.5 | 0.80 | 0.028 | 1.64 | 8 | 9.9 | 24.0 | 0.80 | 0.029 | 75% | 0.69 | 1.18 |
| 111 | 7.8 | 18.8 | 0.65 | 0.049 | 1.67 | 14 | 9.9 | 25.4 | 0.55 | 0.052 | 76% | 1.00 | 1.00 |
| 112 | 7.0 | 17.4 | 0.79 | 0.028 | 1.67 | 8 | 8.9 | 24.6 | 0.79 | 0.029 | 75% | 0.70 | 1.20 |
| 113 | 7.6 | 16.5 | 0.65 | 0.051 | 1.70 | 14 | 9.3 | 23.1 | 0.55 | 0.052 | 76% | 1.00 | 1.00 |
| 114 | 7.7 | 16.7 | 0.80 | 0.030 | 1.70 | 8 | 9.8 | 23.3 | 0.80 | 0.030 | 75% | 0.73 | 1.20 |
| 115 | 8.4 | 19.4 | 0.65 | 0.051 | 1.68 | 14 | 10.4 | 27.0 | 0.56 | 0.053 | 76% | 1.00 | 1.00 |
| 116 | 7.6 | 17.7 | 0.80 | 0.032 | 1.68 | 8 | 9.8 | 24.6 | 0.80 | 0.033 | 75% | 0.65 | 1.15 |
| 117 | 8.2 | 19.4 | 0.65 | 0.052 | 1.67 | 14 | 10.2 | 26.6 | 0.52 | 0.061 | 76% | 1.00 | 1.00 |
| 118 | 8.1 | 18.7 | 0.81 | 0.042 | 1.67 | 8 | 9.8 | 27.0 | 0.71 | 0.043 | 75% | 0.69 | 1.09 |

*A = 1 − (a + b + c + d + e)

TABLE 7C

| | | Soft magnetic alloy powder | | | | | | | | | |
|---|---|---|---|---|---|---|---|---|---|---|---|
| | | (Fe_{(1-(α+β))}Co_{α}Ni_{β})_{(1-(a+b+c+d+e))}BₐP_{b}Si_{c}C_{d}Crₑ (γ = 0) | | | | | | | | | |
| Sample | Comparative Example/ | Fe | Co | Ni | B | P | Si | C | Cr | B + P | Manufacturing condition |
| No. | Example | (1 − (α + β)) × A | α × A | β × A | a | b | c | d | e | a + b | Atomizing apparatus |
| 119 | Comparative Example | 0.812 | 0.008 | 0.000 | 0.110 | 0.020 | 0.030 | 0.010 | 0.010 | 0.130 | Conventional apparatus |
| 120 | Example | 0.812 | 0.008 | 0.000 | 0.110 | 0.020 | 0.030 | 0.010 | 0.010 | 0.130 | Elliptical water flow apparatus |
| 121 | Comparative Example | 0.808 | 0.008 | 0.004 | 0.110 | 0.020 | 0.030 | 0.010 | 0.010 | 0.130 | Conventional apparatus |
| 122 | Example | 0.808 | 0.008 | 0.004 | 0.110 | 0.020 | 0.030 | 0.010 | 0.010 | 0.130 | Elliptical water flow apparatus |
| 123 | Comparative Example | 0.804 | 0.008 | 0.008 | 0.110 | 0.020 | 0.030 | 0.010 | 0.010 | 0.130 | Conventional apparatus |
| 124 | Example | 0.804 | 0.008 | 0.008 | 0.110 | 0.020 | 0.030 | 0.010 | 0.010 | 0.130 | Elliptical water flow apparatus |
| 125 | Comparative Example | 0.787 | 0.008 | 0.025 | 0.110 | 0.020 | 0.030 | 0.010 | 0.010 | 0.130 | Conventional apparatus |
| 126 | Example | 0.787 | 0.008 | 0.025 | 0.110 | 0.020 | 0.030 | 0.010 | 0.010 | 0.130 | Elliptical water flow apparatus |
| 127 | Comparative Example | 0.771 | 0.008 | 0.041 | 0.110 | 0.020 | 0.030 | 0.010 | 0.010 | 0.130 | Conventional apparatus |
| 128 | Example | 0.771 | 0.008 | 0.041 | 0.110 | 0.020 | 0.030 | 0.010 | 0.010 | 0.130 | Elliptical water flow apparatus |
| 129 | Comparative Example | 0.730 | 0.008 | 0.082 | 0.110 | 0.020 | 0.030 | 0.010 | 0.010 | 0.130 | Conventional apparatus |
| 130 | Example | 0.730 | 0.008 | 0.082 | 0.110 | 0.020 | 0.030 | 0.010 | 0.010 | 0.130 | Elliptical water flow apparatus |
| 131 | Comparative Example | 0.648 | 0.008 | 0.164 | 0.110 | 0.020 | 0.030 | 0.010 | 0.010 | 0.130 | Conventional apparatus |
| 132 | Example | 0.648 | 0.008 | 0.164 | 0.110 | 0.020 | 0.030 | 0.010 | 0.010 | 0.130 | Elliptical water flow apparatus |
| 133 | Comparative Example | 0.640 | 0.008 | 0.172 | 0.110 | 0.020 | 0.030 | 0.010 | 0.010 | 0.130 | Conventional apparatus |
| 134 | Comparative Example | 0.640 | 0.008 | 0.172 | 0.110 | 0.020 | 0.030 | 0.010 | 0.010 | 0.130 | Elliptical water flow apparatus |

| | | | | | | Magnetic core (μ = 25) | | | | | | | |
|---|---|---|---|---|---|---|---|---|---|---|---|---|---|
| | Soft magnetic alloy powder | | | | | Manufacturing | | | | | | | |
| | Particle | | Circularity of | | | condition | Particle | | Circularity of | | Characteristics | | |
| | size | | large particles | | Ribbon | Molding | size | | large particles | | Packing | Core | |
| Sample | D50 | D90 | Average | Variance | Bs | pressure | D50 | D90 | Average | Variance | density | loss | Isat |
| No. | μm | μm | (—) | (—) | T | t/cm² | μm | μm | (—) | (—) | (—) | Ratio | Ratio |
| 119 | 7.2 | 18.4 | 0.67 | 0.048 | 1.57 | 12 | 8.9 | 25.8 | 0.60 | 0.051 | 76% | 1.00 | 1.00 |
| 120 | 7.8 | 17.5 | 0.90 | 0.024 | 1.57 | 8 | 10.0 | 25.3 | 0.89 | 0.025 | 75% | 0.67 | 1.10 |
| 121 | 7.6 | 18.7 | 0.68 | 0.048 | 1.59 | 12 | 9.2 | 25.7 | 0.61 | 0.050 | 76% | 1.00 | 1.00 |
| 122 | 7.5 | 18.0 | 0.91 | 0.024 | 1.59 | 8 | 9.6 | 24.4 | 0.91 | 0.025 | 74% | 0.59 | 1.23 |
| 123 | 7.7 | 18.3 | 0.68 | 0.048 | 1.60 | 12 | 9.4 | 25.5 | 0.57 | 0.053 | 76% | 1.00 | 1.00 |
| 124 | 7.6 | 18.7 | 0.90 | 0.024 | 1.60 | 8 | 9.1 | 26.0 | 0.91 | 0.025 | 75% | 0.70 | 1.26 |
| 125 | 7.6 | 18.3 | 0.68 | 0.048 | 1.64 | 12 | 9.8 | 24.9 | 0.57 | 0.054 | 76% | 1.00 | 1.00 |
| 126 | 7.7 | 19.2 | 0.89 | 0.024 | 1.64 | 8 | 9.2 | 26.7 | 0.90 | 0.025 | 75% | 0.68 | 1.25 |
| 127 | 7.1 | 18.6 | 0.68 | 0.048 | 1.67 | 12 | 8.6 | 26.3 | 0.55 | 0.051 | 76% | 1.00 | 1.00 |
| 128 | 8.2 | 18.7 | 0.90 | 0.024 | 1.67 | 8 | 10.4 | 25.6 | 0.90 | 0.024 | 75% | 0.56 | 1.26 |
| 129 | 8.0 | 17.1 | 0.68 | 0.049 | 1.70 | 12 | 10.2 | 24.1 | 0.55 | 0.051 | 76% | 1.00 | 1.00 |
| 130 | 7.7 | 18.3 | 0.91 | 0.026 | 1.70 | 8 | 9.5 | 25.3 | 0.91 | 0.027 | 74% | 0.53 | 1.27 |
| 131 | 7.6 | 18.7 | 0.68 | 0.049 | 1.67 | 12 | 9.5 | 26.3 | 0.57 | 0.055 | 76% | 1.00 | 1.00 |
| 132 | 8.2 | 17.2 | 0.90 | 0.033 | 1.67 | 8 | 10.2 | 23.8 | 0.90 | 0.035 | 75% | 0.63 | 1.15 |
| 133 | 8.4 | 18.7 | 0.69 | 0.050 | 1.67 | 12 | 10.4 | 26.8 | 0.60 | 0.058 | 76% | 1.00 | 1.00 |
| 134 | 8.5 | 16.6 | 0.91 | 0.038 | 1.67 | 8 | 10.5 | 23.1 | 0.80 | 0.038 | 74% | 0.60 | 1.09 |

*A = 1 − (a + b + c + d + e)

TABLE 7D

| | | Soft magnetic alloy powder | | | | | | | | | |
|---|---|---|---|---|---|---|---|---|---|---|---|
| | | (Fe_{(1-(α+β))}Co_{α}Ni_{β})_{(1-(a+b+c+d+e))}BₐP_{b}Si_{c}C_{d}Crₑ (γ = 0) | | | | | | | | | |
| Sample | Comparative Example/ | Fe | Co | Ni | B | P | Si | C | Cr | B + P | Manufacturing condition |
| No. | Example | (1 − (α + β)) × A | α × A | β × A | a | b | c | d | e | a + b | Atomizing apparatus |
| 135 | Comparative Example | 0.574 | 0.246 | 0.000 | 0.110 | 0.020 | 0.030 | 0.010 | 0.010 | 0.130 | Conventional apparatus |
| 136 | Example | 0.574 | 0.246 | 0.000 | 0.110 | 0.020 | 0.030 | 0.010 | 0.010 | 0.130 | Elliptical water flow apparatus |
| 137 | Comparative Example | 0.570 | 0.246 | 0.004 | 0.110 | 0.020 | 0.030 | 0.010 | 0.010 | 0.130 | Conventional apparatus |
| 138 | Example | 0.570 | 0.246 | 0.004 | 0.110 | 0.020 | 0.030 | 0.010 | 0.010 | 0.130 | Elliptical water flow apparatus |
| 139 | Comparative Example | 0.566 | 0.246 | 0.008 | 0.110 | 0.020 | 0.030 | 0.010 | 0.010 | 0.130 | Conventional apparatus |
| 140 | Example | 0.566 | 0.246 | 0.008 | 0.110 | 0.020 | 0.030 | 0.010 | 0.010 | 0.130 | Elliptical water flow apparatus |
| 141 | Comparative Example | 0.549 | 0.246 | 0.025 | 0.110 | 0.020 | 0.030 | 0.010 | 0.010 | 0.130 | Conventional apparatus |
| 142 | Example | 0.549 | 0.246 | 0.025 | 0.110 | 0.020 | 0.030 | 0.010 | 0.010 | 0.130 | Elliptical water flow apparatus |
| 143 | Comparative Example | 0.533 | 0.246 | 0.041 | 0.110 | 0.020 | 0.030 | 0.010 | 0.010 | 0.130 | Conventional apparatus |
| 144 | Example | 0.533 | 0.246 | 0.041 | 0.110 | 0.020 | 0.030 | 0.010 | 0.010 | 0.130 | Elliptical water flow apparatus |
| 145 | Comparative Example | 0.492 | 0.246 | 0.082 | 0.110 | 0.020 | 0.030 | 0.010 | 0.010 | 0.130 | Conventional apparatus |
| 146 | Example | 0.492 | 0.246 | 0.082 | 0.110 | 0.020 | 0.030 | 0.010 | 0.010 | 0.130 | Elliptical water flow apparatus |
| 147 | Comparative Example | 0.410 | 0.246 | 0.164 | 0.110 | 0.020 | 0.030 | 0.010 | 0.010 | 0.130 | Conventional apparatus |
| 148 | Example | 0.410 | 0.246 | 0.164 | 0.110 | 0.020 | 0.030 | 0.010 | 0.010 | 0.130 | Elliptical water flow apparatus |
| 149 | Comparative Example | 0.402 | 0.246 | 0.172 | 0.110 | 0.020 | 0.030 | 0.010 | 0.010 | 0.130 | Conventional apparatus |
| 150 | Comparative Example | 0.402 | 0.246 | 0.172 | 0.110 | 0.020 | 0.030 | 0.010 | 0.010 | 0.130 | Elliptical water flow apparatus |

| | | | | | | Magnetic core (μ = 25) | | | | | | | |
|---|---|---|---|---|---|---|---|---|---|---|---|---|---|
| | Soft magnetic alloy powder | | | | | Manufacturing | | | | | | | |
| | Particle | | Circularity of | | | condition | Particle | | Circularity of | | Characteristics | | |
| | size | | large particles | | Ribbon | Molding | size | | large particles | | Packing | Core | |
| Sample | D50 | D90 | Average | Variance | Bs | pressure | D50 | D90 | Average | Variance | density | loss | Isat |
| No. | μm | μm | (—) | (—) | T | t/cm² | μm | μm | (—) | (—) | (—) | Ratio | Ratio |
| 135 | 8.2 | 16.6 | 0.71 | 0.041 | 1.70 | 12 | 10.3 | 22.6 | 0.62 | 0.043 | 76% | 1.00 | 1.00 |
| 136 | 7.9 | 17.4 | 0.95 | 0.004 | 1.70 | 4 | 9.6 | 24.9 | 0.95 | 0.004 | 74% | 0.55 | 1.27 |
| 137 | 7.2 | 18.9 | 0.71 | 0.041 | 1.70 | 12 | 9.4 | 27.1 | 0.62 | 0.043 | 76% | 1.00 | 1.00 |
| 138 | 7.7 | 18.3 | 0.94 | 0.004 | 1.70 | 4 | 9.3 | 26.1 | 0.94 | 0.004 | 74% | 0.62 | 1.25 |
| 139 | 7.8 | 18.4 | 0.71 | 0.041 | 1.70 | 12 | 9.6 | 25.3 | 0.57 | 0.047 | 76% | 1.00 | 1.00 |
| 140 | 7.6 | 18.4 | 0.94 | 0.004 | 1.70 | 4 | 9.2 | 26.6 | 0.95 | 0.004 | 74% | 0.60 | 1.23 |
| 141 | 8.2 | 17.9 | 0.71 | 0.042 | 1.69 | 12 | 10.1 | 25.1 | 0.58 | 0.043 | 76% | 1.00 | 1.00 |
| 142 | 7.9 | 18.4 | 0.94 | 0.004 | 1.69 | 4 | 9.5 | 25.5 | 0.93 | 0.004 | 74% | 0.57 | 1.24 |
| 143 | 7.8 | 17.8 | 0.71 | 0.041 | 1.68 | 12 | 9.7 | 25.0 | 0.59 | 0.052 | 76% | 1.00 | 1.00 |
| 144 | 7.3 | 18.7 | 0.94 | 0.010 | 1.68 | 4 | 9.0 | 26.8 | 0.94 | 0.010 | 74% | 0.57 | 1.25 |
| 145 | 7.7 | 18.7 | 0.71 | 0.043 | 1.64 | 12 | 9.8 | 26.5 | 0.63 | 0.044 | 76% | 1.00 | 1.00 |
| 146 | 8.3 | 19.2 | 0.94 | 0.012 | 1.64 | 4 | 10.3 | 26.6 | 0.95 | 0.012 | 74% | 0.58 | 1.19 |
| 147 | 7.8 | 18.6 | 0.71 | 0.043 | 1.54 | 12 | 10.1 | 26.7 | 0.63 | 0.046 | 76% | 1.00 | 1.00 |
| 148 | 7.3 | 18.0 | 0.95 | 0.029 | 1.54 | 4 | 9.4 | 24.6 | 0.95 | 0.030 | 74% | 0.57 | 1.10 |
| 149 | 7.3 | 19.2 | 0.72 | 0.044 | 1.53 | 12 | 9.4 | 26.4 | 0.60 | 0.046 | 75% | 1.00 | 1.00 |
| 150 | 7.3 | 18.4 | 0.94 | 0.037 | 1.53 | 4 | 9.2 | 26.2 | 0.77 | 0.038 | 74% | 0.60 | 1.01 |

*A = 1 − (a + b + c + d + e)

TABLE 7E

| | | Soft magnetic alloy powder | | | | | | | | | |
|---|---|---|---|---|---|---|---|---|---|---|---|
| | | (Fe_{(1-(α+β))}Co_{α}Ni_{β})_{(1-(a+b+c+d+e))}BₐP_{b}Si_{c}C_{d}Crₑ (γ = 0) | | | | | | | | | |
| Sample | Comparative Example/ | Fe | Co | Ni | B | P | Si | C | Cr | B + P | Manufacturing condition |
| No. | Example | (1 − (α + β)) × A | α × A | β × A | a | b | c | d | e | a + b | Atomizing apparatus |
| 151 | Comparative Example | 0.410 | 0.410 | 0.000 | 0.110 | 0.020 | 0.030 | 0.010 | 0.010 | 0.130 | Conventional apparatus |
| 152 | Example | 0.410 | 0.410 | 0.000 | 0.110 | 0.020 | 0.030 | 0.010 | 0.010 | 0.130 | Elliptical water flow apparatus |
| 153 | Comparative Example | 0.406 | 0.410 | 0.004 | 0.110 | 0.020 | 0.030 | 0.010 | 0.010 | 0.130 | Conventional apparatus |
| 154 | Example | 0.406 | 0.410 | 0.004 | 0.110 | 0.020 | 0.030 | 0.010 | 0.010 | 0.130 | Elliptical water flow apparatus |
| 155 | Comparative Example | 0.402 | 0.410 | 0.008 | 0.110 | 0.020 | 0.030 | 0.010 | 0.010 | 0.130 | Conventional apparatus |
| 156 | Example | 0.402 | 0.410 | 0.008 | 0.110 | 0.020 | 0.030 | 0.010 | 0.010 | 0.130 | Elliptical water flow apparatus |
| 157 | Comparative Example | 0.385 | 0.410 | 0.025 | 0.110 | 0.020 | 0.030 | 0.010 | 0.010 | 0.130 | Conventional apparatus |
| 158 | Example | 0.385 | 0.410 | 0.025 | 0.110 | 0.020 | 0.030 | 0.010 | 0.010 | 0.130 | Elliptical water flow apparatus |
| 159 | Comparative Example | 0.369 | 0.410 | 0.041 | 0.110 | 0.020 | 0.030 | 0.010 | 0.010 | 0.130 | Conventional apparatus |
| 160 | Example | 0.369 | 0.410 | 0.041 | 0.110 | 0.020 | 0.030 | 0.010 | 0.010 | 0.130 | Elliptical water flow apparatus |
| 161 | Comparative Example | 0.328 | 0.410 | 0.082 | 0.110 | 0.020 | 0.030 | 0.010 | 0.010 | 0.130 | Conventional apparatus |
| 162 | Example | 0.328 | 0.410 | 0.082 | 0.110 | 0.020 | 0.030 | 0.010 | 0.010 | 0.130 | Elliptical water flow apparatus |
| 163 | Comparative Example | 0.246 | 0.410 | 0.164 | 0.110 | 0.020 | 0.030 | 0.010 | 0.010 | 0.130 | Conventional apparatus |
| 164 | Example | 0.246 | 0.410 | 0.164 | 0.110 | 0.020 | 0.030 | 0.010 | 0.010 | 0.130 | Elliptical water flow apparatus |
| 165 | Comparative Example | 0.238 | 0.410 | 0.172 | 0.110 | 0.020 | 0.030 | 0.010 | 0.010 | 0.130 | Conventional apparatus |
| 166 | Comparative Example | 0.238 | 0.410 | 0.172 | 0.110 | 0.020 | 0.030 | 0.010 | 0.010 | 0.130 | Elliptical water flow apparatus |

| | | | | | | Magnetic core (μ = 25) | | | | | | | |
|---|---|---|---|---|---|---|---|---|---|---|---|---|---|
| | Soft magnetic alloy powder | | | | | Manufacturing | | | | | | | |
| | Particle | | Circularity of | | | condition | Particle | | Circularity of | | Characteristics | | |
| | size | | large particles | | Ribbon | Molding | size | | large particles | | Packing | Core | |
| Sample | D50 | D90 | Average | Variance | Bs | pressure | D50 | D90 | Average | Variance | density | loss | Isat |
| No. | μm | μm | (—) | (—) | T | t/cm² | μm | μm | (—) | (—) | (—) | Ratio | Ratio |
| 151 | 7.6 | 18.2 | 0.70 | 0.043 | 1.64 | 12 | 9.4 | 24.6 | 0.62 | 0.044 | 76% | 1.00 | 1.00 |
| 152 | 8.2 | 18.4 | 0.95 | 0.012 | 1.64 | 4 | 10.6 | 26.5 | 0.94 | 0.012 | 74% | 0.59 | 1.21 |
| 153 | 8.4 | 16.8 | 0.72 | 0.043 | 1.64 | 12 | 10.2 | 22.9 | 0.63 | 0.047 | 75% | 1.00 | 1.00 |
| 154 | 7.8 | 17.0 | 0.93 | 0.012 | 1.64 | 4 | 9.9 | 24.1 | 0.94 | 0.012 | 74% | 0.57 | 1.20 |
| 155 | 8.5 | 17.8 | 0.71 | 0.043 | 1.64 | 12 | 10.7 | 24.9 | 0.62 | 0.056 | 76% | 1.00 | 1.00 |
| 156 | 7.5 | 17.9 | 0.94 | 0.012 | 1.64 | 4 | 9.6 | 24.8 | 0.93 | 0.012 | 74% | 0.54 | 1.19 |
| 157 | 8.3 | 19.3 | 0.71 | 0.044 | 1.62 | 12 | 10.2 | 26.5 | 0.61 | 0.046 | 76% | 1.00 | 1.00 |
| 158 | 8.1 | 17.5 | 0.94 | 0.012 | 1.62 | 4 | 10.1 | 24.4 | 0.94 | 0.012 | 74% | 0.54 | 1.17 |
| 159 | 8.4 | 18.0 | 0.70 | 0.044 | 1.60 | 12 | 10.8 | 25.1 | 0.60 | 0.045 | 76% | 1.00 | 1.00 |
| 160 | 8.5 | 18.1 | 0.94 | 0.012 | 1.60 | 4 | 10.6 | 24.7 | 0.94 | 0.012 | 74% | 0.57 | 1.15 |
| 161 | 7.2 | 17.4 | 0.71 | 0.045 | 1.54 | 12 | 9.1 | 24.8 | 0.64 | 0.049 | 76% | 1.00 | 1.00 |
| 162 | 7.5 | 16.6 | 0.93 | 0.018 | 1.54 | 4 | 9.4 | 23.6 | 0.94 | 0.018 | 74% | 0.60 | 1.13 |
| 163 | 8.3 | 16.9 | 0.71 | 0.045 | 1.38 | 12 | 10.4 | 24.3 | 0.59 | 0.057 | 76% | 1.00 | 1.00 |
| 164 | 8.4 | 19.3 | 0.95 | 0.030 | 1.38 | 4 | 10.7 | 26.3 | 0.94 | 0.031 | 74% | 0.53 | 1.11 |
| 165 | 7.4 | 18.9 | 0.71 | 0.046 | 1.36 | 12 | 9.6 | 26.1 | 0.61 | 0.053 | 76% | 1.00 | 1.00 |
| 166 | 8.0 | 16.7 | 0.94 | 0.038 | 1.36 | 4 | 9.9 | 23.3 | 0.83 | 0.039 | 74% | 0.56 | 1.01 |

*A = 1 − (a + b + c + d + e)

TABLE 7F

| | | Soft magnetic alloy powder | | | | | | | | | |
|---|---|---|---|---|---|---|---|---|---|---|---|
| | | (Fe_{(1-(α+β))}Co_{α}Ni_{β})_{(1-(a+b+c+d+e))}BₐP_{b}Si_{c}C_{d}Crₑ (γ = 0) | | | | | | | | | |
| Sample | Comparative Example/ | Fe | Co | Ni | B | P | Si | C | Cr | B + P | Manufacturing condition |
| No. | Example | (1 − (α + β)) × A | α × A | β × A | a | b | c | d | e | a + b | Atomizing apparatus |
| 167 | Comparative Example | 0.246 | 0.574 | 0.000 | 0.110 | 0.020 | 0.030 | 0.010 | 0.010 | 0.130 | Conventional apparatus |
| 168 | Example | 0.246 | 0.574 | 0.000 | 0.110 | 0.020 | 0.030 | 0.010 | 0.010 | 0.130 | Elliptical water flow apparatus |
| 169 | Comparative Example | 0.242 | 0.574 | 0.004 | 0.110 | 0.020 | 0.030 | 0.010 | 0.010 | 0.130 | Conventional apparatus |
| 170 | Example | 0.242 | 0.574 | 0.004 | 0.110 | 0.020 | 0.030 | 0.010 | 0.010 | 0.130 | Elliptical water flow apparatus |
| 171 | Comparative Example | 0.238 | 0.574 | 0.008 | 0.110 | 0.020 | 0.030 | 0.010 | 0.010 | 0.130 | Conventional apparatus |
| 172 | Example | 0.238 | 0.574 | 0.008 | 0.110 | 0.020 | 0.030 | 0.010 | 0.010 | 0.130 | Elliptical water flow apparatus |
| 173 | Comparative Example | 0.221 | 0.574 | 0.025 | 0.110 | 0.020 | 0.030 | 0.010 | 0.010 | 0.130 | Conventional apparatus |
| 174 | Example | 0.221 | 0.574 | 0.025 | 0.110 | 0.020 | 0.030 | 0.010 | 0.010 | 0.130 | Elliptical water flow apparatus |
| 175 | Comparative Example | 0.205 | 0.574 | 0.041 | 0.110 | 0.020 | 0.030 | 0.010 | 0.010 | 0.130 | Conventional apparatus |
| 176 | Example | 0.205 | 0.574 | 0.041 | 0.110 | 0.020 | 0.030 | 0.010 | 0.010 | 0.130 | Elliptical water flow apparatus |
| 177 | Comparative Example | 0.164 | 0.574 | 0.082 | 0.110 | 0.020 | 0.030 | 0.010 | 0.010 | 0.130 | Conventional apparatus |
| 178 | Example | 0.164 | 0.574 | 0.082 | 0.110 | 0.020 | 0.030 | 0.010 | 0.010 | 0.130 | Elliptical water flow apparatus |
| 179 | Comparative Example | 0.082 | 0.574 | 0.164 | 0.110 | 0.020 | 0.030 | 0.010 | 0.010 | 0.130 | Conventional apparatus |
| 180 | Comparative Example | 0.082 | 0.574 | 0.164 | 0.110 | 0.020 | 0.030 | 0.010 | 0.010 | 0.130 | Elliptical water flow apparatus |
| 181 | Comparative Example | 0.074 | 0.574 | 0.172 | 0.110 | 0.020 | 0.030 | 0.010 | 0.010 | 0.130 | Conventional apparatus |
| 182 | Comparative Example | 0.074 | 0.574 | 0.172 | 0.110 | 0.020 | 0.030 | 0.010 | 0.010 | 0.130 | Elliptical water flow apparatus |

| | | | | | | Magnetic core (μ = 25) | | | | | | | |
|---|---|---|---|---|---|---|---|---|---|---|---|---|---|
| | Soft magnetic alloy powder | | | | | Manufacturing | | | | | | | |
| | Particle | | Circularity of | | | condition | Particle | | Circularity of | | Characteristics | | |
| | size | | large particles | | Ribbon | Molding | size | | large particles | | Packing | Core | |
| Sample | D50 | D90 | Average | Variance | Bs | pressure | D50 | D90 | Average | Variance | density | loss | Isat |
| No. | μm | μm | (—) | (—) | T | t/cm² | μm | μm | (—) | (—) | (—) | Ratio | Ratio |
| 167 | 7.3 | 17.5 | 0.71 | 0.043 | 1.55 | 12 | 9.2 | 25.2 | 0.58 | 0.054 | 76% | 1.00 | 1.00 |
| 168 | 7.5 | 16.8 | 0.93 | 0.028 | 1.55 | 4 | 9.1 | 23.1 | 0.94 | 0.028 | 74% | 0.58 | 1.10 |
| 169 | 7.1 | 19.0 | 0.71 | 0.043 | 1.54 | 12 | 9.2 | 26.2 | 0.60 | 0.051 | 76% | 1.00 | 1.00 |
| 170 | 8.2 | 18.7 | 0.95 | 0.028 | 1.54 | 4 | 10.1 | 25.9 | 0.95 | 0.029 | 74% | 0.56 | 1.10 |
| 171 | 7.3 | 19.2 | 0.72 | 0.043 | 1.54 | 12 | 9.0 | 26.5 | 0.60 | 0.050 | 75% | 1.00 | 1.00 |
| 172 | 7.8 | 17.1 | 0.95 | 0.028 | 1.54 | 4 | 9.9 | 23.9 | 0.95 | 0.029 | 74% | 0.58 | 1.11 |
| 173 | 7.1 | 18.3 | 0.71 | 0.043 | 1.50 | 12 | 9.0 | 25.5 | 0.59 | 0.049 | 76% | 1.00 | 1.00 |
| 174 | 8.3 | 17.8 | 0.93 | 0.028 | 1.50 | 4 | 10.0 | 25.2 | 0.94 | 0.029 | 74% | 0.58 | 1.12 |
| 175 | 7.2 | 17.5 | 0.71 | 0.043 | 1.47 | 12 | 9.0 | 25.0 | 0.57 | 0.053 | 76% | 1.00 | 1.00 |
| 176 | 8.3 | 19.2 | 0.93 | 0.028 | 1.47 | 4 | 10.2 | 26.2 | 0.93 | 0.028 | 74% | 0.62 | 1.11 |
| 177 | 8.0 | 16.8 | 0.70 | 0.045 | 1.38 | 12 | 10.3 | 24.2 | 0.60 | 0.056 | 76% | 1.00 | 1.00 |
| 178 | 7.8 | 16.6 | 0.94 | 0.034 | 1.38 | 4 | 9.6 | 23.8 | 0.94 | 0.034 | 74% | 0.59 | 1.10 |
| 179 | 8.3 | 17.2 | 0.71 | 0.045 | 1.20 | 12 | 10.4 | 23.6 | 0.62 | 0.058 | 76% | 1.00 | 1.00 |
| 180 | 8.3 | 18.9 | 0.94 | 0.036 | 1.20 | 4 | 10.1 | 26.8 | 0.94 | 0.037 | 74% | 0.57 | 1.08 |
| 181 | 7.5 | 18.7 | 0.72 | 0.046 | 1.18 | 12 | 9.2 | 26.0 | 0.58 | 0.057 | 75% | 1.00 | 1.00 |
| 182 | 7.4 | 18.0 | 0.95 | 0.048 | 1.18 | 4 | 9.5 | 24.7 | 0.78 | 0.050 | 74% | 0.55 | 1.02 |

*A = 1 − (a + b + c + d + e)

TABLE 7G

| | | Soft magnetic alloy powder | | | | | | | | | |
|---|---|---|---|---|---|---|---|---|---|---|---|
| | | (Fe_{(1-(α+β))}Co_{α}Ni_{β})_{(1-(a+b+c+d+e))}BₐP_{b}Si_{c}C_{d}Crₑ (γ = 0) | | | | | | | | | |
| Sample | Comparative Example/ | Fe | Co | Ni | B | P | Si | C | Cr | B + P | Manufacturing condition |
| No. | Example | (1 − (α + β)) × A | α × A | β × A | a | b | c | d | e | a + b | Atomizing apparatus |
| 183 | Comparative Example | 0.238 | 0.582 | 0.000 | 0.110 | 0.020 | 0.030 | 0.010 | 0.010 | 0.130 | Conventional apparatus |
| 184 | Example | 0.238 | 0.582 | 0.000 | 0.110 | 0.020 | 0.030 | 0.010 | 0.010 | 0.130 | Elliptical water flow apparatus |
| 185 | Comparative Example | 0.234 | 0.582 | 0.004 | 0.110 | 0.020 | 0.030 | 0.010 | 0.010 | 0.130 | Conventional apparatus |
| 186 | Example | 0.234 | 0.582 | 0.004 | 0.110 | 0.020 | 0.030 | 0.010 | 0.010 | 0.130 | Elliptical water flow apparatus |
| 187 | Comparative Example | 0.230 | 0.582 | 0.008 | 0.110 | 0.020 | 0.030 | 0.010 | 0.010 | 0.130 | Conventional apparatus |
| 188 | Example | 0.230 | 0.582 | 0.008 | 0.110 | 0.020 | 0.030 | 0.010 | 0.010 | 0.130 | Elliptical water flow apparatus |
| 189 | Comparative Example | 0.213 | 0.582 | 0.025 | 0.110 | 0.020 | 0.030 | 0.010 | 0.010 | 0.130 | Conventional apparatus |
| 190 | Example | 0.213 | 0.582 | 0.025 | 0.110 | 0.020 | 0.030 | 0.010 | 0.010 | 0.130 | Elliptical water flow apparatus |
| 191 | Comparative Example | 0.197 | 0.582 | 0.041 | 0.110 | 0.020 | 0.030 | 0.010 | 0.010 | 0.130 | Conventional apparatus |
| 192 | Example | 0.197 | 0.582 | 0.041 | 0.110 | 0.020 | 0.030 | 0.010 | 0.010 | 0.130 | Elliptical water flow apparatus |
| 193 | Comparative Example | 0.156 | 0.582 | 0.082 | 0.110 | 0.020 | 0.030 | 0.010 | 0.010 | 0.130 | Conventional apparatus |
| 194 | Example | 0.156 | 0.582 | 0.082 | 0.110 | 0.020 | 0.030 | 0.010 | 0.010 | 0.130 | Elliptical water flow apparatus |
| 195 | Comparative Example | 0.074 | 0.582 | 0.164 | 0.110 | 0.020 | 0.030 | 0.010 | 0.010 | 0.130 | Conventional apparatus |
| 196 | Example | 0.074 | 0.582 | 0.164 | 0.110 | 0.020 | 0.030 | 0.010 | 0.010 | 0.130 | Elliptical water flow apparatus |
| 197 | Comparative Example | 0.066 | 0.582 | 0.172 | 0.110 | 0.020 | 0.030 | 0.010 | 0.010 | 0.130 | Conventional apparatus |
| 198 | Comparative Example | 0.066 | 0.582 | 0.172 | 0.110 | 0.020 | 0.030 | 0.010 | 0.010 | 0.130 | Elliptical water flow apparatus |

| | | | | | | Magnetic core (μ = 25) | | | | | | | |
|---|---|---|---|---|---|---|---|---|---|---|---|---|---|
| | Soft magnetic alloy powder | | | | | Manufacturing | | | | | | | |
| | Particle | | Circularity of | | | condition | Particle | | Circularity of | | Characteristics | | |
| | size | | large particles | | Ribbon | Molding | size | | large particles | | Packing | Core | |
| Sample | D50 | D90 | Average | Variance | Bs | pressure | D50 | D90 | Average | Variance | density | loss | Isat |
| No. | μm | μm | (—) | (—) | T | t/cm² | μm | μm | (—) | (—) | (—) | Ratio | Ratio |
| 183 | 7.0 | 17.8 | 0.71 | 0.046 | 1.54 | 12 | 8.7 | 24.1 | 0.62 | 0.047 | 76% | 1.00 | 1.00 |
| 184 | 8.0 | 17.5 | 0.94 | 0.044 | 1.54 | 4 | 10.1 | 24.5 | 0.84 | 0.046 | 74% | 0.55 | 1.03 |
| 185 | 8.0 | 17.6 | 0.71 | 0.046 | 1.54 | 12 | 10.0 | 24.1 | 0.59 | 0.055 | 76% | 1.00 | 1.00 |
| 186 | 8.4 | 19.5 | 0.93 | 0.044 | 1.54 | 4 | 10.5 | 28.1 | 0.76 | 0.046 | 74% | 0.58 | 1.02 |
| 187 | 7.7 | 19.4 | 0.72 | 0.046 | 1.53 | 12 | 9.6 | 27.6 | 0.63 | 0.049 | 75% | 1.00 | 1.00 |
| 188 | 7.1 | 17.4 | 0.94 | 0.045 | 1.53 | 4 | 9.0 | 24.9 | 0.81 | 0.046 | 74% | 0.58 | 1.02 |
| 189 | 7.6 | 18.0 | 0.71 | 0.046 | 1.50 | 12 | 9.3 | 25.1 | 0.61 | 0.048 | 76% | 1.00 | 1.00 |
| 190 | 8.3 | 19.0 | 0.95 | 0.045 | 1.50 | 4 | 10.3 | 27.5 | 0.77 | 0.046 | 74% | 0.56 | 1.03 |
| 191 | 7.2 | 19.2 | 0.71 | 0.046 | 1.46 | 12 | 9.0 | 26.6 | 0.62 | 0.059 | 76% | 1.00 | 1.00 |
| 192 | 7.4 | 16.7 | 0.94 | 0.046 | 1.46 | 4 | 9.5 | 23.4 | 0.80 | 0.046 | 74% | 0.57 | 1.01 |
| 193 | 7.5 | 18.6 | 0.70 | 0.048 | 1.37 | 12 | 9.0 | 26.3 | 0.57 | 0.049 | 76% | 1.00 | 1.00 |
| 194 | 8.2 | 17.2 | 0.94 | 0.046 | 1.37 | 4 | 10.2 | 24.0 | 0.82 | 0.048 | 74% | 0.55 | 1.02 |
| 195 | 7.6 | 18.5 | 0.70 | 0.048 | 1.19 | 12 | 9.7 | 26.2 | 0.60 | 0.052 | 76% | 1.00 | 1.00 |
| 196 | 8.4 | 18.4 | 0.94 | 0.050 | 1.19 | 4 | 10.1 | 26.0 | 0.78 | 0.051 | 74% | 0.57 | 1.02 |
| 197 | 8.2 | 18.3 | 0.71 | 0.049 | 1.17 | 12 | 10.4 | 24.8 | 0.58 | 0.049 | 76% | 1.00 | 1.00 |
| 198 | 7.8 | 17.9 | 0.93 | 0.055 | 1.17 | 4 | 10.0 | 24.8 | 0.76 | 0.057 | 74% | 0.59 | 1.03 |

*A = 1 − (a + b + c + d + e)

TABLE 8

| | | Soft magnetic alloy powder | | | | | | | | |
|---|---|---|---|---|---|---|---|---|---|---|
| | | (Fe_{(1-α)}Co_{α})_{(1-(a+b+c+d+e))}BₐP_{b}Si_{c}C_{d}Crₑ (α = 0.300, β = γ = 0) | | | | | | | | |
| Sample | Comparative Example/ | Fe | Co | B | P | Si | C | Cr | B + P | Manufacturing condition |
| No. | Example | (1 − α) × A | α × A | a | b | c | d | e | a + b | Atomizing apparatus |
| 199 | Comparative Example | 0.546 | 0.234 | 0.136 | 0.025 | 0.037 | 0.012 | 0.010 | 0.161 | Conventional apparatus |
| 200 | Comparative Example | 0.546 | 0.234 | 0.136 | 0.025 | 0.037 | 0.012 | 0.010 | 0.161 | Elliptical water flow apparatus |
| 201 | Comparative Example | 0.553 | 0.237 | 0.129 | 0.024 | 0.035 | 0.012 | 0.010 | 0.153 | Conventional apparatus |
| 202 | Example | 0.553 | 0.237 | 0.129 | 0.024 | 0.035 | 0.012 | 0.010 | 0.153 | Elliptical water flow apparatus |
| 203 | Comparative Example | 0.560 | 0.240 | 0.123 | 0.022 | 0.034 | 0.011 | 0.010 | 0.145 | Conventional apparatus |
| 204 | Example | 0.560 | 0.240 | 0.123 | 0.022 | 0.034 | 0.011 | 0.010 | 0.145 | Elliptical water flow apparatus |
| 205 | Comparative Example | 0.567 | 0.243 | 0.116 | 0.021 | 0.032 | 0.011 | 0.010 | 0.138 | Conventional apparatus |
| 206 | Example | 0.567 | 0.243 | 0.116 | 0.021 | 0.032 | 0.011 | 0.010 | 0.138 | Elliptical water flow apparatus |
| 207 | Comparative Example | 0.574 | 0.246 | 0.110 | 0.020 | 0.030 | 0.010 | 0.010 | 0.130 | Conventional apparatus |
| 208 | Example | 0.574 | 0.246 | 0.110 | 0.020 | 0.030 | 0.010 | 0.010 | 0.130 | Elliptical water flow apparatus |
| 209 | Comparative Example | 0.581 | 0.249 | 0.104 | 0.019 | 0.028 | 0.009 | 0.010 | 0.122 | Conventional apparatus |
| 210 | Example | 0.581 | 0.249 | 0.104 | 0.019 | 0.028 | 0.009 | 0.010 | 0.122 | Elliptical water flow apparatus |
| 211 | Comparative Example | 0.588 | 0.252 | 0.097 | 0.018 | 0.026 | 0.009 | 0.010 | 0.115 | Conventional apparatus |
| 212 | Example | 0.588 | 0.252 | 0.097 | 0.018 | 0.026 | 0.009 | 0.010 | 0.115 | Elliptical water flow apparatus |
| 213 | Comparative Example | 0.595 | 0.255 | 0.091 | 0.016 | 0.025 | 0.008 | 0.010 | 0.107 | Conventional apparatus |
| 214 | Example | 0.595 | 0.255 | 0.091 | 0.016 | 0.025 | 0.008 | 0.010 | 0.107 | Elliptical water flow apparatus |
| 215 | Comparative Example | 0.602 | 0.258 | 0.084 | 0.015 | 0.023 | 0.008 | 0.010 | 0.099 | Conventional apparatus |
| 216 | Example | 0.602 | 0.258 | 0.084 | 0.015 | 0.023 | 0.008 | 0.010 | 0.099 | Elliptical water flow apparatus |
| 217 | Comparative Example | 0.609 | 0.261 | 0.078 | 0.014 | 0.021 | 0.007 | 0.010 | 0.092 | Conventional apparatus |
| 218 | Example | 0.609 | 0.261 | 0.078 | 0.014 | 0.021 | 0.007 | 0.010 | 0.092 | Elliptical water flow apparatus |
| 219 | Comparative Example | 0.616 | 0.264 | 0.071 | 0.013 | 0.019 | 0.006 | 0.010 | 0.084 | Conventional apparatus |
| 220 | Example | 0.616 | 0.264 | 0.071 | 0.013 | 0.019 | 0.006 | 0.010 | 0.084 | Elliptical water flow apparatus |
| 221 | Comparative Example | 0.623 | 0.267 | 0.065 | 0.012 | 0.018 | 0.006 | 0.010 | 0.076 | Conventional apparatus |
| 222 | Example | 0.623 | 0.267 | 0.065 | 0.012 | 0.018 | 0.006 | 0.010 | 0.076 | Elliptical water flow apparatus |
| 223 | Comparative Example | 0.630 | 0.270 | 0.058 | 0.011 | 0.016 | 0.005 | 0.010 | 0.069 | Conventional apparatus |
| 224 | Example | 0.630 | 0.270 | 0.058 | 0.011 | 0.016 | 0.005 | 0.010 | 0.069 | Elliptical water flow apparatus |
| 225 | Comparative Example | 0.637 | 0.273 | 0.052 | 0.009 | 0.014 | 0.005 | 0.010 | 0.061 | Conventional apparatus |
| 226 | Comparative Example | 0.637 | 0.273 | 0.052 | 0.009 | 0.014 | 0.005 | 0.010 | 0.061 | Elliptical water flow apparatus |

| | | | | | | Magnetic core (μ = 25) | | | | | | | |
|---|---|---|---|---|---|---|---|---|---|---|---|---|---|
| | Soft magnetic alloy powder | | | | | Manufacturing | | | | | | | |
| | Particle | | Circularity of | | | condition | Particle | | Circularity of | | Characteristics | | |
| | size | | large particles | | Ribbon | Molding | size | | large particles | | Packing | Core | |
| Sample | D50 | D90 | Average | Variance | Bs | pressure | D50 | D90 | Average | Variance | density | loss | Isat |
| No. | μm | μm | (—) | (—) | T | t/cm² | μm | μm | (—) | (—) | (—) | Ratio | Ratio |
| 199 | 8.1 | 19.0 | 0.71 | 0.041 | 1.56 | 12 | 10.5 | 27.3 | 0.61 | 0.052 | 76% | 1.00 | 1.00 |
| 200 | 8.1 | 18.5 | 0.94 | 0.035 | 1.56 | 4 | 9.8 | 26.1 | 0.78 | 0.042 | 74% | 0.57 | 1.09 |
| 201 | 8.3 | 16.7 | 0.71 | 0.044 | 1.59 | 12 | 10.0 | 23.1 | 0.58 | 0.054 | 76% | 1.00 | 1.00 |
| 202 | 7.7 | 18.4 | 0.94 | 0.018 | 1.59 | 4 | 9.6 | 25.4 | 0.94 | 0.020 | 74% | 0.61 | 1.12 |
| 203 | 7.4 | 17.1 | 0.70 | 0.044 | 1.63 | 12 | 9.0 | 23.1 | 0.63 | 0.052 | 76% | 1.00 | 1.00 |
| 204 | 7.7 | 17.1 | 0.94 | 0.010 | 1.63 | 4 | 9.3 | 24.1 | 0.95 | 0.016 | 74% | 0.54 | 1.20 |
| 205 | 8.4 | 17.0 | 0.71 | 0.044 | 1.66 | 12 | 10.8 | 24.5 | 0.60 | 0.053 | 76% | 1.00 | 1.00 |
| 206 | 8.0 | 16.9 | 0.94 | 0.006 | 1.66 | 4 | 10.3 | 23.2 | 0.94 | 0.010 | 74% | 0.55 | 1.24 |
| 207 | 7.7 | 19.0 | 0.71 | 0.043 | 1.70 | 12 | 9.8 | 27.5 | 0.61 | 0.052 | 76% | 1.00 | 1.00 |
| 208 | 8.2 | 16.7 | 0.93 | 0.004 | 1.70 | 4 | 9.9 | 24.0 | 0.93 | 0.004 | 74% | 0.56 | 1.27 |
| 209 | 8.0 | 18.9 | 0.71 | 0.043 | 1.74 | 12 | 9.7 | 27.3 | 0.62 | 0.052 | 76% | 1.00 | 1.00 |
| 210 | 7.5 | 19.1 | 0.93 | 0.004 | 1.74 | 4 | 9.1 | 26.4 | 0.93 | 0.004 | 74% | 0.61 | 1.26 |
| 211 | 7.7 | 17.2 | 0.71 | 0.043 | 1.77 | 12 | 9.6 | 23.6 | 0.58 | 0.054 | 76% | 1.00 | 1.00 |
| 212 | 8.1 | 17.3 | 0.94 | 0.004 | 1.77 | 4 | 10.2 | 23.6 | 0.95 | 0.004 | 74% | 0.59 | 1.28 |
| 213 | 8.1 | 17.8 | 0.71 | 0.043 | 1.81 | 12 | 10.3 | 25.0 | 0.64 | 0.051 | 76% | 1.00 | 1.00 |
| 214 | 7.7 | 18.8 | 0.94 | 0.004 | 1.81 | 4 | 9.6 | 26.1 | 0.94 | 0.004 | 74% | 0.55 | 1.32 |
| 215 | 7.2 | 16.7 | 0.71 | 0.043 | 1.84 | 12 | 9.3 | 23.4 | 0.63 | 0.051 | 76% | 1.00 | 1.00 |
| 216 | 8.4 | 17.2 | 0.93 | 0.010 | 1.84 | 4 | 10.4 | 23.7 | 0.94 | 0.010 | 74% | 0.65 | 1.31 |
| 217 | 7.2 | 17.7 | 0.71 | 0.042 | 1.88 | 12 | 9.2 | 24.6 | 0.59 | 0.053 | 76% | 1.00 | 1.00 |
| 218 | 8.5 | 18.4 | 0.95 | 0.010 | 1.88 | 4 | 10.7 | 25.4 | 0.95 | 0.015 | 74% | 0.68 | 1.32 |
| 219 | 7.3 | 17.6 | 0.71 | 0.045 | 1.91 | 12 | 8.8 | 24.4 | 0.58 | 0.054 | 76% | 1.00 | 1.00 |
| 220 | 7.2 | 17.4 | 0.95 | 0.022 | 1.91 | 4 | 9.0 | 24.8 | 0.94 | 0.025 | 74% | 0.75 | 1.34 |
| 221 | 7.8 | 17.1 | 0.70 | 0.043 | 1.95 | 12 | 9.4 | 23.7 | 0.92 | 0.005 | 76% | 1.00 | 1.00 |
| 222 | 8.3 | 19.0 | 0.94 | 0.028 | 1.95 | 4 | 10.0 | 26.5 | 0.92 | 0.030 | 74% | 0.80 | 1.23 |
| 223 | 7.5 | 17.1 | 0.70 | 0.043 | 1.99 | 12 | 9.4 | 23.5 | 0.63 | 0.052 | 76% | 1.00 | 1.00 |
| 224 | 7.6 | 17.0 | 0.94 | 0.030 | 1.99 | 4 | 9.3 | 23.2 | 0.94 | 0.033 | 74% | 0.85 | 1.12 |
| 225 | 7.6 | 17.8 | 0.71 | 0.041 | 2.02 | 12 | 9.6 | 24.3 | 0.58 | 0.054 | 76% | 1.00 | 1.00 |
| 226 | 7.3 | 18.3 | 0.94 | 0.040 | 2.02 | 4 | 9.1 | 25.3 | 0.78 | 0.057 | 74% | 1.00 | 1.01 |

*A = 1 − (a + b + c + d + e)

TABLE 9A

| | | Soft magnetic alloy powder | | | | | | | | | | |
|---|---|---|---|---|---|---|---|---|---|---|---|---|
| | | (Fe_{(1-α)}Co_{α})_{(1-γ)}X1_{γ})_{(1-(a+b+c+d+e))}BₐP_{b}Si_{c}C_{d}Crₑ (α = 0.300, β = 0) | | | | | | | | | | |
| | | Fe | Co | X1 | | | | | | | | |
| Sample | Comparative Example/ | (1 − α) × | α × | | Ele- | B | P | Si | C | Cr | B + P | Manufacturing condition |
| No. | Example | (1 − γ) × A | (1 − γ) × A | γ × A | ment | a | b | c | d | e | a + b | Atomizing apparatus |
| 227 | Comparative Example | 0.573 | 0.246 | 0.001 | Ti | 0.110 | 0.020 | 0.030 | 0.010 | 0.010 | 0.130 | Conventional apparatus |
| 228 | Example | 0.573 | 0.246 | 0.001 | Ti | 0.110 | 0.020 | 0.030 | 0.010 | 0.010 | 0.130 | Elliptical water flow apparatus |
| 229 | Comparative Example | 0.571 | 0.245 | 0.004 | Ti | 0.110 | 0.020 | 0.030 | 0.010 | 0.010 | 0.130 | Conventional apparatus |
| 230 | Example | 0.571 | 0.245 | 0.004 | Ti | 0.110 | 0.020 | 0.030 | 0.010 | 0.010 | 0.130 | Elliptical water flow apparatus |
| 231 | Comparative Example | 0.568 | 0.244 | 0.008 | Ti | 0.110 | 0.020 | 0.030 | 0.010 | 0.010 | 0.130 | Conventional apparatus |
| 232 | Example | 0.568 | 0.244 | 0.008 | Ti | 0.110 | 0.020 | 0.030 | 0.010 | 0.010 | 0.130 | Elliptical water flow apparatus |
| 233 | Comparative Example | 0.557 | 0.239 | 0.025 | Ti | 0.110 | 0.020 | 0.030 | 0.010 | 0.010 | 0.130 | Conventional apparatus |
| 234 | Example | 0.557 | 0.239 | 0.025 | Ti | 0.110 | 0.020 | 0.030 | 0.010 | 0.010 | 0.130 | Elliptical water flow apparatus |
| 235 | Comparative Example | 0.573 | 0.246 | 0.001 | Zr | 0.110 | 0.020 | 0.030 | 0.010 | 0.010 | 0.130 | Conventional apparatus |
| 236 | Example | 0.573 | 0.246 | 0.001 | Zr | 0.110 | 0.020 | 0.030 | 0.010 | 0.010 | 0.130 | Elliptical water flow apparatus |
| 237 | Comparative Example | 0.571 | 0.245 | 0.004 | Zr | 0.110 | 0.020 | 0.030 | 0.010 | 0.010 | 0.130 | Conventional apparatus |
| 238 | Example | 0.571 | 0.245 | 0.004 | Zr | 0.110 | 0.020 | 0.030 | 0.010 | 0.010 | 0.130 | Elliptical water flow apparatus |
| 239 | Comparative Example | 0.568 | 0.244 | 0.008 | Zr | 0.110 | 0.020 | 0.030 | 0.010 | 0.010 | 0.130 | Conventional apparatus |
| 240 | Example | 0.568 | 0.244 | 0.008 | Zr | 0.110 | 0.020 | 0.030 | 0.010 | 0.010 | 0.130 | Elliptical water flow apparatus |
| 241 | Comparative Example | 0.557 | 0.239 | 0.025 | Zr | 0.110 | 0.020 | 0.030 | 0.010 | 0.010 | 0.130 | Conventional apparatus |
| 242 | Example | 0.557 | 0.239 | 0.025 | Zr | 0.110 | 0.020 | 0.030 | 0.010 | 0.010 | 0.130 | Elliptical water flow apparatus |
| 243 | Comparative Example | 0.573 | 0.246 | 0.001 | Hf | 0.110 | 0.020 | 0.030 | 0.010 | 0.010 | 0.130 | Conventional apparatus |
| 244 | Example | 0.573 | 0.246 | 0.001 | Hf | 0.110 | 0.020 | 0.030 | 0.010 | 0.010 | 0.130 | Elliptical water flow apparatus |
| 245 | Comparative Example | 0.571 | 0.245 | 0.004 | Hf | 0.110 | 0.020 | 0.030 | 0.010 | 0.010 | 0.130 | Conventional apparatus |
| 246 | Example | 0.571 | 0.245 | 0.004 | Hf | 0.110 | 0.020 | 0.030 | 0.010 | 0.010 | 0.130 | Elliptical water flow apparatus |
| 247 | Comparative Example | 0.568 | 0.244 | 0.008 | Hf | 0.110 | 0.020 | 0.030 | 0.010 | 0.010 | 0.130 | Conventional apparatus |
| 248 | Example | 0.568 | 0.244 | 0.008 | Hf | 0.110 | 0.020 | 0.030 | 0.010 | 0.010 | 0.130 | Elliptical water flow apparatus |
| 249 | Comparative Example | 0.557 | 0.239 | 0.025 | Hf | 0.110 | 0.020 | 0.030 | 0.010 | 0.010 | 0.130 | Conven tional apparatus |
| 250 | Example | 0.557 | 0.239 | 0.025 | Hf | 0.110 | 0.020 | 0.030 | 0.010 | 0.010 | 0.130 | Elliptical water flow apparatus |
| 251 | Comparative Example | 0.573 | 0.246 | 0.001 | Nb | 0.110 | 0.020 | 0.030 | 0.010 | 0.010 | 0.130 | Conventional apparatus |
| 252 | Example | 0.573 | 0.246 | 0.001 | Nb | 0.110 | 0.020 | 0.030 | 0.010 | 0.010 | 0.130 | Elliptical water flow apparatus |
| 253 | Comparative Example | 0.571 | 0.245 | 0.004 | Nb | 0.110 | 0.020 | 0.030 | 0.010 | 0.010 | 0.130 | Conventional apparatus |
| 254 | Example | 0.571 | 0.245 | 0.004 | Nb | 0.110 | 0.020 | 0.030 | 0.010 | 0.010 | 0.130 | Elliptical water flow apparatus |
| 255 | Comparative Example | 0.568 | 0.244 | 0.008 | Nb | 0.110 | 0.020 | 0.030 | 0.010 | 0.010 | 0.130 | Conventional apparatus |
| 256 | Example | 0.568 | 0.244 | 0.008 | Nb | 0.110 | 0.020 | 0.030 | 0.010 | 0.010 | 0.130 | Elliptical water flow apparatus |
| 257 | Comparative Example | 0.557 | 0.239 | 0.025 | Nb | 0.110 | 0.020 | 0.030 | 0.010 | 0.010 | 0.130 | Conventional apparatus |
| 258 | Example | 0.557 | 0.239 | 0.025 | Nb | 0.110 | 0.020 | 0.030 | 0.010 | 0.010 | 0.130 | Elliptical water flow apparatus |

| | | | | | | Magnetic core (μ = 25) | | | | | | | |
|---|---|---|---|---|---|---|---|---|---|---|---|---|---|
| | Soft magnetic alloy powder | | | | | Manufacturing | | | | | | | |
| | Particle | | Circularity of | | | condition | Particle | | Circularity of | | Characteristics | | |
| | size | | large particles | | Ribbon | Molding | size | | large particles | | Packing | Core | |
| Sample | D50 | D90 | Average | Variance | Bs | pressure | D50 | D90 | Average | Variance | density | loss | Isat |
| No. | μm | μm | (—) | (—) | T | t/cm² | μm | μm | (—) | (—) | (—) | Ratio | Ratio |
| 227 | 7.4 | 18.8 | 0.71 | 0.043 | 1.70 | 12 | 9.0 | 25.9 | 0.61 | 0.052 | 76% | 1.00 | 1.00 |
| 228 | 7.5 | 17.2 | 0.93 | 0.004 | 1.70 | 4 | 9.6 | 24.0 | 0.93 | 0.004 | 74% | 0.57 | 1.27 |
| 229 | 7.5 | 17.6 | 0.70 | 0.045 | 1.70 | 12 | 9.0 | 24.5 | 0.58 | 0.053 | 76% | 1.00 | 1.00 |
| 230 | 7.2 | 16.7 | 0.93 | 0.004 | 1.70 | 4 | 9.2 | 22.7 | 0.94 | 0.004 | 74% | 0.61 | 1.23 |
| 231 | 7.8 | 18.4 | 0.70 | 0.044 | 1.70 | 12 | 10.1 | 26.3 | 0.62 | 0.052 | 76% | 1.00 | 1.00 |
| 232 | 8.2 | 17.3 | 0.94 | 0.004 | 1.70 | 4 | 10.3 | 24.6 | 0.95 | 0.004 | 74% | 0.60 | 1.19 |
| 233 | 7.9 | 18.0 | 0.70 | 0.045 | 1.68 | 12 | 10.2 | 24.4 | 0.57 | 0.054 | 76% | 1.00 | 1.00 |
| 234 | 7.6 | 19.0 | 0.93 | 0.004 | 1.68 | 4 | 9.7 | 26.8 | 0.93 | 0.004 | 74% | 0.56 | 1.15 |
| 235 | 8.3 | 17.1 | 0.71 | 0.045 | 1.70 | 12 | 10.7 | 24.4 | 0.59 | 0.054 | 76% | 1.00 | 1.00 |
| 236 | 7.7 | 18.4 | 0.94 | 0.004 | 1.70 | 4 | 9.3 | 25.1 | 0.94 | 0.004 | 74% | 0.57 | 1.26 |
| 237 | 7.4 | 19.1 | 0.71 | 0.041 | 1.70 | 12 | 9.4 | 27.3 | 0.61 | 0.053 | 76% | 1.00 | 1.00 |
| 238 | 7.9 | 17.9 | 0.95 | 0.004 | 1.70 | 4 | 9.7 | 25.0 | 0.95 | 0.004 | 74% | 0.56 | 1.22 |
| 239 | 8.1 | 18.7 | 0.71 | 0.042 | 1.70 | 12 | 10.2 | 26.5 | 0.60 | 0.053 | 76% | 1.00 | 1.00 |
| 240 | 8.1 | 18.0 | 0.93 | 0.004 | 1.70 | 4 | 10.0 | 25.8 | 0.94 | 0.004 | 74% | 0.57 | 1.18 |
| 241 | 7.6 | 19.2 | 0.71 | 0.044 | 1.68 | 12 | 9.3 | 26.1 | 0.61 | 0.053 | 76% | 1.00 | 1.00 |
| 242 | 7.6 | 17.8 | 0.94 | 0.004 | 1.68 | 4 | 9.4 | 25.2 | 0.94 | 0.004 | 74% | 0.61 | 1.15 |
| 243 | 8.1 | 19.3 | 0.70 | 0.044 | 1.70 | 12 | 10.1 | 26.1 | 0.59 | 0.054 | 76% | 1.00 | 1.00 |
| 244 | 7.0 | 16.7 | 0.93 | 0.004 | 1.70 | 4 | 8.6 | 23.3 | 0.94 | 0.004 | 74% | 0.55 | 1.25 |
| 245 | 7.9 | 17.1 | 0.70 | 0.045 | 1.70 | 12 | 10.1 | 24.2 | 0.59 | 0.053 | 76% | 1.00 | 1.00 |
| 246 | 7.2 | 19.2 | 0.94 | 0.004 | 1.70 | 4 | 9.4 | 26.7 | 0.94 | 0.004 | 74% | 0.60 | 1.21 |
| 247 | 7.2 | 17.1 | 0.70 | 0.044 | 1.70 | 12 | 9.4 | 24.6 | 0.63 | 0.051 | 76% | 1.00 | 1.00 |
| 248 | 7.6 | 19.0 | 0.94 | 0.004 | 1.70 | 4 | 9.6 | 27.0 | 0.94 | 0.004 | 74% | 0.56 | 1.17 |
| 249 | 7.0 | 19.2 | 0.71 | 0.044 | 1.68 | 12 | 8.6 | 26.9 | 0.58 | 0.053 | 76% | 1.00 | 1.00 |
| 250 | 8.0 | 16.9 | 0.93 | 0.004 | 1.68 | 4 | 10.0 | 24.4 | 0.94 | 0.004 | 74% | 0.59 | 1.14 |
| 251 | 8.0 | 18.3 | 0.71 | 0.042 | 1.70 | 12 | 9.7 | 25.9 | 0.59 | 0.053 | 76% | 1.00 | 1.00 |
| 252 | 8.4 | 16.5 | 0.95 | 0.004 | 1.70 | 4 | 10.5 | 22.4 | 0.95 | 0.004 | 74% | 0.58 | 1.27 |
| 253 | 7.5 | 17.6 | 0.72 | 0.042 | 1.70 | 12 | 9.3 | 24.7 | 0.64 | 0.051 | 75% | 1.00 | 1.00 |
| 254 | 7.5 | 17.6 | 0.93 | 0.004 | 1.70 | 4 | 9.7 | 24.4 | 0.93 | 0.004 | 74% | 0.57 | 1.23 |
| 255 | 8.1 | 19.0 | 0.71 | 0.043 | 1.69 | 12 | 9.9 | 27.4 | 0.59 | 0.053 | 76% | 1.00 | 1.00 |
| 256 | 8.5 | 19.4 | 0.94 | 0.004 | 1.69 | 4 | 10.3 | 27.7 | 0.95 | 0.004 | 74% | 0.56 | 1.19 |
| 257 | 7.5 | 17.6 | 0.71 | 0.042 | 1.68 | 12 | 9.6 | 25.3 | 0.58 | 0.054 | 76% | 1.00 | 1.00 |
| 258 | 7.0 | 19.0 | 0.93 | 0.004 | 1.68 | 4 | 8.9 | 27.3 | 0.93 | 0.004 | 74% | 0.57 | 1.15 |

*A = 1 − (a + b + c + d + e)

TABLE 9B

| | | Soft magnetic alloy powder | | | | | | | | | | |
|---|---|---|---|---|---|---|---|---|---|---|---|---|
| | | (Fe_{(1-α)}Co_{α})_{(1-γ)}X1_{γ})_{(1-(a+b+c+d+e))}BₐP_{b}Si_{c}C_{d}Crₑ (α = 0.300, β = 0) | | | | | | | | | | |
| | | Fe | Co | X1 | | | | | | | | |
| Sample | Comparative Example/ | (1 − α) × | α × | | Ele- | B | P | Si | C | Cr | B + P | Manufacturing condition |
| No. | Example | (1 − γ) × A | (1 − γ) × A | γ × A | ment | a | b | c | d | e | a + b | Atomizing apparatus |
| 259 | Comparative Example | 0.573 | 0.246 | 0.001 | Ta | 0.110 | 0.020 | 0.030 | 0.010 | 0.010 | 0.130 | Conventional apparatus |
| 260 | Example | 0.573 | 0.246 | 0.001 | Ta | 0.110 | 0.020 | 0.030 | 0.010 | 0.010 | 0.130 | Elliptical water flow apparatus |
| 261 | Comparative Example | 0.571 | 0.245 | 0.004 | Ta | 0.110 | 0.020 | 0.030 | 0.010 | 0.010 | 0.130 | Conventional apparatus |
| 262 | Example | 0.571 | 0.245 | 0.004 | Ta | 0.110 | 0.020 | 0.030 | 0.010 | 0.010 | 0.130 | Elliptical water flow apparatus |
| 263 | Comparative Example | 0.568 | 0.244 | 0.008 | Ta | 0.110 | 0.020 | 0.030 | 0.010 | 0.010 | 0.130 | Conventional apparatus |
| 264 | Example | 0.568 | 0.244 | 0.008 | Ta | 0.110 | 0.020 | 0.030 | 0.010 | 0.010 | 0.130 | Elliptical water flow apparatus |
| 265 | Comparative Example | 0.557 | 0.239 | 0.025 | Ta | 0.110 | 0.020 | 0.030 | 0.010 | 0.010 | 0.130 | Conventional apparatus |
| 266 | Example | 0.557 | 0.239 | 0.025 | Ta | 0.110 | 0.020 | 0.030 | 0.010 | 0.010 | 0.130 | Elliptical water flow apparatus |
| 267 | Comparative Example | 0.573 | 0.246 | 0.001 | Mo | 0.110 | 0.020 | 0.030 | 0.010 | 0.010 | 0.130 | Conventional apparatus |
| 268 | Example | 0.573 | 0.246 | 0.001 | Mo | 0.110 | 0.020 | 0.030 | 0.010 | 0.010 | 0.130 | Elliptical water flow apparatus |
| 269 | Comparative Example | 0.571 | 0.245 | 0.004 | Mo | 0.110 | 0.020 | 0.030 | 0.010 | 0.010 | 0.130 | Conventional apparatus |
| 270 | Example | 0.571 | 0.245 | 0.004 | Mo | 0.110 | 0.020 | 0.030 | 0.010 | 0.010 | 0.130 | Elliptical water flow apparatus |
| 271 | Comparative Example | 0.568 | 0.244 | 0.008 | Mo | 0.110 | 0.020 | 0.030 | 0.010 | 0.010 | 0.130 | Conventional apparatus |
| 272 | Example | 0.568 | 0.244 | 0.008 | Mo | 0.110 | 0.020 | 0.030 | 0.010 | 0.010 | 0.130 | Elliptical water flow apparatus |
| 273 | Comparative Example | 0.557 | 0.239 | 0.025 | Mo | 0.110 | 0.020 | 0.030 | 0.010 | 0.010 | 0.130 | Conventional apparatus |
| 274 | Example | 0.557 | 0.239 | 0.025 | Mo | 0.110 | 0.020 | 0.030 | 0.010 | 0.010 | 0.130 | Elliptical water flow apparatus |
| 275 | Comparative Example | 0.573 | 0.246 | 0.001 | W | 0.110 | 0.020 | 0.030 | 0.010 | 0.010 | 0.130 | Conventional apparatus |
| 276 | Example | 0.573 | 0.246 | 0.001 | W | 0.110 | 0.020 | 0.030 | 0.010 | 0.010 | 0.130 | Elliptical water flow apparatus |
| 277 | Comparative Example | 0.571 | 0.245 | 0.004 | W | 0.110 | 0.020 | 0.030 | 0.010 | 0.010 | 0.130 | Conventional apparatus |
| 278 | Example | 0.571 | 0.245 | 0.004 | W | 0.110 | 0.020 | 0.030 | 0.010 | 0.010 | 0.130 | Elliptical water flow apparatus |
| 279 | Comparative Example | 0.568 | 0.244 | 0.008 | W | 0.110 | 0.020 | 0.030 | 0.010 | 0.010 | 0.130 | Conventional apparatus |
| 280 | Example | 0.568 | 0.244 | 0.008 | W | 0.110 | 0.020 | 0.030 | 0.010 | 0.010 | 0.130 | Elliptical water flow apparatus |
| 281 | Comparative Example | 0.557 | 0.239 | 0.025 | W | 0.110 | 0.020 | 0.030 | 0.010 | 0.010 | 0.130 | Conventional apparatus |
| 282 | Example | 0.557 | 0.239 | 0.025 | W | 0.110 | 0.020 | 0.030 | 0.010 | 0.010 | 0.130 | Elliptical water flow apparatus |
| 283 | Comparative Example | 0.573 | 0.246 | 0.001 | Al | 0.110 | 0.020 | 0.030 | 0.010 | 0.010 | 0.130 | Conventional apparatus |
| 284 | Example | 0.573 | 0.246 | 0.001 | Al | 0.110 | 0.020 | 0.030 | 0.010 | 0.010 | 0.130 | Elliptical water flow apparatus |
| 285 | Comparative Example | 0.571 | 0.245 | 0.004 | Al | 0.110 | 0.020 | 0.030 | 0.010 | 0.010 | 0.130 | Conventional apparatus |
| 286 | Example | 0.571 | 0.245 | 0.004 | Al | 0.110 | 0.020 | 0.030 | 0.010 | 0.010 | 0.130 | Elliptical water flow apparatus |
| 287 | Comparative Example | 0.568 | 0.244 | 0.008 | Al | 0.110 | 0.020 | 0.030 | 0.010 | 0.010 | 0.130 | Conventional apparatus |
| 288 | Example | 0.568 | 0.244 | 0.008 | Al | 0.110 | 0.020 | 0.030 | 0.010 | 0.010 | 0.130 | Elliptical water flow apparatus |
| 289 | Comparative Example | 0.557 | 0.239 | 0.025 | Al | 0.110 | 0.020 | 0.030 | 0.010 | 0.010 | 0.130 | Conventional apparatus |
| 290 | Example | 0.557 | 0.239 | 0.025 | Al | 0.110 | 0.020 | 0.030 | 0.010 | 0.010 | 0.130 | Elliptical water flow apparatus |

| | | | | | | Magnetic core (μ = 25) | | | | | | | |
|---|---|---|---|---|---|---|---|---|---|---|---|---|---|
| | Soft magnetic alloy powder | | | | | Manufacturing | | | | | | | |
| | Particle | | Circularity of | | | condition | Particle | | Circularity of | | Characteristics | | |
| | size | | large particles | | Ribbon | Molding | size | | large particles | | Packing | Core | |
| Sample | D50 | D90 | Average | Variance | Bs | pressure | D50 | D90 | Average | Variance | density | loss | Isat |
| No. | μm | μm | (—) | (—) | T | t/cm² | μm | μm | (—) | (—) | (—) | Ratio | Ratio |
| 259 | 7.2 | 17.5 | 0.70 | 0.044 | 1.70 | 12 | 8.9 | 24.7 | 0.62 | 0.052 | 76% | 1.00 | 1.00 |
| 260 | 8.3 | 18.2 | 0.94 | 0.004 | 1.70 | 4 | 10.1 | 24.9 | 0.94 | 0.004 | 74% | 0.59 | 1.25 |
| 261 | 8.1 | 16.8 | 0.70 | 0.044 | 1.70 | 12 | 9.7 | 22.7 | 0.60 | 0.053 | 76% | 1.00 | 1.00 |
| 262 | 7.9 | 19.1 | 0.94 | 0.004 | 1.70 | 4 | 10.2 | 27.5 | 0.95 | 0.004 | 74% | 0.58 | 1.22 |
| 263 | 7.5 | 17.3 | 0.71 | 0.041 | 1.69 | 12 | 9.5 | 24.6 | 0.58 | 0.054 | 76% | 1.00 | 1.00 |
| 264 | 8.4 | 16.8 | 0.95 | 0.004 | 1.69 | 4 | 10.6 | 23.4 | 0.94 | 0.004 | 74% | 0.57 | 1.18 |
| 265 | 7.5 | 18.2 | 0.71 | 0.042 | 1.68 | 12 | 9.4 | 25.7 | 0.58 | 0.054 | 76% | 1.00 | 1.00 |
| 266 | 7.4 | 17.4 | 0.93 | 0.004 | 1.68 | 4 | 9.0 | 24.0 | 0.93 | 0.004 | 74% | 0.62 | 1.14 |
| 267 | 8.2 | 18.2 | 0.71 | 0.041 | 1.70 | 12 | 10.0 | 26.0 | 0.60 | 0.053 | 76% | 1.00 | 1.00 |
| 268 | 7.9 | 17.6 | 0.95 | 0.004 | 1.70 | 4 | 9.6 | 24.2 | 0.95 | 0.003 | 74% | 0.57 | 1.27 |
| 269 | 8.1 | 16.8 | 0.71 | 0.042 | 1.70 | 12 | 10.5 | 23.8 | 0.58 | 0.054 | 76% | 1.00 | 3.00 |
| 270 | 8.1 | 17.5 | 0.94 | 0.004 | 1.70 | 4 | 10.6 | 24.7 | 0.94 | 0.004 | 74% | 0.62 | 1.23 |
| 271 | 7.5 | 17.2 | 0.71 | 0.042 | 1.69 | 12 | 9.6 | 23.7 | 0.63 | 0.051 | 76% | 1.00 | 1.00 |
| 272 | 7.9 | 19.2 | 0.94 | 0.004 | 1.69 | 4 | 9.6 | 25.9 | 0.94 | 0.004 | 74% | 0.58 | 1.19 |
| 273 | 8.0 | 18.7 | 0.71 | 0.043 | 1.67 | 12 | 10.2 | 26.8 | 0.63 | 0.051 | 76% | 1.00 | 1.00 |
| 274 | 8.1 | 17.9 | 0.94 | 0.004 | 1.67 | 4 | 10.1 | 25.5 | 0.94 | 0.004 | 74% | 0.54 | 1.15 |
| 275 | 7.4 | 18.9 | 0.71 | 0.043 | 1.70 | 12 | 9.4 | 26.4 | 0.62 | 0.052 | 76% | 1.00 | 1.00 |
| 276 | 8.5 | 16.7 | 0.95 | 0.004 | 1.70 | 4 | 10.3 | 23.1 | 0.95 | 0.004 | 74% | 0.53 | 1.26 |
| 277 | 8.1 | 19.0 | 0.71 | 0.044 | 1.70 | 12 | 10.3 | 27.5 | 0.63 | 0.051 | 76% | 1.00 | 1.00 |
| 278 | 7.2 | 16.6 | 0.93 | 0.004 | 1.70 | 4 | 8.7 | 23.1 | 0.94 | 0.004 | 74% | 0.57 | 1.22 |
| 279 | 7.9 | 18.8 | 0.71 | 0.042 | 1.69 | 12 | 10.0 | 26.1 | 0.64 | 0.051 | 76% | 1.00 | 1.00 |
| 280 | 7.9 | 16.7 | 0.93 | 0.004 | 1.69 | 4 | 9.8 | 22.8 | 0.94 | 0.004 | 74% | 0.57 | 1.18 |
| 281 | 7.9 | 16.7 | 0.71 | 0.045 | 1.67 | 12 | 9.8 | 23.7 | 0.58 | 0.054 | 76% | 1.00 | 1.00 |
| 282 | 8.3 | 19.5 | 0.94 | 0.004 | 1.67 | 4 | 10.2 | 26.7 | 0.94 | 0.004 | 74% | 0.57 | 1.14 |
| 283 | 8.2 | 17.7 | 0.71 | 0.045 | 1.70 | 12 | 10.3 | 25.4 | 0.61 | 0.052 | 76% | 1.00 | 1.00 |
| 284 | 7.9 | 19.3 | 0.94 | 0.004 | 1.70 | 4 | 9.9 | 27.6 | 0.93 | 0.004 | 74% | 0.58 | 1.25 |
| 285 | 8.0 | 19.2 | 0.70 | 0.044 | 1.68 | 12 | 10.3 | 27.8 | 0.62 | 0.052 | 76% | 1.00 | 1.00 |
| 286 | 8.5 | 18.6 | 0.94 | 0.004 | 1.68 | 4 | 10.2 | 25.3 | 0.95 | 0.003 | 74% | 0.58 | 1.21 |
| 287 | 8.3 | 18.9 | 0.72 | 0.042 | 1.66 | 12 | 10.0 | 26.1 | 0.64 | 0.050 | 75% | 1.00 | 1.00 |
| 288 | 7.8 | 18.6 | 0.94 | 0.004 | 1.66 | 4 | 9.8 | 25.5 | 0.94 | 0.004 | 74% | 0.58 | 1.18 |
| 289 | 7.5 | 16.7 | 0.71 | 0.043 | 1.60 | 12 | 9.2 | 24.2 | 0.62 | 0.052 | 76% | 1.00 | 1.00 |
| 290 | 7.7 | 19.2 | 0.95 | 0.004 | 1.60 | 4 | 9.6 | 26.3 | 0.95 | 0.004 | 74% | 0.55 | 1.14 |

*A = 1 − (a + b + c + d + e)

TABLE 9C

| | | Soft magnetic alloy powder | | | | | | | | | | |
|---|---|---|---|---|---|---|---|---|---|---|---|---|
| | | (Fe_{(1-α)}Co_{α})_{(1-γ)}X1_{γ})_{(1-(a+b+c+d+e))}BₐP_{b}Si_{c}C_{d}Crₑ (α = 0.300, β = 0) | | | | | | | | | | |
| | | Fe | Co | X1 | | | | | | | | |
| Sample | Comparative Example/ | (1 − α) × | α × | | Ele- | B | P | Si | C | Cr | B + P | Manufacturing condition |
| No. | Example | (1 − γ) × A | (1 − γ) × A | γ × A | ment | a | b | c | d | e | a + b | Atomizing apparatus |
| 291 | Comparative Example | 0.573 | 0.246 | 0.001 | Ga | 0.110 | 0.020 | 0.030 | 0.010 | 0.010 | 0.130 | Conventional apparatus |
| 292 | Example | 0.573 | 0.246 | 0.001 | Ga | 0.110 | 0.020 | 0.030 | 0.010 | 0.010 | 0.130 | Elliptical water flow apparatus |
| 293 | Comparative Example | 0.571 | 0.245 | 0.004 | Ga | 0.110 | 0.020 | 0.030 | 0.010 | 0.010 | 0.130 | Conventional apparatus |
| 294 | Example | 0.571 | 0.245 | 0.004 | Ga | 0.110 | 0.020 | 0.030 | 0.010 | 0.010 | 0.130 | Elliptical water flow apparatus |
| 295 | Comparative Example | 0.568 | 0.244 | 0.008 | Ga | 0.110 | 0.020 | 0.030 | 0.010 | 0.010 | 0.130 | Conventional apparatus |
| 296 | Example | 0.568 | 0.244 | 0.008 | Ga | 0.110 | 0.020 | 0.030 | 0.010 | 0.010 | 0.130 | Elliptical water flow apparatus |
| 297 | Comparative Example | 0.557 | 0.239 | 0.025 | Ga | 0.110 | 0.020 | 0.030 | 0.010 | 0.010 | 0.130 | Conventional apparatus |
| 298 | Example | 0.557 | 0.239 | 0.025 | Ga | 0.110 | 0.020 | 0.030 | 0.010 | 0.010 | 0.130 | Elliptical water flow apparatus |
| 299 | Comparative Example | 0.573 | 0.246 | 0.001 | Ag | 0.110 | 0.020 | 0.030 | 0.010 | 0.010 | 0.130 | Conventional apparatus |
| 300 | Example | 0.573 | 0.246 | 0.001 | Ag | 0.110 | 0.020 | 0.030 | 0.010 | 0.010 | 0.130 | Elliptical water flow apparatus |
| 301 | Comparative Example | 0.571 | 0.245 | 0.004 | Ag | 0.110 | 0.020 | 0.030 | 0.010 | 0.010 | 0.130 | Conventional apparatus |
| 302 | Example | 0.571 | 0.245 | 0.004 | Ag | 0.110 | 0.020 | 0.030 | 0.010 | 0.010 | 0.130 | Elliptical water flow apparatus |
| 303 | Comparative Example | 0.568 | 0.244 | 0.008 | Ag | 0.110 | 0.020 | 0.030 | 0.010 | 0.010 | 0.130 | Conventional apparatus |
| 304 | Example | 0.568 | 0.244 | 0.008 | Ag | 0.110 | 0.020 | 0.030 | 0.010 | 0.010 | 0.130 | Elliptical water flow apparatus |
| 305 | Comparative Example | 0.557 | 0.239 | 0.025 | Ag | 0.110 | 0.020 | 0.030 | 0.010 | 0.010 | 0.130 | Conventional apparatus |
| 306 | Example | 0.557 | 0.239 | 0.025 | Ag | 0.110 | 0.020 | 0.030 | 0.010 | 0.010 | 0.130 | Elliptical water flow apparatus |
| 307 | Comparative Example | 0.573 | 0.246 | 0.001 | Zn | 0.110 | 0.020 | 0.030 | 0.010 | 0.010 | 0.130 | Conventional apparatus |
| 308 | Example | 0.573 | 0.246 | 0.001 | Zn | 0.110 | 0.020 | 0.030 | 0.010 | 0.010 | 0.130 | Elliptical water flow apparatus |
| 309 | Comparative Example | 0.571 | 0.245 | 0.004 | Zn | 0.110 | 0.020 | 0.030 | 0.010 | 0.010 | 0.130 | Conventional apparatus |
| 310 | Example | 0.571 | 0.245 | 0.004 | Zn | 0.110 | 0.020 | 0.030 | 0.010 | 0.010 | 0.130 | Elliptical water flow apparatus |
| 311 | Comparative Example | 0.568 | 0.244 | 0.008 | Zn | 0.110 | 0.020 | 0.030 | 0.010 | 0.010 | 0.130 | Conventional apparatus |
| 312 | Example | 0.568 | 0.244 | 0.008 | Zn | 0.110 | 0.020 | 0.030 | 0.010 | 0.010 | 0.130 | Elliptical water flow apparatus |
| 313 | Comparative Example | 0.557 | 0.239 | 0.025 | Zn | 0.110 | 0.020 | 0.030 | 0.010 | 0.010 | 0.130 | Conventional apparatus |
| 314 | Example | 0.557 | 0.239 | 0.025 | Zn | 0.110 | 0.020 | 0.030 | 0.010 | 0.010 | 0.130 | Elliptical water flow apparatus |
| 315 | Comparative Example | 0.573 | 0.246 | 0.001 | S | 0.110 | 0.020 | 0.030 | 0.010 | 0.010 | 0.130 | Conventional apparatus |
| 316 | Example | 0.573 | 0.246 | 0.001 | S | 0.110 | 0.020 | 0.030 | 0.010 | 0.010 | 0.130 | Elliptical water flow apparatus |
| 317 | Comparative Example | 0.571 | 0.245 | 0.004 | S | 0.110 | 0.020 | 0.030 | 0.010 | 0.010 | 0.130 | Conventional apparatus |
| 318 | Example | 0.571 | 0.245 | 0.004 | S | 0.110 | 0.020 | 0.030 | 0.010 | 0.010 | 0.130 | Elliptical water flow apparatus |
| 319 | Comparative Example | 0.568 | 0.244 | 0.008 | S | 0.110 | 0.020 | 0.030 | 0.010 | 0.010 | 0.130 | Conventional apparatus |
| 320 | Example | 0.568 | 0.244 | 0.008 | S | 0.110 | 0.020 | 0.030 | 0.010 | 0.010 | 0.130 | Elliptical water flow apparatus |
| 321 | Comparative Example | 0.557 | 0.239 | 0.025 | S | 0.110 | 0.020 | 0.030 | 0.010 | 0.010 | 0.130 | Conventional apparatus |
| 322 | Example | 0.557 | 0.239 | 0.025 | S | 0.110 | 0.020 | 0.030 | 0.010 | 0.010 | 0.130 | Elliptical water flow apparatus |

| | | | | | | Magnetic core (μ = 25) | | | | | | | |
|---|---|---|---|---|---|---|---|---|---|---|---|---|---|
| | Soft magnetic alloy powder | | | | | Manufacturing | | | | | | | |
| | Particle | | Circularity of | | | condition | Particle | | Circularity of | | Characteristics | | |
| | size | | large particles | | Ribbon | Molding | size | | large particles | | Packing | Core | |
| Sample | D50 | D90 | Average | Variance | Bs | pressure | D50 | D90 | Average | Variance | density | loss | Isat |
| No. | μm | μm | (—) | (—) | T | t/cm² | μm | μm | (—) | (—) | (—) | Ratio | Ratio |
| 291 | 7.4 | 19.2 | 0.70 | 0.044 | 1.70 | 12 | 9.1 | 26.3 | 0.63 | 0.051 | 76% | 1.00 | 1.00 |
| 292 | 7.5 | 16.8 | 0.94 | 0.004 | 1.70 | 4 | 9.0 | 23.0 | 0.94 | 0.004 | 74% | 0.60 | 1.24 |
| 293 | 7.7 | 18.3 | 0.71 | 0.043 | 1.68 | 12 | 9.9 | 24.7 | 0.63 | 0.051 | 76% | 1.00 | 1.00 |
| 294 | 7.5 | 18.3 | 0.94 | 0.004 | 1.68 | 4 | 9.1 | 26.4 | 0.94 | 0.004 | 74% | 0.58 | 1.20 |
| 295 | 7.6 | 17.5 | 0.71 | 0.042 | 1.66 | 12 | 9.7 | 25.4 | 0.62 | 0.052 | 76% | 1.00 | 1.00 |
| 296 | 7.3 | 18.8 | 0.94 | 0.004 | 1.66 | 4 | 8.9 | 26.0 | 0.95 | 0.004 | 74% | 0.59 | 1.17 |
| 297 | 7.5 | 16.6 | 0.71 | 0.042 | 1.60 | 12 | 9.3 | 23.8 | 0.60 | 0.053 | 76% | 1.00 | 1.00 |
| 298 | 7.8 | 18.9 | 0.94 | 0.004 | 1.60 | 4 | 9.8 | 26.6 | 0.94 | 0.004 | 74% | 0.59 | 1.14 |
| 299 | 8.4 | 18.4 | 0.71 | 0.045 | 1.70 | 12 | 10.0 | 25.3 | 0.59 | 0.054 | 76% | 1.00 | 1.00 |
| 300 | 7.5 | 17.1 | 0.95 | 0.004 | 1.70 | 4 | 9.2 | 24.5 | 0.95 | 0.004 | 74% | 0.57 | 1.25 |
| 301 | 7.2 | 17.4 | 0.72 | 0.042 | 1.69 | 12 | 8.9 | 24.3 | 0.60 | 0.053 | 75% | 1.00 | 1.00 |
| 302 | 7.4 | 17.8 | 0.95 | 0.004 | 1.69 | 4 | 9.1 | 25.5 | 0.94 | 0.004 | 74% | 0.58 | 1.21 |
| 303 | 7.8 | 16.6 | 0.70 | 0.044 | 1.67 | 12 | 9.5 | 22.9 | 0.63 | 0.051 | 76% | 1.00 | 1.00 |
| 304 | 7.4 | 17.8 | 0.93 | 0.004 | 1.67 | 4 | 9.1 | 25.2 | 0.94 | 0.004 | 74% | 0.59 | 1.18 |
| 305 | 7.4 | 18.3 | 0.71 | 0.044 | 1.61 | 12 | 8.9 | 26.2 | 0.62 | 0.052 | 76% | 1.00 | 1.00 |
| 306 | 7.4 | 18.2 | 0.93 | 0.004 | 1.61 | 4 | 9.1 | 25.7 | 0.94 | 0.004 | 74% | 0.55 | 1.14 |
| 307 | 8.1 | 19.2 | 0.71 | 0.043 | 1.70 | 12 | 10.2 | 26.7 | 0.62 | 0.052 | 76% | 1.00 | 1.00 |
| 308 | 8.1 | 18.8 | 0.95 | 0.004 | 1.70 | 4 | 10.1 | 26.4 | 0.94 | 0.004 | 74% | 0.57 | 1.24 |
| 309 | 7.7 | 17.4 | 0.71 | 0.041 | 1.68 | 12 | 9.3 | 25.2 | 0.58 | 0.054 | 76% | 1.00 | 1.00 |
| 310 | 7.6 | 17.0 | 0.93 | 0.004 | 1.68 | 4 | 9.5 | 23.7 | 0.94 | 0.004 | 74% | 0.57 | 1.21 |
| 311 | 7.1 | 19.3 | 0.71 | 0.042 | 1.67 | 12 | 8.9 | 27.6 | 0.60 | 0.053 | 76% | 1.00 | 1.00 |
| 312 | 7.8 | 18.6 | 0.94 | 0.004 | 1.67 | 4 | 9.4 | 25.2 | 0.94 | 0.004 | 74% | 0.57 | 1.17 |
| 313 | 8.3 | 19.0 | 0.71 | 0.043 | 1.60 | 12 | 10.6 | 27.6 | 0.62 | 0.052 | 76% | 1.00 | 1.00 |
| 314 | 8.3 | 18.4 | 0.94 | 0.004 | 1.60 | 4 | 10.0 | 26.5 | 0.94 | 0.004 | 74% | 0.54 | 1.14 |
| 315 | 7.6 | 16.8 | 0.71 | 0.045 | 1.70 | 12 | 9.7 | 23.6 | 0.60 | 0.053 | 76% | 1.00 | 1.00 |
| 316 | 8.4 | 16.8 | 0.94 | 0.004 | 1.70 | 4 | 10.2 | 22.7 | 0.93 | 0.004 | 74% | 0.61 | 1.25 |
| 317 | 8.0 | 19.4 | 0.71 | 0.044 | 1.69 | 12 | 10.2 | 26.8 | 0.61 | 0.053 | 76% | 1.00 | 1.00 |
| 318 | 7.1 | 16.6 | 0.94 | 0.004 | 1.69 | 4 | 8.7 | 22.4 | 0.94 | 0.004 | 74% | 0.53 | 1.21 |
| 319 | 8.1 | 18.9 | 0.71 | 0.044 | 1.68 | 12 | 9.8 | 25.9 | 0.58 | 0.054 | 76% | 1.00 | 1.00 |
| 320 | 8.4 | 17.6 | 0.94 | 0.004 | 1.68 | 4 | 10.3 | 23.9 | 0.95 | 0.004 | 74% | 0.61 | 1.18 |
| 321 | 7.7 | 18.9 | 0.71 | 0.042 | 1.64 | 12 | 9.4 | 26.6 | 0.61 | 0.052 | 76% | 1.00 | 1.00 |
| 322 | 7.4 | 18.7 | 0.94 | 0.004 | 1.64 | 4 | 9.2 | 26.4 | 0.94 | 0.004 | 74% | 0.58 | 1.14 |

*A = 1 − (a + b + c + d + e)

TABLE 9D

| | | Soft magnetic alloy powder | | | | | | | | | | |
|---|---|---|---|---|---|---|---|---|---|---|---|---|
| | | (Fe_{(1-α)}Co_{α})_{(1-γ)}X1_{γ})_{(1-(a+b+c+d+e))}BₐP_{b}Si_{c}C_{d}Crₑ (α = 0.300, β = 0) | | | | | | | | | | |
| | | Fe | Co | X1 | | | | | | | | |
| Sample | Comparative Example/ | (1 − α) × | α × | | Ele- | B | P | Si | C | Cr | B + P | Manufacturing condition |
| No. | Example | (1 − γ) × A | (1 − γ) × A | γ × A | ment | a | b | c | d | e | a + b | Atomizing apparatus |
| 323 | Comparative Example | 0.573 | 0.246 | 0.001 | Ca | 0.110 | 0.020 | 0.030 | 0.010 | 0.010 | 0.130 | Conventional apparatus |
| 324 | Example | 0.573 | 0.246 | 0.001 | Ca | 0.110 | 0.020 | 0.030 | 0.010 | 0.010 | 0.130 | Elliptical water flow apparatus |
| 325 | Comparative Example | 0.571 | 0.245 | 0.004 | Ca | 0.110 | 0.020 | 0.030 | 0.010 | 0.010 | 0.130 | Conventional apparatus |
| 326 | Example | 0.571 | 0.245 | 0.004 | Ca | 0.110 | 0.020 | 0.030 | 0.010 | 0.010 | 0.130 | Elliptical water flow apparatus |
| 327 | Comparative Example | 0.568 | 0.244 | 0.008 | Ca | 0.110 | 0.020 | 0.030 | 0.010 | 0.010 | 0.130 | Conventional apparatus |
| 328 | Example | 0.568 | 0.244 | 0.008 | Ca | 0.110 | 0.020 | 0.030 | 0.010 | 0.010 | 0.130 | Elliptical water flow apparatus |
| 329 | Comparative Example | 0.557 | 0.239 | 0.025 | Ca | 0.110 | 0.020 | 0.030 | 0.010 | 0.010 | 0.130 | Conventional apparatus |
| 330 | Example | 0.557 | 0.239 | 0.025 | Ca | 0.110 | 0.020 | 0.030 | 0.010 | 0.010 | 0.130 | Elliptical water flow apparatus |
| 331 | Comparative Example | 0.573 | 0.246 | 0.001 | Mg | 0.110 | 0.020 | 0.030 | 0.010 | 0.010 | 0.130 | Conventional apparatus |
| 332 | Example | 0.573 | 0.246 | 0.001 | Mg | 0.110 | 0.020 | 0.030 | 0.010 | 0.010 | 0.130 | Elliptical water flow apparatus |
| 333 | Comparative Example | 0.571 | 0.245 | 0.004 | Mg | 0.110 | 0.020 | 0.030 | 0.010 | 0.010 | 0.130 | Conventional apparatus |
| 334 | Example | 0.571 | 0.245 | 0.004 | Mg | 0.110 | 0.020 | 0.030 | 0.010 | 0.010 | 0.130 | Elliptical water flow apparatus |
| 335 | Comparative Example | 0.568 | 0.244 | 0.008 | Mg | 0.110 | 0.020 | 0.030 | 0.010 | 0.010 | 0.130 | Conventional apparatus |
| 336 | Example | 0.568 | 0.244 | 0.008 | Mg | 0.110 | 0.020 | 0.030 | 0.010 | 0.010 | 0.130 | Elliptical water flow apparatus |
| 337 | Comparative Example | 0.557 | 0.239 | 0.025 | Mg | 0.110 | 0.020 | 0.030 | 0.010 | 0.010 | 0.130 | Conventional apparatus |
| 338 | Example | 0.557 | 0.239 | 0.025 | Mg | 0.110 | 0.020 | 0.030 | 0.010 | 0.010 | 0.130 | Elliptical water flow apparatus |
| 339 | Comparative Example | 0.573 | 0.246 | 0.001 | V | 0.110 | 0.020 | 0.030 | 0.010 | 0.010 | 0.130 | Conventional apparatus |
| 340 | Example | 0.573 | 0.246 | 0.001 | V | 0.110 | 0.020 | 0.030 | 0.010 | 0.010 | 0.130 | Elliptical water flow apparatus |
| 341 | Comparative Example | 0.571 | 0.245 | 0.004 | V | 0.110 | 0.020 | 0.030 | 0.010 | 0.010 | 0.130 | Conventional apparatus |
| 342 | Example | 0.571 | 0.245 | 0.004 | V | 0.110 | 0.020 | 0.030 | 0.010 | 0.010 | 0.130 | Elliptical water flow apparatus |
| 343 | Comparative Example | 0.568 | 0.244 | 0.008 | V | 0.110 | 0.020 | 0.030 | 0.010 | 0.010 | 0.130 | Conventional apparatus |
| 344 | Example | 0.568 | 0.244 | 0.008 | V | 0.110 | 0.020 | 0.030 | 0.010 | 0.010 | 0.130 | Elliptical water flow apparatus |
| 345 | Comparative Example | 0.557 | 0.239 | 0.025 | V | 0.110 | 0.020 | 0.030 | 0.010 | 0.010 | 0.130 | Conventional apparatus |
| 346 | Example | 0.557 | 0.239 | 0.025 | V | 0.110 | 0.020 | 0.030 | 0.010 | 0.010 | 0.130 | Elliptical water flow apparatus |
| 347 | Comparative Example | 0.573 | 0.246 | 0.001 | Sn | 0.110 | 0.020 | 0.030 | 0.010 | 0.010 | 0.130 | Conventional apparatus |
| 348 | Example | 0.573 | 0.246 | 0.001 | Sn | 0.110 | 0.020 | 0.030 | 0.010 | 0.010 | 0.130 | Elliptical water flow apparatus |
| 349 | Comparative Example | 0.571 | 0.245 | 0.004 | Sn | 0.110 | 0.020 | 0.030 | 0.010 | 0.010 | 0.130 | Conventional apparatus |
| 350 | Example | 0.571 | 0.245 | 0.004 | Sn | 0.110 | 0.020 | 0.030 | 0.010 | 0.010 | 0.130 | Elliptical water flow apparatus |
| 351 | Comparative Example | 0.568 | 0.244 | 0.008 | Sn | 0.110 | 0.020 | 0.030 | 0.010 | 0.010 | 0.130 | Conventional apparatus |
| 352 | Example | 0.568 | 0.244 | 0.008 | Sn | 0.110 | 0.020 | 0.030 | 0.010 | 0.010 | 0.130 | Elliptical water flow apparatus |
| 353 | Comparative Example | 0.557 | 0.239 | 0.025 | Sn | 0.110 | 0.020 | 0.030 | 0.010 | 0.010 | 0.130 | Conventional apparatus |
| 354 | Example | 0.557 | 0.239 | 0.025 | Sn | 0.110 | 0.020 | 0.030 | 0.010 | 0.010 | 0.130 | Elliptical water flow apparatus |

| | | | | | | Magnetic core (μ = 25) | | | | | | | |
|---|---|---|---|---|---|---|---|---|---|---|---|---|---|
| | Soft magnetic alloy powder | | | | | Manufacturing | | | | | | | |
| | Particle | | Circularity of | | | condition | Particle | | Circularity of | | Characteristics | | |
| | size | | large particles | | Ribbon | Molding | size | | large particles | | Packing | Core | |
| Sample | D50 | D90 | Average | Variance | Bs | pressure | D50 | D90 | Average | Variance | density | loss | Isat |
| No. | μm | μm | (—) | (—) | T | t/cm² | μm | μm | (—) | (—) | (—) | Ratio | Ratio |
| 323 | 7.3 | 18.8 | 0.71 | 0.044 | 1.70 | 12 | 8.8 | 27.0 | 0.59 | 0.054 | 76% | 1.00 | 1.00 |
| 324 | 7.8 | 19.0 | 0.94 | 0.004 | 1.70 | 4 | 9.8 | 27.4 | 0.95 | 0.003 | 74% | 0.57 | 1.26 |
| 325 | 7.6 | 18.0 | 0.71 | 0.042 | 1.70 | 12 | 9.4 | 25.0 | 0.57 | 0.054 | 76% | 1.00 | 1.00 |
| 326 | 8.3 | 17.1 | 0.93 | 0.004 | 1.70 | 4 | 10.0 | 23.6 | 0.93 | 0.004 | 74% | 0.59 | 1.22 |
| 327 | 7.4 | 16.6 | 0.70 | 0.043 | 1.71 | 12 | 9.5 | 22.7 | 0.61 | 0.053 | 76% | 1.00 | 1.00 |
| 328 | 8.1 | 17.2 | 0.93 | 0.004 | 1.71 | 4 | 9.8 | 24.6 | 0.94 | 0.004 | 74% | 0.55 | 1.18 |
| 329 | 7.1 | 18.7 | 0.71 | 0.045 | 1.66 | 12 | 8.6 | 26.1 | 0.62 | 0.052 | 76% | 1.00 | 1.00 |
| 330 | 8.3 | 17.3 | 0.94 | 0.004 | 1.66 | 4 | 10.6 | 24.1 | 0.94 | 0.004 | 74% | 0.54 | 1.15 |
| 331 | 8.1 | 18.2 | 0.71 | 0.043 | 1.70 | 12 | 10.4 | 25.7 | 0.63 | 0.051 | 76% | 1.00 | 1.00 |
| 332 | 8.2 | 18.6 | 0.93 | 0.004 | 1.70 | 4 | 10.1 | 25.6 | 0.94 | 0.004 | 74% | 0.58 | 1.26 |
| 333 | 7.8 | 18.3 | 0.71 | 0.045 | 1.70 | 12 | 10.0 | 25.2 | 0.64 | 0.051 | 76% | 1.00 | 1.00 |
| 334 | 7.3 | 16.8 | 0.94 | 0.004 | 1.70 | 4 | 8.8 | 24.3 | 0.94 | 0.004 | 74% | 0.54 | 1.23 |
| 335 | 8.3 | 17.4 | 0.71 | 0.045 | 1.71 | 12 | 10.3 | 23.8 | 0.61 | 0.053 | 76% | 1.00 | 1.00 |
| 336 | 7.3 | 19.0 | 0.95 | 0.004 | 1.71 | 4 | 8.9 | 27.4 | 0.94 | 0.004 | 74% | 0.59 | 1.18 |
| 337 | 8.3 | 17.3 | 0.71 | 0.041 | 1.66 | 12 | 10.0 | 23.4 | 0.58 | 0.054 | 76% | 1.00 | 1.00 |
| 338 | 7.2 | 17.2 | 0.94 | 0.004 | 1.66 | 4 | 8.6 | 23.6 | 0.94 | 0.004 | 74% | 0.58 | 1.15 |
| 339 | 8.4 | 16.8 | 0.71 | 0.045 | 1.70 | 12 | 10.2 | 23.3 | 0.63 | 0.052 | 76% | 1.00 | 1.00 |
| 340 | 8.3 | 17.7 | 0.95 | 0.004 | 1.70 | 4 | 10.0 | 24.2 | 0.95 | 0.004 | 74% | 0.55 | 1.25 |
| 341 | 7.6 | 16.9 | 0.71 | 0.044 | 1.70 | 12 | 9.8 | 23.6 | 0.63 | 0.052 | 76% | 1.00 | 1.00 |
| 342 | 8.0 | 18.2 | 0.94 | 0.004 | 1.70 | 4 | 10.2 | 25.3 | 0.93 | 0.004 | 74% | 0.59 | 1.21 |
| 343 | 8.2 | 17.3 | 0.72 | 0.043 | 1.69 | 12 | 10.3 | 24.8 | 0.61 | 0.053 | 75% | 1.00 | 1.00 |
| 344 | 8.2 | 16.9 | 0.94 | 0.004 | 1.69 | 4 | 10.4 | 23.9 | 0.94 | 0.004 | 74% | 0.57 | 1.18 |
| 345 | 7.8 | 16.7 | 0.71 | 0.042 | 1.68 | 12 | 9.7 | 23.1 | 0.60 | 0.053 | 76% | 1.00 | 1.00 |
| 346 | 7.7 | 18.8 | 0.94 | 0.004 | 1.68 | 4 | 9.8 | 25.9 | 0.94 | 0.004 | 74% | 0.58 | 1.14 |
| 347 | 7.2 | 18.8 | 0.71 | 0.043 | 1.70 | 12 | 9.1 | 27.2 | 0.58 | 0.054 | 76% | 1.00 | 1.00 |
| 348 | 8.2 | 18.0 | 0.93 | 0.004 | 1.70 | 4 | 10.6 | 25.8 | 0.94 | 0.004 | 74% | 0.53 | 1.23 |
| 349 | 8.3 | 16.7 | 0.71 | 0.044 | 1.68 | 12 | 10.4 | 24.1 | 0.62 | 0.052 | 76% | 1.00 | 1.00 |
| 350 | 8.1 | 18.6 | 0.93 | 0.004 | 1.68 | 4 | 10.4 | 25.4 | 0.94 | 0.004 | 74% | 0.60 | 1.20 |
| 351 | 8.1 | 17.4 | 0.72 | 0.042 | 1.66 | 12 | 10.2 | 23.6 | 0.62 | 0.052 | 75% | 1.00 | 1.00 |
| 352 | 8.5 | 18.4 | 0.95 | 0.004 | 1.66 | 4 | 11.0 | 24.9 | 0.95 | 0.004 | 74% | 0.55 | 1.16 |
| 353 | 7.9 | 18.3 | 0.70 | 0.045 | 1.57 | 12 | 9.6 | 25.6 | 0.62 | 0.052 | 76% | 1.00 | 1.00 |
| 354 | 7.8 | 17.1 | 0.94 | 0.004 | 1.57 | 4 | 9.8 | 24.7 | 0.94 | 0.004 | 74% | 0.58 | 1.11 |

*A = 1 − (a + b + c + d + e)

TABLE 9E

| | | Soft magnetic alloy powder | | | | | | | | | | |
|---|---|---|---|---|---|---|---|---|---|---|---|---|
| | | (Fe_{(1-α)}Co_{α})_{(1-γ)}X1_{γ})_{(1-(a+b+c+d+e))}BₐP_{b}Si_{c}C_{d}Crₑ (α = 0.300, β = 0) | | | | | | | | | | |
| | | Fe | Co | X1 | | | | | | | | |
| Sample | Comparative Example/ | (1 − α) × | α × | | Ele- | B | P | Si | C | Cr | B + P | Manufacturing condition |
| No. | Example | (1 − γ) × A | (1 − γ) × A | γ × A | ment | a | b | c | d | e | a + b | Atomizing apparatus |
| 355 | Comparative Example | 0.573 | 0.246 | 0.001 | As | 0.110 | 0.020 | 0.030 | 0.010 | 0.010 | 0.130 | Conventional apparatus |
| 356 | Example | 0.573 | 0.246 | 0.001 | As | 0.110 | 0.020 | 0.030 | 0.010 | 0.010 | 0.130 | Elliptical water flow apparatus |
| 357 | Comparative Example | 0.571 | 0.245 | 0.004 | As | 0.110 | 0.020 | 0.030 | 0.010 | 0.010 | 0.130 | Conventional apparatus |
| 358 | Example | 0.571 | 0.245 | 0.004 | As | 0.110 | 0.020 | 0.030 | 0.010 | 0.010 | 0.130 | Elliptical water flow apparatus |
| 359 | Comparative Example | 0.568 | 0.244 | 0.008 | As | 0.110 | 0.020 | 0.030 | 0.010 | 0.010 | 0.130 | Conventional apparatus |
| 360 | Example | 0.568 | 0.244 | 0.008 | As | 0.110 | 0.020 | 0.030 | 0.010 | 0.010 | 0.130 | Elliptical water flow apparatus |
| 361 | Comparative Example | 0.557 | 0.239 | 0.025 | As | 0.110 | 0.020 | 0.030 | 0.010 | 0.010 | 0.130 | Conventional apparatus |
| 362 | Example | 0.557 | 0.239 | 0.025 | As | 0.110 | 0.020 | 0.030 | 0.010 | 0.010 | 0.130 | Elliptical water flow apparatus |
| 363 | Comparative Example | 0.573 | 0.246 | 0.001 | Sb | 0.110 | 0.020 | 0.030 | 0.010 | 0.010 | 0.130 | Conventional apparatus |
| 364 | Example | 0.573 | 0.246 | 0.001 | Sb | 0.110 | 0.020 | 0.030 | 0.010 | 0.010 | 0.130 | Elliptical water flow apparatus |
| 365 | Comparative Example | 0.571 | 0.245 | 0.004 | Sb | 0.110 | 0.020 | 0.030 | 0.010 | 0.010 | 0.130 | Conventional apparatus |
| 366 | Example | 0.571 | 0.245 | 0.004 | Sb | 0.110 | 0.020 | 0.030 | 0.010 | 0.010 | 0.130 | Elliptical water flow apparatus |
| 367 | Comparative Example | 0.568 | 0.244 | 0.008 | Sb | 0.110 | 0.020 | 0.030 | 0.010 | 0.010 | 0.130 | Conventional apparatus |
| 368 | Example | 0.568 | 0.244 | 0.008 | Sb | 0.110 | 0.020 | 0.030 | 0.010 | 0.010 | 0.130 | Elliptical water flow apparatus |
| 369 | Comparative Example | 0.557 | 0.239 | 0.025 | Sb | 0.110 | 0.020 | 0.030 | 0.010 | 0.010 | 0.130 | Conventional apparatus |
| 370 | Example | 0.557 | 0.239 | 0.025 | Sb | 0.110 | 0.020 | 0.030 | 0.010 | 0.010 | 0.130 | Elliptical water flow apparatus |
| 371 | Comparative Example | 0.573 | 0.246 | 0.001 | Bi | 0.110 | 0.020 | 0.030 | 0.010 | 0.010 | 0.130 | Conventional apparatus |
| 372 | Example | 0.573 | 0.246 | 0.001 | Bi | 0.110 | 0.020 | 0.030 | 0.010 | 0.010 | 0.130 | Elliptical water flow apparatus |
| 373 | Comparative Example | 0.571 | 0.245 | 0.004 | Bi | 0.110 | 0.020 | 0.030 | 0.010 | 0.010 | 0.130 | Conventional apparatus |
| 374 | Example | 0.571 | 0.245 | 0.004 | Bi | 0.110 | 0.020 | 0.030 | 0.010 | 0.010 | 0.130 | Elliptical water flow apparatus |
| 375 | Comparative Example | 0.568 | 0.244 | 0.008 | Bi | 0.110 | 0.020 | 0.030 | 0.010 | 0.010 | 0.130 | Conventional apparatus |
| 376 | Example | 0.568 | 0.244 | 0.008 | Bi | 0.110 | 0.020 | 0.030 | 0.010 | 0.010 | 0.130 | Elliptical water flow apparatus |
| 377 | Comparative Example | 0.557 | 0.239 | 0.025 | Bi | 0.110 | 0.020 | 0.030 | 0.010 | 0.010 | 0.130 | Conventional apparatus |
| 378 | Example | 0.557 | 0.239 | 0.025 | Bi | 0.110 | 0.020 | 0.030 | 0.010 | 0.010 | 0.130 | Elliptical water flow apparatus |
| 379 | Comparative Example | 0.573 | 0.246 | 0.001 | N | 0.110 | 0.020 | 0.030 | 0.010 | 0.010 | 0.130 | Conventional apparatus |
| 380 | Example | 0.573 | 0.246 | 0.001 | N | 0.110 | 0.020 | 0.030 | 0.010 | 0.010 | 0.130 | Elliptical water flow apparatus |
| 381 | Comparative Example | 0.571 | 0.245 | 0.004 | N | 0.110 | 0.020 | 0.030 | 0.010 | 0.010 | 0.130 | Conventional apparatus |
| 382 | Example | 0.571 | 0.245 | 0.004 | N | 0.110 | 0.020 | 0.030 | 0.010 | 0.010 | 0.130 | Elliptical water flow apparatus |
| 383 | Comparative Example | 0.568 | 0.244 | 0.008 | N | 0.110 | 0.020 | 0.030 | 0.010 | 0.010 | 0.130 | Conventional apparatus |
| 384 | Example | 0.568 | 0.244 | 0.008 | N | 0.110 | 0.020 | 0.030 | 0.010 | 0.010 | 0.130 | Elliptical water flow apparatus |
| 385 | Comparative Example | 0.557 | 0.239 | 0.025 | N | 0.110 | 0.020 | 0.030 | 0.010 | 0.010 | 0.130 | Conventional apparatus |
| 386 | Example | 0.557 | 0.239 | 0.025 | N | 0.110 | 0.020 | 0.030 | 0.010 | 0.010 | 0.130 | Elliptical water flow apparatus |

| | | | | | | Magnetic core (μ = 25) | | | | | | | |
|---|---|---|---|---|---|---|---|---|---|---|---|---|---|
| | Soft magnetic alloy powder | | | | | Manufacturing | | | | | | | |
| | Particle | | Circularity of | | | condition | Particle | | Circularity of | | Characteristics | | |
| | size | | large particles | | Ribbon | Molding | size | | large particles | | Packing | Core | |
| Sample | D50 | D90 | Average | Variance | Bs | pressure | D50 | D90 | Average | Variance | density | loss | Isat |
| No. | μm | μm | (—) | (—) | T | t/cm² | μm | μm | (—) | (—) | (—) | Ratio | Ratio |
| 355 | 7.6 | 18.4 | 0.71 | 0.042 | 1.70 | 12 | 9.2 | 25.0 | 0.58 | 0.054 | 76% | 1.00 | 1.00 |
| 356 | 7.4 | 18.1 | 0.94 | 0.004 | 1.70 | 4 | 8.9 | 24.9 | 0.95 | 0.004 | 74% | 0.58 | 1.23 |
| 357 | 7.9 | 17.2 | 0.71 | 0.045 | 1.69 | 12 | 10.1 | 23.6 | 0.60 | 0.053 | 76% | 1.00 | 1.00 |
| 358 | 8.4 | 18.7 | 0.95 | 0.004 | 1.69 | 4 | 10.4 | 26.7 | 0.95 | 0.004 | 74% | 0.57 | 1.20 |
| 359 | 7.7 | 17.0 | 0.70 | 0.043 | 1.68 | 12 | 9.4 | 24.0 | 0.60 | 0.053 | 76% | 1.00 | 1.00 |
| 360 | 7.3 | 18.0 | 0.93 | 0.004 | 1.68 | 4 | 9.0 | 25.2 | 0.94 | 0.004 | 74% | 0.59 | 1.16 |
| 361 | 7.8 | 19.2 | 0.71 | 0.041 | 1.64 | 12 | 9.8 | 26.3 | 0.58 | 0.053 | 76% | 1.00 | 1.00 |
| 362 | 7.5 | 17.7 | 0.95 | 0.004 | 1.64 | 4 | 9.1 | 24.5 | 0.95 | 0.004 | 74% | 0.58 | 1.13 |
| 363 | 8.0 | 16.6 | 0.72 | 0.041 | 1.70 | 12 | 10.4 | 22.9 | 0.61 | 0.052 | 75% | 1.00 | 1.00 |
| 364 | 8.3 | 19.1 | 0.94 | 0.004 | 1.70 | 4 | 10.0 | 26.1 | 0.95 | 0.004 | 74% | 0.57 | 1.24 |
| 365 | 7.1 | 18.3 | 0.71 | 0.042 | 1.68 | 12 | 9.2 | 25.8 | 0.61 | 0.052 | 76% | 1.00 | 1.00 |
| 366 | 7.9 | 17.8 | 0.94 | 0.004 | 1.68 | 4 | 10.1 | 24.1 | 0.95 | 0.004 | 74% | 0.58 | 1.21 |
| 367 | 8.2 | 17.1 | 0.72 | 0.043 | 1.66 | 12 | 10.2 | 24.7 | 0.63 | 0.052 | 75% | 1.00 | 1.00 |
| 368 | 7.6 | 18.6 | 0.94 | 0.004 | 1.66 | 4 | 9.4 | 25.7 | 0.94 | 0.004 | 74% | 0.55 | 1.17 |
| 369 | 8.2 | 18.9 | 0.71 | 0.044 | 1.60 | 12 | 9.9 | 26.3 | 0.61 | 0.052 | 76% | 1.00 | 1.00 |
| 370 | 8.3 | 17.1 | 0.93 | 0.004 | 1.60 | 4 | 10.5 | 23.1 | 0.93 | 0.004 | 74% | 0.56 | 1.14 |
| 371 | 8.3 | 18.1 | 0.70 | 0.043 | 1.70 | 12 | 10.4 | 26.0 | 0.58 | 0.053 | 76% | 1.00 | 1.00 |
| 372 | 7.7 | 18.9 | 0.93 | 0.004 | 1.70 | 4 | 10.0 | 26.1 | 0.93 | 0.004 | 74% | 0.57 | 1.24 |
| 373 | 7.0 | 17.9 | 0.71 | 0.044 | 1.68 | 12 | 8.5 | 25.6 | 0.58 | 0.054 | 76% | 1.00 | 1.00 |
| 374 | 8.4 | 19.3 | 0.94 | 0.004 | 1.68 | 4 | 10.9 | 27.7 | 0.95 | 0.004 | 74% | 0.57 | 1.20 |
| 375 | 7.2 | 16.6 | 0.71 | 0.043 | 1.66 | 12 | 8.9 | 23.8 | 0.58 | 0.054 | 76% | 1.00 | 1.00 |
| 376 | 8.0 | 18.4 | 0.95 | 0.004 | 1.66 | 4 | 10.2 | 25.3 | 0.96 | 0.003 | 74% | 0.61 | 1.16 |
| 377 | 7.8 | 17.3 | 0.71 | 0.044 | 1.56 | 12 | 9.7 | 23.7 | 0.62 | 0.052 | 76% | 1.00 | 1.00 |
| 378 | 7.4 | 17.3 | 0.95 | 0.004 | 1.56 | 4 | 9.3 | 23.8 | 0.95 | 0.003 | 74% | 0.59 | 1.13 |
| 379 | 7.4 | 18.4 | 0.70 | 0.044 | 1.70 | 12 | 9.1 | 25.1 | 0.57 | 0.054 | 76% | 1.00 | 1.00 |
| 380 | 7.7 | 18.8 | 0.95 | 0.004 | 1.70 | 4 | 9.6 | 26.5 | 0.95 | 0.004 | 74% | 0.55 | 1.25 |
| 381 | 7.2 | 19.1 | 0.72 | 0.042 | 1.69 | 12 | 8.6 | 27.3 | 0.63 | 0.051 | 75% | 1.00 | 1.00 |
| 382 | 8.5 | 17.8 | 0.94 | 0.004 | 1.69 | 4 | 10.3 | 25.1 | 0.94 | 0.004 | 74% | 0.59 | 1.22 |
| 383 | 8.0 | 19.0 | 0.71 | 0.041 | 1.68 | 12 | 10.3 | 27.1 | 0.59 | 0.053 | 76% | 1.00 | 1.00 |
| 384 | 7.9 | 19.3 | 0.95 | 0.004 | 1.68 | 4 | 9.8 | 26.9 | 0.94 | 0.004 | 74% | 0.59 | 1.18 |
| 385 | 7.0 | 17.2 | 0.71 | 0.042 | 1.64 | 12 | 8.6 | 23.7 | 0.58 | 0.054 | 76% | 1.00 | 1.00 |
| 386 | 7.5 | 18.0 | 0.93 | 0.004 | 1.64 | 4 | 9.5 | 26.0 | 0.94 | 0.004 | 74% | 0.59 | 1.14 |

*A = 1 − (a + b + c + d + e)

TABLE 9F

| | | Soft magnetic alloy powder | | | | | | | | | | |
|---|---|---|---|---|---|---|---|---|---|---|---|---|
| | | (Fe_{(1-α)}Co_{α})_{(1-γ)}X1_{γ})_{(1-(a+b+c+d+e))}BₐP_{b}Si_{c}C_{d}Crₑ (α = 0.300, β = 0) | | | | | | | | | | |
| | | Fe | Co | X1 | | | | | | | | |
| Sample | Comparative Example/ | (1 − α) × | α × | | Ele- | B | P | Si | C | Cr | B + P | Manufacturing condition |
| No. | Example | (1 − γ) × A | (1 − γ) × A | γ × A | ment | a | b | c | d | e | a + b | Atomizing apparatus |
| 387 | Comparative Example | 0.573 | 0.246 | 0.001 | O | 0.110 | 0.020 | 0.030 | 0.010 | 0.010 | 0.130 | Conventional apparatus |
| 388 | Example | 0.573 | 0.246 | 0.001 | O | 0.110 | 0.020 | 0.030 | 0.010 | 0.010 | 0.130 | Elliptical water flow apparatus |
| 389 | Comparative Example | 0.571 | 0.245 | 0.004 | O | 0.110 | 0.020 | 0.030 | 0.010 | 0.010 | 0.130 | Conventional apparatus |
| 390 | Example | 0.571 | 0.245 | 0.004 | O | 0.110 | 0.020 | 0.030 | 0.010 | 0.010 | 0.130 | Elliptical water flow apparatus |
| 391 | Comparative Example | 0.568 | 0.244 | 0.008 | O | 0.110 | 0.020 | 0.030 | 0.010 | 0.010 | 0.130 | Conventional apparatus |
| 392 | Example | 0.568 | 0.244 | 0.008 | O | 0.110 | 0.020 | 0.030 | 0.010 | 0.010 | 0.130 | Elliptical water flow apparatus |
| 393 | Comparative Example | 0.557 | 0.239 | 0.025 | O | 0.110 | 0.020 | 0.030 | 0.010 | 0.010 | 0.130 | Conventional apparatus |
| 394 | Example | 0.557 | 0.239 | 0.025 | O | 0.110 | 0.020 | 0.030 | 0.010 | 0.010 | 0.130 | Elliptical water flow apparatus |
| 395 | Comparative Example | 0.573 | 0.246 | 0.001 | Au | 0.110 | 0.020 | 0.030 | 0.010 | 0.010 | 0.130 | Conventional apparatus |
| 396 | Example | 0.573 | 0.246 | 0.001 | Au | 0.110 | 0.020 | 0.030 | 0.010 | 0.010 | 0.130 | Elliptical water flow apparatus |
| 397 | Comparative Example | 0.571 | 0.245 | 0.004 | Au | 0.110 | 0.020 | 0.030 | 0.010 | 0.010 | 0.130 | Conventional apparatus |
| 398 | Example | 0.571 | 0.245 | 0.004 | Au | 0.110 | 0.020 | 0.030 | 0.010 | 0.010 | 0.130 | Elliptical water flow apparatus |
| 399 | Comparative Example | 0.568 | 0.244 | 0.008 | Au | 0.110 | 0.020 | 0.030 | 0.010 | 0.010 | 0.130 | Conventional apparatus |
| 400 | Example | 0.568 | 0.244 | 0.008 | Au | 0.110 | 0.020 | 0.030 | 0.010 | 0.010 | 0.130 | Elliptical water flow apparatus |
| 401 | Comparative Example | 0.557 | 0.239 | 0.025 | Au | 0.110 | 0.020 | 0.030 | 0.010 | 0.010 | 0.130 | Conventional apparatus |
| 402 | Example | 0.557 | 0.239 | 0.025 | Au | 0.110 | 0.020 | 0.030 | 0.010 | 0.010 | 0.130 | Elliptical water flow apparatus |
| 403 | Comparative Example | 0.573 | 0.246 | 0.001 | Cu | 0.110 | 0.020 | 0.030 | 0.010 | 0.010 | 0.130 | Conventional apparatus |
| 404 | Example | 0.573 | 0.246 | 0.001 | Cu | 0.110 | 0.020 | 0.030 | 0.010 | 0.010 | 0.130 | Elliptical water flow apparatus |
| 405 | Comparative Example | 0.571 | 0.245 | 0.004 | Cu | 0.110 | 0.020 | 0.030 | 0.010 | 0.010 | 0.130 | Conventional apparatus |
| 406 | Example | 0.571 | 0.245 | 0.004 | Cu | 0.110 | 0.020 | 0.030 | 0.010 | 0.010 | 0.130 | Elliptical water flow apparatus |
| 407 | Comparative Example | 0.568 | 0.244 | 0.008 | Cu | 0.110 | 0.020 | 0.030 | 0.010 | 0.010 | 0.130 | Conventional apparatus |
| 408 | Example | 0.568 | 0.244 | 0.008 | Cu | 0.110 | 0.020 | 0.030 | 0.010 | 0.010 | 0.130 | Elliptical water flow apparatus |
| 409 | Comparative Example | 0.557 | 0.239 | 0.025 | Cu | 0.110 | 0.020 | 0.030 | 0.010 | 0.010 | 0.130 | Conventional apparatus |
| 410 | Example | 0.557 | 0.239 | 0.025 | Cu | 0.110 | 0.020 | 0.030 | 0.010 | 0.010 | 0.130 | Elliptical water flow apparatus |
| 411 | Comparative Example | 0.573 | 0.246 | 0.001 | Mn | 0.110 | 0.020 | 0.030 | 0.010 | 0.010 | 0.130 | Conventional apparatus |
| 412 | Example | 0.573 | 0.246 | 0.001 | Mn | 0.110 | 0.020 | 0.030 | 0.010 | 0.010 | 0.130 | Elliptical water flow apparatus |
| 413 | Comparative Example | 0.571 | 0.245 | 0.004 | Mn | 0.110 | 0.020 | 0.030 | 0.010 | 0.010 | 0.130 | Conventional apparatus |
| 414 | Example | 0.571 | 0.245 | 0.004 | Mn | 0.110 | 0.020 | 0.030 | 0.010 | 0.010 | 0.130 | Elliptical water flow apparatus |
| 415 | Comparative Example | 0.568 | 0.244 | 0.008 | Mn | 0.110 | 0.020 | 0.030 | 0.010 | 0.010 | 0.130 | Conventional apparatus |
| 416 | Example | 0.568 | 0.244 | 0.008 | Mn | 0.110 | 0.020 | 0.030 | 0.010 | 0.010 | 0.130 | Elliptical water flow apparatus |
| 417 | Comparative Example | 0.557 | 0.239 | 0.025 | Mn | 0.110 | 0.020 | 0.030 | 0.010 | 0.010 | 0.130 | Conventional apparatus |
| 418 | Example | 0.557 | 0.239 | 0.025 | Mn | 0.110 | 0.020 | 0.030 | 0.010 | 0.010 | 0.130 | Elliptical water flow apparatus |

| | | | | | | Magnetic core (μ = 25) | | | | | | | |
|---|---|---|---|---|---|---|---|---|---|---|---|---|---|
| | Soft magnetic alloy powder | | | | | Manufacturing | | | | | | | |
| | Particle | | Circularity of | | | condition | Particle | | Circularity of | | Characteristics | | |
| | size | | large particles | | Ribbon | Molding | size | | large particles | | Packing | Core | |
| Sample | D50 | D90 | Average | Variance | Bs | pressure | D50 | D90 | Average | Variance | density | loss | Isat |
| No. | μm | μm | (—) | (—) | T | t/cm² | μm | μm | (—) | (—) | (—) | Ratio | Ratio |
| 387 | 7.2 | 18.2 | 0.70 | 0.044 | 1.70 | 12 | 9.0 | 25.8 | 0.60 | 0.053 | 76% | 1.00 | 1.00 |
| 388 | 8.3 | 17.2 | 0.94 | 0.004 | 1.70 | 4 | 10.2 | 24.1 | 0.94 | 0.004 | 74% | 0.55 | 1.25 |
| 389 | 7.7 | 18.3 | 0.71 | 0.042 | 1.69 | 12 | 9.3 | 26.4 | 0.62 | 0.052 | 76% | 1.00 | 1.00 |
| 390 | 8.5 | 16.6 | 0.94 | 0.004 | 1.69 | 4 | 10.9 | 22.9 | 0.95 | 0.003 | 74% | 0.60 | 1.22 |
| 391 | 7.5 | 16.1 | 0.72 | 0.043 | 1.68 | 12 | 9.1 | 22.7 | 0.59 | 0.053 | 75% | 1.00 | 1.00 |
| 392 | 8.0 | 17.8 | 0.94 | 0.004 | 1.68 | 4 | 10.1 | 25.3 | 0.94 | 0.004 | 74% | 0.59 | 1.18 |
| 393 | 8.4 | 19.3 | 0.71 | 0.044 | 1.63 | 12 | 10.5 | 27.8 | 0.58 | 0.054 | 76% | 1.00 | 1.00 |
| 394 | 8.1 | 7.6 | 0.95 | 0.004 | 1.63 | 4 | 10.4 | 25.1 | 0.95 | 0.003 | 74% | 0.55 | 1.14 |
| 395 | 8.1 | 18.2 | 0.71 | 0.041 | 1.70 | 12 | 9.8 | 26.0 | 0.62 | 0.052 | 76% | 1.00 | 1.00 |
| 396 | 7.5 | 18.6 | 0.93 | 0.004 | 1.70 | 4 | 9.4 | 25.9 | 0.94 | 0.004 | 74% | 0.58 | 1.25 |
| 397 | 7.4 | 7.9 | 0.71 | 0.045 | 1.69 | 12 | 9.6 | 24.9 | 0.61 | 0.053 | 76% | 1.00 | 1.00 |
| 398 | 8.2 | 18.9 | 0.94 | 0.004 | 1.69 | 4 | 9.9 | 27.1 | 0.94 | 0.004 | 74% | 0.58 | 1.21 |
| 399 | 8.4 | 17.6 | 0.72 | 0.041 | 1.67 | 12 | 10.3 | 25.2 | 0.57 | 0.054 | 75% | 1.00 | 1.00 |
| 400 | 8.5 | 18.1 | 0.93 | 0.004 | 1.67 | 4 | 10.7 | 25.7 | 0.94 | 0.004 | 74% | 0.56 | 1.17 |
| 401 | 8.1 | 19.0 | 0.72 | 0.041 | 1.61 | 12 | 9.9 | 26.3 | 0.59 | 0.053 | 75% | 1.00 | 1.00 |
| 402 | 8.2 | 16.8 | 0.95 | 0.004 | 1.61 | 4 | 9.9 | 23.1 | 0.94 | 0.004 | 74% | 0.54 | 1.14 |
| 403 | 7.3 | 18.2 | 0.71 | 0.042 | 1.70 | 12 | 8.8 | 25.6 | 0.60 | 0.053 | 76% | 1.00 | 1.00 |
| 404 | 7.6 | 17.1 | 0.95 | 0.004 | 1.70 | 4 | 9.4 | 24.1 | 0.95 | 0.004 | 74% | 0.55 | 1.24 |
| 405 | 7.1 | 17.1 | 0.71 | 0.042 | 1.69 | 12 | 9.1 | 23.6 | 0.58 | 0.054 | 76% | 1.00 | 1.00 |
| 406 | 8.0 | 16.8 | 0.94 | 0.004 | 1.69 | 4 | 9.9 | 24.2 | 0.94 | 0.004 | 74% | 0.58 | 1.20 |
| 407 | 7.7 | 17.2 | 0.70 | 0.045 | 1.67 | 12 | 9.9 | 24.0 | 0.61 | 0.053 | 76% | 1.00 | 1.00 |
| 408 | 8.4 | 17.9 | 0.93 | 0.004 | 1.67 | 4 | 10.9 | 25.9 | 0.93 | 0.004 | 74% | 0.59 | 1.16 |
| 409 | 8.2 | 18.6 | 0.71 | 0.043 | 1.61 | 12 | 10.0 | 26.1 | 0.63 | 0.052 | 76% | 1.00 | 1.00 |
| 410 | 8.0 | 16.9 | 0.94 | 0.004 | 1.61 | 4 | 10.1 | 24.5 | 0.95 | 0.004 | 74% | 0.57 | 1.13 |
| 411 | 8.1 | 18.9 | 0.71 | 0.045 | 1.70 | 12 | 9.9 | 25.8 | 0.63 | 0.051 | 76% | 1.00 | 1.00 |
| 412 | 8.2 | 17.5 | 0.94 | 0.004 | 1.70 | 4 | 10.0 | 24.0 | 0.94 | 0.004 | 74% | 0.59 | 1.25 |
| 413 | 8.4 | 17.8 | 0.70 | 0.043 | 1.69 | 12 | 10.8 | 24.7 | 0.60 | 0.053 | 76% | 1.00 | 1.00 |
| 414 | 7.5 | 19.1 | 0.94 | 0.004 | 1.69 | 4 | 9.4 | 26.5 | 0.94 | 0.004 | 74% | 0.55 | 1.21 |
| 415 | 7.8 | 17.2 | 0.71 | 0.042 | 1.69 | 12 | 9.5 | 24.1 | 0.61 | 0.053 | 76% | 1.00 | 1.00 |
| 416 | 7.2 | 16.7 | 0.94 | 0.004 | 1.69 | 4 | 8.8 | 23.5 | 0.94 | 0.004 | 74% | 0.60 | 1.18 |
| 417 | 7.0 | 18.8 | 0.71 | 0.044 | 1.65 | 12 | 8.9 | 27.0 | 0.62 | 0.052 | 76% | 1.00 | 1.00 |
| 418 | 7.9 | 17.3 | 0.95 | 0.004 | 1.65 | 4 | 10.1 | 25.0 | 0.95 | 0.004 | 74% | 0.55 | 1.14 |

*A = 1 − (a + b + c + d + e)

TABLE 9G

| | | Soft magnetic alloy powder | | | | | | | | | | |
|---|---|---|---|---|---|---|---|---|---|---|---|---|
| | | (Fe_{(1-α)}Co_{α})_{(1-γ)}X1_{γ})_{(1-(a+b+c+d+e))}BₐP_{b}Si_{c}C_{d}Crₑ (α = 0.300, β = 0) | | | | | | | | | | |
| | | Fe | Co | X1 | | | | | | | | |
| Sample | Comparative Example/ | (1 − α) × | α × | | Ele- | B | P | Si | C | Cr | B + P | Manufacturing condition |
| No. | Example | (1 − γ) × A | (1 − γ) × A | γ × A | ment | a | b | c | d | e | a + b | Atomizing apparatus |
| 419 | Comparative Example | 0.573 | 0.246 | 0.001 | La | 0.110 | 0.020 | 0.030 | 0.010 | 0.010 | 0.130 | Conventional apparatus |
| 420 | Example | 0.573 | 0.246 | 0.001 | La | 0.110 | 0.020 | 0.030 | 0.010 | 0.010 | 0.130 | Elliptical water flow apparatus |
| 421 | Comparative Example | 0.571 | 0.245 | 0.004 | La | 0.110 | 0.020 | 0.030 | 0.010 | 0.010 | 0.130 | Conventional apparatus |
| 422 | Example | 0.571 | 0.245 | 0.004 | La | 0.110 | 0.020 | 0.030 | 0.010 | 0.010 | 0.130 | Elliptical water flow apparatus |
| 423 | Comparative Example | 0.568 | 0.244 | 0.008 | La | 0.110 | 0.020 | 0.030 | 0.010 | 0.010 | 0.130 | Conventional apparatus |
| 424 | Example | 0.568 | 0.244 | 0.008 | La | 0.110 | 0.020 | 0.030 | 0.010 | 0.010 | 0.130 | Elliptical water flow apparatus |
| 425 | Comparative Example | 0.557 | 0.239 | 0.025 | La | 0.110 | 0.020 | 0.030 | 0.010 | 0.010 | 0.130 | Conventional apparatus |
| 426 | Example | 0.557 | 0.239 | 0.025 | La | 0.110 | 0.020 | 0.030 | 0.010 | 0.010 | 0.130 | Elliptical water flow apparatus |
| 427 | Comparative Example | 0.573 | 0.246 | 0.001 | Y | 0.110 | 0.020 | 0.030 | 0.010 | 0.010 | 0.130 | Conventional apparatus |
| 428 | Example | 0.573 | 0.246 | 0.001 | Y | 0.110 | 0.020 | 0.030 | 0.010 | 0.010 | 0.130 | Elliptical water flow apparatus |
| 429 | Comparative Example | 0.571 | 0.245 | 0.004 | Y | 0.110 | 0.020 | 0.030 | 0.010 | 0.010 | 0.130 | Conventional apparatus |
| 430 | Example | 0.571 | 0.245 | 0.004 | Y | 0.110 | 0.020 | 0.030 | 0.010 | 0.010 | 0.130 | Elliptical water flow apparatus |
| 431 | Comparative Example | 0.568 | 0.244 | 0.008 | Y | 0.110 | 0.020 | 0.030 | 0.010 | 0.010 | 0.130 | Conventional apparatus |
| 432 | Example | 0.568 | 0.244 | 0.008 | Y | 0.110 | 0.020 | 0.030 | 0.010 | 0.010 | 0.130 | Elliptical water flow apparatus |
| 433 | Comparative Example | 0.557 | 0.239 | 0.025 | Y | 0.110 | 0.020 | 0.030 | 0.010 | 0.010 | 0.130 | Conventional apparatus |
| 434 | Example | 0.557 | 0.239 | 0.025 | Y | 0.110 | 0.020 | 0.030 | 0.010 | 0.010 | 0.130 | Elliptical water flow apparatus |
| 435 | Comparative Example | 0.573 | 0.246 | 0.001 | Pd | 0.110 | 0.020 | 0.030 | 0.010 | 0.010 | 0.130 | Conventional apparatus |
| 436 | Example | 0.573 | 0.246 | 0.001 | Pd | 0.110 | 0.020 | 0.030 | 0.010 | 0.010 | 0.130 | Elliptical water flow apparatus |
| 437 | Comparative Example | 0.571 | 0.245 | 0.004 | Pd | 0.110 | 0.020 | 0.030 | 0.010 | 0.010 | 0.130 | Conventional apparatus |
| 438 | Example | 0.571 | 0.245 | 0.004 | Pd | 0.110 | 0.020 | 0.030 | 0.010 | 0.010 | 0.130 | Elliptical water flow apparatus |
| 439 | Comparative Example | 0.568 | 0.244 | 0.008 | Pd | 0.110 | 0.020 | 0.030 | 0.010 | 0.010 | 0.130 | Conventional apparatus |
| 440 | Example | 0.568 | 0.244 | 0.008 | Pd | 0.110 | 0.020 | 0.030 | 0.010 | 0.010 | 0.130 | Elliptical water flow apparatus |
| 441 | Comparative Example | 0.557 | 0.239 | 0.025 | Pd | 0.110 | 0.020 | 0.030 | 0.010 | 0.010 | 0.130 | Conventional apparatus |
| 442 | Example | 0.557 | 0.239 | 0.025 | Pd | 0.110 | 0.020 | 0.030 | 0.010 | 0.010 | 0.130 | Elliptical water flow apparatus |
| 443 | Comparative Example | 0.573 | 0.246 | 0.001 | Pt | 0.110 | 0.020 | 0.030 | 0.010 | 0.010 | 0.130 | Conventional apparatus |
| 444 | Example | 0.573 | 0.246 | 0.001 | Pt | 0.110 | 0.020 | 0.030 | 0.010 | 0.010 | 0.130 | Elliptical water flow apparatus |
| 445 | Comparative Example | 0.571 | 0.245 | 0.004 | Pt | 0.110 | 0.020 | 0.030 | 0.010 | 0.010 | 0.130 | Conventional apparatus |
| 446 | Example | 0.571 | 0.245 | 0.004 | Pt | 0.110 | 0.020 | 0.030 | 0.010 | 0.010 | 0.130 | Elliptical water flow apparatus |
| 447 | Comparative Example | 0.568 | 0.244 | 0.008 | Pt | 0.110 | 0.020 | 0.030 | 0.010 | 0.010 | 0.130 | Conventional apparatus |
| 448 | Example | 0.568 | 0.244 | 0.008 | Pt | 0.110 | 0.020 | 0.030 | 0.010 | 0.010 | 0.130 | Elliptical water flow apparatus |
| 449 | Comparative Example | 0.557 | 0.239 | 0.025 | Pt | 0.110 | 0.020 | 0.030 | 0.010 | 0.010 | 0.130 | Conventional apparatus |
| 450 | Example | 0.557 | 0.239 | 0.025 | Pt | 0.110 | 0.020 | 0.030 | 0.010 | 0.010 | 0.130 | Elliptical water flow apparatus |

| | | | | | | Magnetic core (μ = 25) | | | | | | | |
|---|---|---|---|---|---|---|---|---|---|---|---|---|---|
| | Soft magnetic alloy powder | | | | | Manufacturing | | | | | | | |
| | Particle | | Circularity of | | | condition | Particle | | Circularity of | | Characteristics | | |
| | size | | large particles | | Ribbon | Molding | size | | large particles | | Packing | Core | |
| Sample | D50 | D90 | Average | Variance | Bs | pressure | D50 | D90 | Average | Variance | density | loss | Isat |
| No. | μm | μm | (—) | (—) | T | t/cm² | μm | μm | (—) | (—) | (—) | Ratio | Ratio |
| 419 | 8.4 | 17.8 | 0.71 | 0.044 | 1.70 | 12 | 10.5 | 24.9 | 0.57 | 0.054 | 76% | 1.00 | 1.00 |
| 420 | 7.2 | 19.3 | 0.93 | 0.004 | 1.70 | 4 | 9.2 | 26.7 | 0.94 | 0.004 | 74% | 0.55 | 1.25 |
| 421 | 7.1 | 16.6 | 0.71 | 0.042 | 1.70 | 12 | 9.1 | 23.2 | 0.59 | 0.053 | 76% | 1.00 | 1.00 |
| 422 | 8.4 | 18.4 | 0.94 | 0.004 | 1.70 | 4 | 10.4 | 25.6 | 0.94 | 0.004 | 74% | 0.61 | 1.21 |
| 423 | 7.8 | 19.3 | 0.71 | 0.045 | 1.70 | 12 | 10.1 | 28.0 | 0.57 | 0.054 | 76% | 1.00 | 1.00 |
| 424 | 7.8 | 19.0 | 0.95 | 0.004 | 1.70 | 4 | 9.9 | 26.2 | 0.96 | 0.004 | 74% | 0.55 | 1.17 |
| 425 | 8.2 | 17.2 | 0.71 | 0.044 | 1.67 | 12 | 10.7 | 23.4 | 0.62 | 0.052 | 76% | 1.00 | 1.00 |
| 426 | 7.9 | 19.0 | 0.94 | 0.004 | 1.67 | 4 | 10.2 | 27.0 | 0.95 | 0.004 | 74% | 0.56 | 1.14 |
| 427 | 8.1 | 17.0 | 0.70 | 0.045 | 1.70 | 12 | 10.3 | 23.2 | 0.63 | 0.052 | 76% | 1.00 | 1.00 |
| 428 | 7.1 | 18.8 | 0.94 | 0.004 | 1.70 | 4 | 8.9 | 26.4 | 0.94 | 0.004 | 74% | 0.58 | 1.27 |
| 429 | 8.0 | 16.7 | 0.71 | 0.043 | 1.70 | 12 | 10.2 | 23.6 | 0.64 | 0.051 | 76% | 1.00 | 1.00 |
| 430 | 7.5 | 16.6 | 0.94 | 0.004 | 1.70 | 4 | 9.2 | 22.8 | 0.95 | 0.004 | 74% | 0.59 | 1.23 |
| 431 | 7.4 | 16.9 | 0.71 | 0.041 | 1.70 | 12 | 9.0 | 23.9 | 0.59 | 0.053 | 76% | 1.00 | 1.00 |
| 432 | 8.4 | 19.0 | 0.94 | 0.004 | 1.70 | 4 | 10.6 | 26.2 | 0.95 | 0.003 | 74% | 0.54 | 1.19 |
| 433 | 7.3 | 17.6 | 0.70 | 0.044 | 1.67 | 12 | 9.0 | 24.2 | 0.58 | 0.054 | 76% | 1.00 | 1.00 |
| 434 | 8.4 | 16.8 | 0.95 | 0.004 | 1.67 | 4 | 10.3 | 24.4 | 0.95 | 0.004 | 74% | 0.56 | 1.15 |
| 435 | 8.2 | 18.4 | 0.71 | 0.042 | 1.70 | 12 | 10.3 | 26.3 | 0.63 | 0.052 | 76% | 1.00 | 1.00 |
| 436 | 7.1 | 18.9 | 0.95 | 0.004 | 1.70 | 4 | 8.8 | 27.0 | 0.95 | 0.003 | 74% | 0.57 | 1.23 |
| 437 | 7.6 | 18.2 | 0.71 | 0.044 | 1.69 | 12 | 9.6 | 24.7 | 0.61 | 0.052 | 76% | 1.00 | 1.00 |
| 438 | 7.7 | 16.9 | 0.95 | 0.004 | 1.69 | 4 | 9.9 | 24.3 | 0.95 | 0.004 | 74% | 0.56 | 1.20 |
| 439 | 7.9 | 17.7 | 0.70 | 0.044 | 1.67 | 12 | 9.5 | 24.8 | 0.57 | 0.054 | 76% | 1.00 | 1.00 |
| 440 | 7.5 | 17.9 | 0.94 | 0.004 | 1.67 | 4 | 9.3 | 25.2 | 0.94 | 0.004 | 74% | 0.60 | 1.16 |
| 441 | 8.4 | 19.0 | 0.70 | 0.044 | 1.62 | 12 | 10.8 | 27.4 | 0.63 | 0.052 | 76% | 1.00 | 1.00 |
| 442 | 8.3 | 19.0 | 0.94 | 0.004 | 1.62 | 4 | 10.2 | 26.4 | 0.95 | 0.004 | 74% | 0.57 | 1.13 |
| 443 | 7.9 | 17.0 | 0.71 | 0.042 | 1.70 | 12 | 9.8 | 23.6 | 0.58 | 0.053 | 76% | 1.00 | 1.00 |
| 444 | 7.4 | 18.3 | 0.94 | 0.004 | 1.70 | 4 | 9.1 | 26.1 | 0.95 | 0.004 | 74% | 0.59 | 1.25 |
| 445 | 8.5 | 16.7 | 0.71 | 0.043 | 1.69 | 12 | 10.4 | 23.0 | 0.60 | 0.053 | 76% | 1.00 | 1.00 |
| 446 | 7.2 | 18.8 | 0.94 | 0.004 | 1.69 | 4 | 9.0 | 25.7 | 0.94 | 0.004 | 74% | 0.61 | 1.22 |
| 447 | 8.4 | 16.8 | 0.71 | 0.044 | 1.67 | 12 | 10.2 | 24.0 | 0.57 | 0.054 | 76% | 1.00 | 1.00 |
| 448 | 7.5 | 19.1 | 0.94 | 0.004 | 1.67 | 4 | 9.4 | 27.4 | 0.94 | 0.004 | 74% | 0.58 | 1.18 |
| 449 | 8.3 | 18.1 | 0.72 | 0.041 | 1.62 | 12 | 10.3 | 25.6 | 0.61 | 0.053 | 75% | 1.00 | 1.00 |
| 450 | 7.5 | 17.3 | 0.95 | 0.004 | 1.61 | 4 | 9.6 | 24.5 | 0.95 | 0.003 | 74% | 0.57 | 1.14 |

*A = 1 − (a + b + c + d + e)

Table 2 shows cases in which P was not contained and mainly the B content (a) was changed. When the composition of the soft magnetic alloy satisfied predetermined ranges (e.g., 0.020≤α≤0.200), changing the type of the atomizing apparatus enabled changes in the average circularity of the large particles, the variance of circularity of the large particles, and also the core loss and Isat of the magnetic cores.

Bs tended to decrease as the B content increased. According to Table 2, when the B content (a) was 0.100 or more and 0.200 or less, Bs increased as the B content (a) increased. This was because, when the B content (a) was 0.100 or more and 0.200 or less, the Si content (c) was changed at the same time so that the composition of the soft magnetic alloy was within the predetermined ranges.

The ratio of the core loss of Sample No. 24 to that of Sample No. 23 was smaller than the ratio of the core loss of Sample No. 22 to that of Sample No. 21. This was because the molding pressure of Sample No. 23 was relatively increased to satisfy μ=25 while the large particles of Sample No. 23 had relatively low circularity, resulting in relative increase of the core loss of Sample No. 23.

When B was not contained, despite change of the atomizing apparatus, changes in the average circularity of the large particles and in the variance of circularity of the large particles were small. Additionally, even when the atomizing apparatus was changed, the core loss of the magnetic core did not sufficiently decrease, and the DC superimposition characteristics thereof did not sufficiently improve.

When the B content was too high, despite change of the atomizing apparatus, changes in the average circularity of the large particles and in the variance of circularity of the large particles were small. Additionally, even when the atomizing apparatus was changed, the core loss of the magnetic core did not sufficiently decrease, and the DC superimposition characteristics thereof did not sufficiently improve.

Table 3 shows cases in which the B content (a) and the P content (b) were changed while their total remained constant. When the composition of the soft magnetic alloy satisfied the predetermined ranges (e.g., 0≤b≤0.070), changing the type of the atomizing apparatus enabled changes in the average circularity of the large particles, the variance of circularity of the large particles, and also the core loss and Isat of the magnetic cores.

When the P content was too high, Bs was lower than when the P content was within the above range. Additionally, even when the atomizing apparatus was changed, the core loss of the magnetic core did not sufficiently decrease, and the DC superimposition characteristics thereof did not sufficiently improve.

Table 4 shows cases in which the Si content (c) was changed while the total of the B content and the Si content remained constant. When the composition of the soft magnetic alloy satisfied the predetermined ranges (e.g., 0≤c≤0.100), changing the type of the atomizing apparatus enabled changes in the average circularity of the large particles, the variance of circularity of the large particles, and also the core loss and Isat of the magnetic cores.

When the Si content was too high, Bs was lower than when the Si content was within the above range. Additionally, even when the atomizing apparatus was changed, the core loss of the magnetic core did not sufficiently decrease, and the DC superimposition characteristics thereof did not sufficiently improve.

Table 5 shows cases in which the C content (d) was changed while the total of the B content and the C content remained constant. When the composition of the soft magnetic alloy satisfied the predetermined ranges (e.g., 0≤d≤0.050 ), changing the type of the atomizing apparatus enabled changes in the average circularity of the large particles, the variance of circularity of the large particles, and also the core loss and Isat of the magnetic cores.

When the C content was too low, the average circularity of the large particles was smaller and the variance of circularity of the large particles was larger compared to when the C content was within the above range. Additionally, even when the atomizing apparatus was changed, the core loss of the magnetic core did not sufficiently decrease, and the DC superimposition characteristics thereof did not sufficiently improve.

When the C content was too high, the core loss of the magnetic cores was significantly large despite use of the elliptical water flow apparatus. Further, despite change of the atomizing apparatus, the DC superimposition characteristics were not sufficiently improved.

Table 6 shows cases in which the Cr content (e) was changed. When the composition of the soft magnetic alloy satisfied the predetermined ranges (e.g., 0≤e≤0.040), changing the type of the atomizing apparatus enabled changes in the average circularity of the large particles, the variance of circularity of the large particles, and also the core loss and Isat of the magnetic cores.

When the Cr content was too high, Bs was lower than when the Cr content was within the above range. Consequently, despite change of the atomizing apparatus, the DC superimposition characteristics of the magnetic cores were not sufficiently improved.

Tables 7A to 7G show cases in which α and β were changed while a, b, c, d, and e remained constant. Each table shows cases in which β=0, β=0.005, β=0.010, β=0.030, β=0.050, β=0.100, β=0.200, and β=0.210 were satisfied.

Table 7A shows the cases in which α=0 was satisfied, i.e., Co was not contained. Because Co was not contained, even when the atomizing apparatus was changed, the core loss of the magnetic cores was not sufficiently reduced, and the DC superimposition characteristics thereof were not sufficiently improved.

Table 7B shows the cases in which α=0.005 was satisfied. Table 7C shows the cases in which α=0.010 was satisfied. Table 7D shows the cases in which α=0.300 was satisfied. Table 7E shows the cases in which α=0.500 was satisfied. Table 7F shows the cases in which α=0.700 was satisfied. When the composition of the soft magnetic alloy satisfied the predetermined ranges, changing the type of the atomizing apparatus enabled changes in the average circularity of the large particles, the variance of circularity of the large particles, and also the core loss and Isat of the magnetic cores.

In contrast, when β was too large, the DC superimposition characteristics of the magnetic cores were not sufficiently improved despite change of the atomizing apparatus.

Table 7G shows the cases in which α=0.710 was satisfied. Because a was too large, the DC superimposition characteristics of the magnetic cores were not sufficiently improved even when the atomizing apparatus was changed.

Table 8 shows cases in which the sum (1−(a+b+c+d+e)) of the Fe content, Co content, Ni content, and X1 content was changed and the B content, P content, Si content, and C content were accordingly changed. When the composition of the soft magnetic alloy satisfied the predetermined ranges (e.g., 0.790≤(1−(a+b+c+d+e))≤0.900), changing the type of the atomizing apparatus enabled changes in the average circularity of the large particles, the variance of circularity of the large particles, and also the core loss and Isat of the magnetic cores.

When the sum of the Fe content, Co content, Ni content, and X1 was too small, the DC superimposition characteristics of the magnetic cores were not sufficiently improved despite change of the atomizing apparatus. When the sum of the Fe content, Co content, Ni content, and X1 was too large, the core loss of the magnetic cores was not sufficiently reduced, and the DC superimposition characteristics thereof were not sufficiently improved, despite change of the atomizing apparatus.

Tables 9A to 9G each show cases in which the element included in X1 was changed while γ=0.001, γ=0.005, γ=0.010, and γ=0.030 were satisfied. When the composition of the soft magnetic alloy satisfied the predetermined ranges, changing the type of the atomizing apparatus enabled changes in the average circularity of the large particles, the variance of circularity of the large particles, and also the core loss and Isat of the magnetic cores.

### Experiment 3

The experiment was conducted as in Sample Nos. 6a and 3b of Table 1 except that the particle size of the soft magnetic alloy powder was changed. The particle size of the soft magnetic alloy powder was changed by appropriately changing the sprayed amount of the molten metal, the gas spraying pressure, and the cooling water pressure. Table 10 shows the results.

TABLE 10

| | | Soft magnetic alloy powder | | | | | |
|---|---|---|---|---|---|---|---|
| | | | Particle | | Circularity of | | |
| | | | size | | large particles | | Ribbon |
| Sample | Comparative Example/ | Manufacturing condition | D50 | D90 | Average | Variance | Bs |
| No. | Example | Atomizing apparatus | μm | μm | (—) | (—) | T |
| 451 | Comparative Example | Conventional apparatus | 3.5 | 10.0 | 0.74 | 0.042 | 1.70 |
| 452 | Example | Elliptical water flow apparatus | 3.5 | 10.1 | 0.99 | 0.001 | 1.70 |
| 453 | Comparative Example | Conventional apparatus | 5.0 | 12.4 | 0.72 | 0.043 | 1.70 |
| 454 | Example | Elliptical water flow apparatus | 5.0 | 12.5 | 0.95 | 0.003 | 1.70 |
| 6a | Comparative Example | Conventional apparatus | 7.6 | 17.4 | 0.71 | 0.044 | 1.70 |
| 3b | Example | Elliptical water flow apparatus | 7.8 | 17.8 | 0.94 | 0.004 | 1.70 |
| 457 | Comparative Example | Conventional apparatus | 10.3 | 21.1 | 0.68 | 0.045 | 1.70 |
| 458 | Example | Elliptical water flow apparatus | 10.3 | 21.1 | 0.94 | 0.004 | 1.70 |
| 459 | Comparative Example | Conventional apparatus | 15.1 | 29.3 | 0.65 | 0.046 | 1.70 |
| 460 | Example | Elliptical water flow apparatus | 15.0 | 29.4 | 0.93 | 0.004 | 1.70 |
| 461 | Comparative Example | Conventional apparatus | 20.2 | 40.1 | 0.58 | 0.050 | 1.70 |
| 462 | Example | Elliptical water flow apparatus | 20.2 | 40.2 | 0.93 | 0.005 | 1.70 |
| 463 | Comparative Example | Conventional apparatus | 25.1 | 48.9 | 0.52 | 0.059 | 1.70 |
| 464 | Example | Elliptical water flow apparatus | 25.1 | 48.9 | 0.92 | 0.005 | 1.70 |
| 465 | Comparative Example | Conventional apparatus | 30.3 | 59.9 | 0.48 | 0.065 | 1.70 |
| 466 | Example | Elliptical water flow apparatus | 30.2 | 59.9 | 0.92 | 0.006 | 1.70 |
| 467 | Comparative Example | Conventional apparatus | 35.0 | 69.9 | 0.44 | 0.072 | 1.70 |
| 468 | Example | Elliptical water flow apparatus | 34.9 | 69.9 | 0.92 | 0.006 | 1.70 |

| | Magnetic core | | | | | | | | | | |
|---|---|---|---|---|---|---|---|---|---|---|---|
| | Manufacturing | | | | | | | | | | |
| | condition | Particle | | Circularity of | | Characteristics | | | | | |
| | Molding | size | | large particles | | Packing | | | | | |
| Sample | pressure | D50 | D90 | Average | Variance | density | μ | Core loss | | Isat | |
| No. | t/cm² | μm | μm | (—) | (—) | (—) | (—) | kW/m³ | Ratio | A | Ratio |
| 451 | 12 | 4.5 | 13.7 | 0.68 | 0.051 | 75% | 19.4 | 1301 | 1.00 | 9.5 | 1.00 |
| 452 | 2 | 4.4 | 13.6 | 0.98 | 0.002 | 72% | 19.4 | 775 | 0.60 | 11.6 | 1.23 |
| 453 | 12 | 6.5 | 17.5 | 0.66 | 0.052 | 75% | 22.3 | 1548 | 1.00 | 9.4 | 1.00 |
| 454 | 2 | 6.5 | 17.6 | 0.95 | 0.003 | 72% | 22.3 | 871 | 0.56 | 11.6 | 1.24 |
| 6a | 12 | 9.8 | 25.2 | 0.60 | 0.053 | 76% | 25.2 | 1910 | 1.00 | 9.4 | 1.00 |
| 3b | 2 | 9.7 | 24.3 | 0.94 | 0.004 | 73% | 25.2 | 1024 | 0.54 | 11.8 | 1.25 |
| 457 | 12 | 13.3 | 29.4 | 0.58 | 0.054 | 76% | 26.4 | 2092 | 1.00 | 9.4 | 1.00 |
| 458 | 2 | 13.3 | 29.5 | 0.94 | 0.004 | 73% | 26.4 | 1088 | 0.52 | 11.9 | 1.27 |
| 459 | 12 | 19.6 | 41.1 | 0.55 | 0.056 | 77% | 27.9 | 2891 | 1.00 | 9.3 | 1.00 |
| 460 | 2 | 19.6 | 41.1 | 0.93 | 0.005 | 73% | 27.9 | 1343 | 0.46 | 11.9 | 1.28 |
| 461 | 12 | 26.0 | 56.6 | 0.53 | 0.061 | 77% | 29.3 | 3300 | 1.00 | 9.3 | 1.00 |
| 462 | 2 | 26.0 | 56.6 | 0.92 | 0.005 | 74% | 29.3 | 1455 | 0.44 | 11.6 | 1.25 |
| 463 | 12 | 32.1 | 69.1 | 0.50 | 0.072 | 78% | 30.9 | 2915 | 1.00 | 9.4 | 1.00 |
| 464 | 2 | 32.2 | 69.1 | 0.92 | 0.006 | 74% | 30.9 | 1554 | 0.53 | 11.6 | 1.23 |
| 465 | 12 | 39.2 | 83.8 | 0.47 | 0.079 | 78% | 31.5 | 2873 | 1.00 | 9.3 | 1.00 |
| 466 | 2 | 39.2 | 83.9 | 0.91 | 0.006 | 74% | 31.5 | 1599 | 0.56 | 11.9 | 1.28 |
| 467 | 12 | 45.4 | 97.8 | 0.43 | 0.087 | 79% | 32.1 | 2768 | 1.00 | 9.5 | 1.00 |
| 468 | 2 | 45.4 | 97.9 | 0.91 | 0.007 | 75% | 32.1 | 1674 | 0.60 | 11.8 | 1.24 |

According to Table 10, provided that an Example and a Comparative Example had about the same D50 and about the same D90, changing the atomizing apparatus from the conventional apparatus to the elliptical water flow apparatus increased the average circularity of the large particles included in the soft magnetic alloy powder. Provided that the Example and the Comparative Example had about the same D50 and about the same D90, changing the atomizing apparatus from the conventional apparatus to the elliptical water flow apparatus reduced the variance of circularity of the large particles included in the soft magnetic alloy powder.

As for the core loss and the DC superimposition characteristics of the magnetic cores, provided that the Example and the Comparative Example had about the same D50, about the same D90, and about the same u, changing the atomizing apparatus from the conventional apparatus to the elliptical water flow apparatus reduced the core loss and improved the DC superimposition characteristics.

### Experiment 4

The experiment was conducted as in Sample Nos. 257 and 258 except that the soft magnetic alloy powder was appropriately subjected to a heat treatment. Specifically, the heat treatment was carried out at 300° C. for Sample Nos. 257a and 258a; at 575° C. for Sample Nos. 257b and 258b; and at 900° C. for Sample Nos. 257c and 258c. The microstructure of each powder was evaluated by X-ray diffraction measurement. Other conditions were the same as in Experiment 2. Table 11 shows the results.

TABLE 11

| | | Soft magnetic alloy powder | | | | | | |
|---|---|---|---|---|---|---|---|---|
| | | | | Particle | | Circularity of | | |
| | | | | size | | large particles | | Ribbon |
| Sample | Comparative Example/ | Manufacturing condition | | D50 | D90 | Average | Variance | Bs |
| No. | Example | Atomizing apparatus | Structure | μm | μm | (—) | (—) | T |
| 257 | Comparative Example | Conventional apparatus | Amorphous | 7.5 | 17.6 | 0.71 | 0.042 | 1.68 |
| 258 | Example | Elliptical water flow apparatus | Amorphous | 7.0 | 19.0 | 0.93 | 0.004 | 1.68 |
| 257a | Comparative Example | Conventional apparatus | Hetero-amorphous | 7.5 | 17.6 | 0.71 | 0.042 | 1.68 |
| 258a | Example | Elliptical water flow apparatus | Hetero-amorphous | 7.0 | 19.0 | 0.93 | 0.004 | 1.68 |
| 257b | Comparative Example | Conventional apparatus | Nanocrystalline | 7.5 | 17.6 | 0.71 | 0.042 | 1.68 |
| 258b | Example | Elliptical water flow apparatus | Nanocrystalline | 7.0 | 19.0 | 0.93 | 0.004 | 1.68 |
| 257c | Comparative Example | Conventional apparatus | Crystalline | 7.5 | 17.6 | 0.71 | 0.042 | 1.68 |
| 258c | Example | Elliptical water flow apparatus | Crystalline | 7.0 | 19.0 | 0.93 | 0.004 | 1.68 |

| | Magnetic core (μ = 25) | | | | | | | |
|---|---|---|---|---|---|---|---|---|
| | Manufacturing | | | | | | | |
| | condition | Particle | | Circularity of | | Characteristics | | |
| | Molding | size | | large particles | | Packing | Core | |
| Sample | pressure | D50 | D90 | Average | Variance | density | loss | Isat |
| No. | t/cm² | μm | μm | (—) | (—) | (—) | Ratio | Ratio |
| 257 | 12 | 9.6 | 25.3 | 0.58 | 0.054 | 76% | 1.00 | 1.00 |
| 258 | 4 | 8.9 | 27.3 | 0.93 | 0.004 | 74% | 0.57 | 1.15 |
| 257a | 12 | 9.5 | 25.6 | 0.58 | 0.053 | 77% | 1.00 | 1.00 |
| 258a | 4 | 9.0 | 27.1 | 0.93 | 0.004 | 74% | 0.54 | 1.17 |
| 257b | 12 | 9.5 | 25.6 | 0.58 | 0.053 | 76% | 1.00 | 1.00 |
| 258b | 4 | 9.1 | 27.3 | 0.93 | 0.004 | 73% | 0.51 | 1.19 |
| 257c | 12 | 9.5 | 25.5 | 0.59 | 0.056 | 77% | 1.00 | 1.00 |
| 258c | 4 | 9.1 | 27.2 | 0.94 | 0.005 | 74% | 0.63 | 1.11 |

According to Table 11, the heat treatment did not change the average circularity of the large particles or the variance of circularity of the large particle. Regardless of the microstructure, changing the atomizing apparatus from the conventional apparatus to the elliptical water flow apparatus reduced the core loss of the magnetic cores and improved the DC superimposition characteristics thereof.

### REFERENCE NUMERALS

10 . . . elliptical water flow atomizing apparatus
20 . . . molten metal supply unit
21 . . . molten metal
22 . . . container
23 . . . molten metal discharge port
24 . . . heating coil
26 . . . gas spray nozzle
27 . . . gas spray port
30 . . . cooling unit
32 . . . tubular body
32α . . . cylindrical member
33 . . . inner circumferential surface
34 . . . discharge port
36 . . . cooling liquid introduction unit
37 . . . supply line
38 . . . frame
39a . . . inner frame piece
39b . . . frame support piece
40 . . . auxiliary tubular body
42 . . . passage
44 . . . outside space
45 . . . outer member
46 . . . inside space
50 . . . cooling liquid layer
52 . . . cooling liquid discharge port

What is claimed is:

1. A soft magnetic alloy powder comprising a component having a compositional formula ((Fe_{(1-(═+β))}Co_{α}Ni_{β})_{(1-γ)}X1_{γ})_{(1-(a+b+c+d+e))}BₐP_{b}Si_{c}C_{d}Crₑ in atomic ratio, wherein
X1 comprises at least one selected from the group consisting of Ti, Zr, Hf, Nb, Ta, Mo, W, Al, Ga, Ag, Zn, S, Ca, Mg, V, Sn, As, Sb, Bi, N, O, Au, Cu, Mn, rare earth elements, and platinum-group elements;
a, b, c, d, e, α, β, and γ of the compositional formula satisfy
0.020≤a≤0.200,
0≤b≤0.070,
0.020≤a+b≤0.200,
0≤c≤0.100,
0<d≤0.050,
0≤e≤0.040,
0.005≤α≤0.700,
0≤β≤0.200,
0≤γ≤0.030, and
0.790≤1−(a+b+c+d+e)≤0.900;
the soft magnetic alloy powder comprises soft magnetic alloy particles including soft magnetic alloy particles having a particle size of (0.95×D90) or more and (1.05×D90) or less;
an average Wadell's circularity of the soft magnetic alloy particles having the particle size of (0.95×D90) or more and (1.05×D90) or less is 0.75 or more; and
a variance of Wadell's circularity of the soft magnetic alloy particles having the particle size of (0.95×D90) or more and (1.05×D90) or less is 0.035 or less.

2. A magnetic core comprising the soft magnetic alloy powder according to claim 1.

3. The magnetic core according to claim 2 further comprising a resin.

4. A magnetic component comprising the magnetic core according to claim 2.

5. An electronic device comprising the magnetic core according to claim 2.
